(19) United States
(12) Patent Application Publication
(10) Pub. No.: US 2010/0235291 A1
(43) Pub. Date: Sep. 16, 2010

(54) SELF-HELP INVENTION COMPUTER SYSTEM

(76) Inventor: Ronald L. Docie, SR., Athens, OH (US)

Correspondence Address: PETER K. TRZYNA, ESQ., P O BOX 7131, CHICAGO, IL, 60680, US

(21) Appl. No.: 12/724,419

(22) Filed: Mar. 15, 2010

Related U.S. Application Data
(60) Provisional application No. 61/159,983, filed on Mar. 13, 2009.

(51) Int. Cl. G06Q 50/00; G06Q 10/00; G06F 3/01

(52) U.S. Cl. 705/310; 715/705

(57) ABSTRACT

Self-help system to support innovation. Depending on the implementation, there is a machine, a method for use, a method for making, and corresponding products produced thereby, as well as data structures, computer-readable media tangibly embodying program instructions, manufactures, and necessary intermediates of the foregoing.

### I. PRIORITY STATEMENT

This patent application claims priority from, and incorporates by reference for all purposes as if fully set forth herein: Ser. No. 61/159,983, filed Mar. 13, 2009, of the same title and by inventor as herein; and Provisional Patent Application, filed on Mar. 12, 2010 by express mail EB734071685US, of the same title and by inventor as herein. Also incorporated by reference is “The Inventor's Bible: How to Market and License Your Brilliant Ideas, 2010, 3^{rd} Ed, Ten Speed Press Imprint of Crown Publishing, Division of Random House. A portion of the disclosure of this patent document contains material that is subject to copyright protection. The copyright owner has no objection to a statutory fair use of this material, as it appears in the files or records of the U.S. Patent and Trademark Office, but otherwise reserves all copyright rights whatsoever.

### II. TECHNICAL FIELD

The technical field is computers and data processing systems. Depending on the implementation, there is apparatus, a method for use and a method for making, and corresponding products produced thereby, as well as data structures, computer-readable media tangibly embodying program instructions, manufactures, and necessary intermediates of the foregoing.

### III. SUMMARY

Incorporated by reference, for all purposes as if fully set forth herein, are U.S. Patent Applic. No. 60/173,170, Ser. No. 09/747,748, Ser. No. 10/854,653 (i.e., U.S. Pat. No. 7,043,454), Ser. No. 11/379,930 (i.e., U.S. Pat. No. 7,672,904), Ser. No. 11/379,926, Ser. No. 11/379,935, Ser. No. 11/926,626, naming as inventor Michael D. Powell (collectively referenced herein as “Powell”). The title of U.S. Pat. No. 7,672,904 is “System and Method to Facilitate and Support Electronic Communication of Ideas”, and the abstract is as follows:

### ABSTRACT

A method and apparatus effectuates bilateral commerce in ideas. An originator and user-driven on-line commercial network system is designed to facilitate idea submission, purchase, and licensing, and is easily adapted to business-to-business transfers of innovation as well as consumer-to-business transfers of innovation. The invention allows originators of ideas to communicate nondisclosing synopses of ideas globally to potential users, for users conveniently to search for relevant ideas and for users potentially to bind an originator to a limited duration license granting user the exclusive right to access and consider confidentially the originator's fully disclosed idea. The invention also allows users to communicate confidentially or nonconfidentially unsolved problems or needs globally to potential originators, for originators conveniently to search for relevant unsolved problems or needs, and for originators to submit and communicate confidentially proposed solutions to the soliciting user.

Powell shows an originator-driven system in FIG. 1a and a user-driven system in FIG. 1b. Both figures show a Central Controller 200 located intermediate hardware for the originator and for the user.

It is respectfully submitted, with great respect for Powell, that interposing an intermediary between these parties does not empower innovators to operate on their own, in a self-help manner, in directly communicating with presentations of innovations to recipients, i.e., without an intermediary, broker, or the like. Therefore, some embodiments herein are directed to removing an element apparently believed necessary, e.g., with respect to Central Controller 200. In some embodiments herein, the system is devoid of an intermediary, such Central Controller 200. Some embodiments herein also facilitate sending the presentation to a recipient without a confidentiality agreement or license, and/or sending the presentation without an intermediary deciding whether the presentation can be disclosed to the recipient, and/or wherein a central controller does not convey the presentation to the recipient.

In short, Powell is a fundamentally different business model than embodiments herein which empower an innovator with a self-help system to produce one or more innovation presentations and to present them directly to a recipient. More so, in some embodiments, herein it is the innovator who controls every aspect of who receives the presentations, not an intermediary; and in some embodiments, it is the innovator who controls whether a recipient receives one presentation or another. Other embodiments pertain to developing innovation criteria, which may be matched against the criteria of a potential recipient. Some of the questions used to help an innovator to develop the criteria and/or presentation(s) can also be used to help a potential recipient develop criteria that may lead an innovator to submit a presentation.

### IV. FIGURES

FIG. 1 is an illustrative embodiment.

FIG. 2 is an illustrative embodiment.

FIG. 3 is an illustrative embodiment.

FIG. 4 is an illustrative embodiment.

FIG. 5A is an illustrative embodiment.

FIG. 5B is an illustrative embodiment.

FIG. 6 is an illustrative embodiment.

FIG. 7 is an illustrative embodiment.

FIG. 8 is an illustrative embodiment.

FIG. 9 is an illustrative embodiment.

FIG. 10 is an illustrative embodiment.

FIG. 11 is an illustrative embodiment.

FIG. 12 is an illustrative embodiment

FIG. 13 is an illustrative embodiment.

FIG. 14 is an illustrative embodiment.

FIG. 15 is an illustrative embodiment.

FIG. 16 is an illustrative embodiment.

FIG. 17 is an illustrative embodiment.

FIG. 18 is an illustrative embodiment.

FIG. 19 is an illustrative embodiment.

FIG. 20 is an illustrative embodiment.

FIG. 21 is an illustrative embodiment.

FIG. 22 is an illustrative embodiment.

FIG. 23 is an illustrative embodiment.

FIG. 24 is an illustrative embodiment.

FIG. 25 is an illustrative embodiment.

FIG. 26 is an illustrative embodiment.

FIG. 27 is an illustrative embodiment.

FIG. 28 is an illustrative embodiment.

FIG. 29 is an illustrative embodiment.

FIG. 30 is an illustrative embodiment.

FIG. 31 is an illustrative embodiment.

FIG. 32 is an illustrative embodiment.

FIG. 33 is an illustrative embodiment.

FIG. 34 is an illustrative embodiment.

FIG. 35 is an illustrative embodiment.

FIG. 36 is an illustrative embodiment.

FIG. 37 is an illustrative embodiment.

FIG. 38 is an illustrative embodiment.

FIG. 39 is an illustrative embodiment.

FIG. 40 is an illustrative embodiment.

FIG. 41 is an illustrative embodiment.

FIG. 42 is an illustrative embodiment.

FIG. 43 is an illustrative embodiment.

FIG. 44 is an illustrative embodiment.

FIG. 45 is an illustrative embodiment.

FIG. 46 is an illustrative embodiment.

FIG. 47 is an illustrative embodiment.

FIG. 48 is an illustrative embodiment.

FIG. 49 is an illustrative embodiment.

FIG. 50 is an illustrative embodiment.

FIG. 51 is an illustrative embodiment.

FIG. 52 is an illustrative embodiment.

FIG. 53 is an illustrative embodiment.

FIG. 54 is an illustrative embodiment.

FIG. 55 is an illustrative embodiment.

FIG. 56 is an illustrative embodiment.

FIG. 57 is an illustrative embodiment.

FIG. 58 is an illustrative embodiment.

FIG. 59 is an illustrative embodiment.

FIG. 60 is an illustrative embodiment.

FIG. 61 is an illustrative embodiment.

FIG. 62 is an illustrative embodiment.

FIG. 63 is an illustrative embodiment.

FIG. 64 is an illustrative embodiment.

FIG. 65 is an illustrative embodiment.

FIG. 66 is an illustrative embodiment.

FIG. 67 is an illustrative embodiment.

FIG. 68 is an illustrative embodiment.

FIG. 69 is an illustrative embodiment.

FIG. 70 is an illustrative embodiment.

FIG. 71 is an illustrative embodiment.

FIG. 72 is an illustrative embodiment.

FIG. 73 is an illustrative embodiment.

FIG. 74 is an illustrative embodiment.

FIG. 75 is an illustrative embodiment.

FIG. 76 is an illustrative embodiment.

FIG. 77 is an illustrative embodiment.

FIG. 78 is an illustrative embodiment.

FIG. 79 is an illustrative embodiment.

FIG. 80 is an illustrative embodiment.

FIG. 81 is an illustrative embodiment.

FIG. 82 is an illustrative embodiment.

FIG. 83 is an illustrative embodiment.

FIG. 84 is an illustrative embodiment.

FIG. 85 is an illustrative embodiment.

FIG. 86 is an illustrative embodiment.

FIG. 87 is an illustrative embodiment.

FIG. 88 is an illustrative embodiment.

FIG. 89 is an illustrative embodiment.

FIG. 90 is an illustrative embodiment.

FIG. 91 is an illustrative embodiment.

FIG. 92 is an illustrative embodiment.

FIG. 93 is an illustrative embodiment.

FIG. 94 is an illustrative embodiment.

FIG. 95 is an illustrative embodiment.

FIG. 96 is an illustrative embodiment.

FIG. 97 is an illustrative embodiment.

FIG. 98 is an illustrative embodiment.

FIG. 99 is an illustrative embodiment.

FIG. 100 is an illustrative embodiment.

FIG. 101 is an illustrative embodiment.

FIG. 102 is an illustrative embodiment.

FIG. 103 is an illustrative embodiment.

FIG. 104 is an illustrative embodiment.

FIG. 105 is an illustrative embodiment.

FIG. 106 is an illustrative embodiment.

FIG. 107 is an illustrative embodiment.

FIG. 108 is an illustrative embodiment.

FIG. 109 is an illustrative embodiment.

FIG. 110 is an illustrative embodiment.

FIG. 111 is an illustrative embodiment.

FIG. 112 is an illustrative embodiment.

FIG. 113 is an illustrative embodiment

FIG. 114 is an illustrative embodiment.

FIG. 115 is an illustrative embodiment.

FIG. 116 is an illustrative embodiment.

FIG. 117 is an illustrative embodiment.

FIG. 118 is an illustrative embodiment.

FIG. 119 is an illustrative embodiment

FIG. 120 is an illustrative embodiment.

FIG. 121 is an illustrative embodiment.

FIG. 122 is an illustrative embodiment.

FIG. 123 is an illustrative embodiment.

FIG. 124 is an illustrative embodiment.

FIG. 125 is an illustrative embodiment.

FIG. 126 is an illustrative embodiment.

FIG. 127 is an illustrative embodiment.

FIG. 128 is an illustrative embodiment.

FIG. 129 is an illustrative embodiment.

### V. MODES

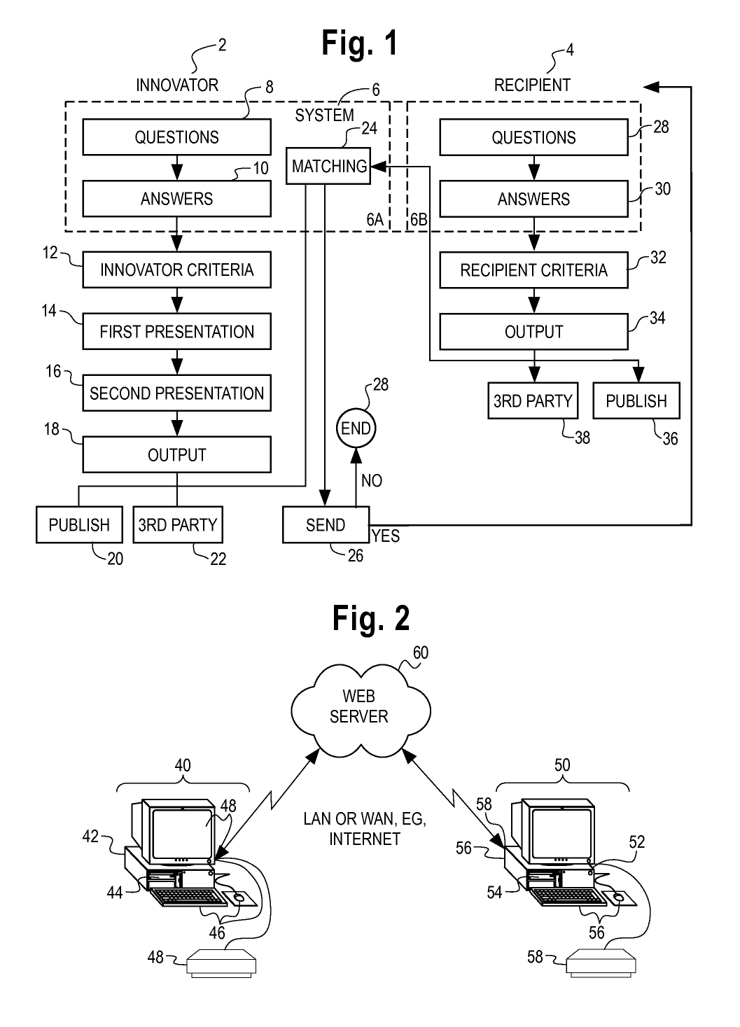

FIG. 1 is a diagram depicting an illustrative embodiment as an overview of the computer-related aspects detailed hereinafter, with reference to particulars in one embodiment or another, such as those referenced in part as DIMWIT and as INVENTION COMUTER SYSTEM. There can be an innovator 2, as distinct from a potential recipient or recipient 4. As indicated by the dashed lines, there can be a system 6 having a component corresponding to innovator 2 (i.e., component 6A), recipient 4 (i.e., component 6B), or each of them, depending on the embodiment of choice.

With respect to the innovator component 6A presents questions and answers, some of which can be by interactive screens, some of which comprise questions 8 for answers 10 (and if desired, gathering criteria 12 about an innovation), until a first presentation 14 (and if desired, a second presentation 16 about the innovation) formed. The presentation(s) 14 (16) and if included in an embodiment, the innovator criteria 12, can be included in output 18. The output can be printed or displayed at an output device, published 20 (e.g., at a web page, on the Internet, or otherwise), conveyed to a 3^{rd} party 22 (e.g., a law firm, an invention broker or an agent). The innovator 2 decides (and if an embodiment includes match capability 24, by use thereof) whether or not to send 26 the output to recipient 4.

As mentioned above, in some embodiments, there can be a recipient component 6b, questions 28 for answers 30, which can evolve recipient criteria 32 in output 34. The output 34 can be printed or displayed at an output device, published 36 (e.g., at a web page, on the Internet, or otherwise), conveyed to a 3^{rd} party 38 (which may be the same as 3^{rd} party 22, e.g.), a law firm, an invention broker or an agent. In some embodiments, the recipient criteria can be communicated to the match capability 24, which can reside local to the innovator 2, local to the recipient, or intermediate innovator 2 and recipient 4. If so utilized, the match capability 24 can inform the recipient regarding whether to send 26 the output to the recipient 4.

In some embodiments components 6A and 6B are related in system 6. One manner of relating 6A and 6B, if desired, is to have the recipient criteria 32 influence, change, supplement, etc. the questions 8. Another manner of relating 6A and 6B, if desired, is to have the recipient criteria 32 influence the manner by which the presentation(s) are constructed. Criteria from both can be looped to the other in refining what is ultimately finalized in the presentation(s) 14 (16), and in this manner, the innovator 2 can pose criteria to the recipient 4. In some embodiments the recipient 4 can pose criteria to the innovator 4, which the innovator 4 may use in: refining the presentation, developing the innovation, commercializing the innovation, performing market research, identifying potential licensees or buyers, establishing market value, etc.

Consider now illustrative computer aspects of embodiments, as may be desired for one application or another. As used herein, the term “computer” generally refers to hardware or hardware in combination with one or more program(s), such as can be implemented in software, hardware, or a combination thereof. Computer aspects can be implemented on general purpose computers or specialized devices, and can operate electrically, optically, or in any other fashion. A computer as used herein can be viewed as at least one computer having all functionality or as multiple computers with functionality separated to collectively cooperate to bring about the functionality. Logic flow can represent signal processing, such as digital data processing, communication, or as evident from the context hereinafter. Logic flow or “logic means” can be implemented in discrete circuits, programmed computer, or the equivalent. Computer-readable media, as used herein, can comprise at least one of a tape, a written document (including a “mark-sense” card or an XML document), a RAM, a ROM, a disk, a flash drive, an ASIC, and a PROM. Data entry, as used herein, can comprise at least one of (i) manual entry by at least one of one or more keyboards, one or more mice, one or more pens, one or more tablets, one or more scanners, one or more voices, one or more movements or contractions of a body part, one or more body-generated magnetic or electrical signals, or one or more other manual data entry devices, or (ii) electronic entry through one or more physical or wired attachments to computer-readable media or one or more wireless connections to computer-readable media, and in each such cases either directly to the entry device or media or indirectly through a LAN or WAN (e.g., the Internet).

Embodiments of herein may be implemented in hardware or software, or a combination of both. Embodiments may be implemented as one or more computer programs executing on programmable systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion. For purposes of this application, a processing system embodying the playback device components includes any system that has a processor, such as, for example, a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the embodiments are not limited in scope to any particular programming language. In any case, the language may be a compiled or interpreted language.

The program(s) may be stored on a storage media or device (e.g., hard disk drive, floppy disk drive, read only memory (ROM), CD-ROM device, flash memory device, digital versatile disk (DVD), or other storage device) readable by a general or special purpose programmable processing system, for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

Some embodiments can be configured along the lines of FIG. 2, or part thereof. Illustratively, then, there can be a computer system 40, such as a self-help apparatus (corresponding to innovator 2) to develop a presentation of an invention characterization without a central controller. The computer system 40, which in some embodiments herein are referenced as INVENTION COMPUTER SYSTEM can include a digital computer 42 (e.g., an IBM, Hewlett Packard, or other personal computer) with one or more processors (e.g., an Intel series processor or the like), a memory system not shown in FIG. 2, (such as a hard drive, disk drive, etc.) and a memory 44 such as a CD, DVD, flash drive, etc., one or more input devices 46 (e.g., keyboard, mouse, modem, etc.), and one or more output devices 48 (e.g., a Hewlett Packard printer, a Dell monitor, a modem, router, etc.). There can be an operating system or other program such as Microsoft XP Professional (and its applications such as EXCEL, ACCESS, and WORD) to run on the computer system 40, a word processing system, such as Microsoft Word to process transaction data, and/or some hard coded systems to perform the technical processes herein, and produce the output data according thereto.

So for example, the input device 46 such as a keyboard can receive the input data either manually or in another manner, e.g., electronically via an input device such as a router. Output device 48 can be used for outputting the presentations 14, 16, etc.

Similarly, there can be a computer system 50 (corresponding to recipient 4), which can include a digital computer 52 (e.g., an IBM, Hewlett Packard, or other personal computer) with one or more processors (e.g., an Intel series processor or the like), a memory system not shown in FIG. 2, (such as a hard drive, disk drive, etc.) and a memory 54 such as a CD, DVD, flash drive, etc., one or more input devices 56 (e.g., keyboard, mouse, modem, etc.), and one or more output devices 58 (e.g., a Hewlett Packard printer, a Dell monitor, a modem, router, etc.). There can be an operating system or other program such as Microsoft XP Professional (and its applications such as EXCEL, ACCESS, and WORD) to run on the computer system 50, a word processing system such as Microsoft Word to process transaction data, and/or some hard coded systems to perform the technical processes herein, and produce the output data according thereto.

So for example, the input device 56 such as a keyboard can receive the input data either manually or in another manner, e.g., electronically via an input device such as a router. Output device 58 can be used for outputting match criteria 32.

Note that the presentations 14, 16, (see, e.g., send 26 in FIG. 1) and criteria 12 can be communicated electronically from system 40 to system 50, and criteria 32 can be communicated electronically from system 50 to system 40, via a network, such as a LAN, WAN like the Internet, server 60, etc.

In some embodiments, therefore, there can be a self-help apparatus to develop a presentation of an invention characterization without a central controller. The apparatus can include a digital computer system 40 comprising a computer 42, operably associated with an input device 46, an output device 48, and memory (not shown in FIG. 2) storing executable instructions which when executed, causes the digital computer 42 to perform the operations of: producing self-help user interfaces (exemplified further herein) comprising enough questions 8, at the output device 48, so that receiving answers 10 which correspond to the output questions 8 enables the computer 40 to generate a presentation of an innovation characterization configured to avoid disclosure of a trade secret and to avoid a bar to patentability if the presentation were publicly disclosed; receiving, at the input device 46, answers to the output questions 8; generating, by the computer 42 from the received answers 10, the presentation; and outputting 18 the presentation at the output device 48 so as to allow communication of the presentation to a recipient 4 without a confidentiality agreement or license involving the innovator 2 and the recipient 4 as parties, and without an intermediary deciding whether the presentation can be disclosed to the recipient 4, and wherein the apparatus is devoid of a central controller between the digital computer system 40 and the recipient 4, and a central controller does not convey the presentation to the recipient 4. Thus, any and all functionality of Powell can be modified, to the extent desired and feasible for applications of choice, so as to remove one or more aforesaid features in Powell and, or otherwise, instead conform to the approaches, embodiments, and teachings herein: particularly, empowering the innovator 2 with tools to do as he or she wishes.

In another embodiment, there can be a self-help apparatus to develop a presentation of an invention characterization without a central controller. The apparatus can include: a digital computer system 40 comprising a computer 42 operably associated with an input device 46, an output device 48, and memory (not shown in FIG. 2) storing executable instructions which when executed, causes the digital computer 42 to perform the operations of: producing self-help user interfaces (exemplified subsequently) comprising enough questions 8, at the output device 48, so that receiving answers 10 which correspond to the output questions 8 enables the computer 42 to generate a presentation of an innovation characterization configured to avoid disclosure of a trade secret and to avoid a bar to patentability if the presentation were publicly disclosed; receiving, at the input device 46, answers 10 to the output questions 8; generating, by the computer 42 from the received answers 10, the presentation; and outputting 18 the presentation at the output device 48 to convey to a recipient 4, wherein the apparatus is devoid of a central controller between the digital computer system 40 and a recipient 2 to convey the presentation to the recipient 4.

In some embodiments, there can further include the operation of: producing, from at least some of the received answers 10, an other presentation that is not configured to avoid disclosure of a trade secret and to avoid a bar to patentability if the presentation were publicly disclosed.

In some embodiments the operation of generating includes generating the presentation of the innovation characterization configured in one or more ways to avoid disclosure of patentable subject matter, to avoid making an offer to sell, so as not to contain sufficient detail to be patentable, and/or to consist of commonly known or pubic information.

In some embodiments, the operation of outputting enough questions 8 includes producing interactive screens at the output device 48, some of which include questions 8.

In some embodiments, the operation of outputting enough questions 8 includes producing screens at the output device 48, whereby at least some of the received answers 10 govern which of the questions 8 is subsequently presented.

In some embodiments, the operation of outputting enough questions 8 includes producing screens at the output device 48, whereby at least some of the received answers 8 govern which of the presentations is first output.

In some embodiments, the operations further include generating, by the computer 42 from the received answers 10, advice (subsequently exemplified) on how to develop the innovation characterization; and outputting the advice at the output device 48.

In some embodiments, the operations further include generating, by the computer 42 from the received answers 10, advice on how to commercialize the innovation characterization; and outputting the advice at the output device 48.

In some embodiments, the operations further include generating, by the computer 42 from the received answers 8, instructions corresponding to at least one criterion from an other (e.g., recipient 4, or another), the instructions corresponding to receiving the innovation characterization; and outputting the instructions at the output device 48.

In some embodiments, some of the answers 8 include at least one criterion of a category, function, benefit, advantage, feature, objective, characteristic, application, uses, users, market, sales outlet, distribution, consumer demographic, and consumer psychographic, corresponding to the innovation characterization.

In some embodiments, the operations further include receiving at least one criterion from an other (e.g., recipient 4, or another) specifying a desired presentation.

In some embodiments, the operations further include matching 24 said at least one criterion with at least one criterion from an other (e.g., recipient 4, or another) with respect to the innovation characterization.

In some embodiments, the operations further include matching 24 said at least one criterion with at least one criterion from an other with respect to the innovation characterization in determining a statistical significance of the matching 24.

In some embodiments, the operations further include producing a relevance matching 24 of said at least one criterion with at least one criterion from an other (e.g., recipient 4, or another) with respect to the innovation characterization.

In some embodiments, the operations further include presenting screens (exemplified subsequently) which solicit said at least one criterion from an other (e.g., recipient 4, or another) so as to correspond to some of the answers 8.

In some embodiments, the outputting and receiving operations are carried out at a web site 60.

In some embodiments, the memory comprises one memory media for both presentations.

In some embodiments, the memory comprises one memory media for the presentation and a second memory media for the other presentation.

Some embodiments can further include a second computer system 50 communicating with the computer system 40 in providing said at least one criterion of the other (e.g., recipient 4).

Some embodiments can further include a recipient computer system 50 receiving said presentation.

In some embodiments, the presentation is configured to avoid disclosure of a trade secret by filtering the received answers 10.

In some embodiments, the presentation is configured to avoid a bar to patentability if the presentation were publicly disclosed by filtering the received answers 10.

In some embodiments, the presentation is configured to avoid disclosure of a trade secret by carrying out the outputting with a set of the questions 8 that do not have trade secret answers 10.

In some embodiments, the presentation is configured to avoid a bar to patentability if the presentation were publicly disclosed by carrying out the outputting with a set of questions 8 that do not have answers 10 which would bar patentability.

In some embodiments, there can be computer-readable media (not shown in FIG. 2) tangibly embodying a program of instructions executable by a computer 42 to control a computer system 40 to give the computer capabilities corresponding to the embodiment of choice herein, e.g., illustratively, in carrying out the self-help steps of: outputting enough questions 8 so that receiving answers 10 which correspond to the output questions 8 enables the computer 42 to generate a presentation of an innovation characterization configured to avoid disclosure of a trade secret and to avoid a bar to patentability if the presentation were publicly disclosed; receiving answers 8 to the output questions 8; generating, from the received answers 10, the presentation; and outputting the presentation, wherein the instructions are not adapted to communicate with a central controller intermediate digital computer system 40 and the recipient 4.

In some embodiments, the media can be a member of a group including at least one of a RAM, a ROM, a disk, an ASIC, and a PROM.

In some embodiments, there can be a method of making an apparatus including: providing a digital computer system 40 comprising a computer 42 operably associated with an input device 46, an output device 48, and memory storing executable instructions which when executed, causes the digital computer 42 to perform the self-help operations of: outputting enough questions 8, at the output device 48, so that receiving answers 10 which correspond to the output questions 8 enables the computer 42 to generate a presentation of an innovation characterization configured to avoid disclosure of a trade secret and to avoid a bar to patentability if the presentation were publicly disclosed; receiving, at the input device 46, answers 10 to the output questions 8; generating, by the computer 42 from the received answers 10, the presentation; and outputting 18 the presentation at the output device 48, wherein the apparatus is not adapted to convey the presentation to the recipient 4 via a central controller.

In some embodiments, there can be a method of using an apparatus including: engaging a digital computer system 40 comprising a computer 42 operably associated with an input device 46, an output device 48, and memory storing executable instructions which when executed, to cause the digital computer 40 to perform the self-help operations of: outputting enough of questions 8, at the output device 48, so that receiving answers 10 which correspond to the output questions 8 enables the computer 42 to generate a presentation of an innovation characterization configured to avoid disclosure of a trade secret and to avoid a bar to patentability if the presentation were publicly disclosed; receiving, at the input device 46, answers 10 to the output questions 8; generating, by the computer 42 from the received answers 10, the presentation; and outputting 18 the presentation at the output device 48 so as to allow communication of the presentation from the innovator 2 to a recipient 4 without an intermediary deciding whether the presentation can be disclosed to the recipient 4.

In some embodiments, the operations can further include calculating, by the computer 42 from data input at the input device 46, a market value corresponding to the presentation; and outputting 18 the market value at said output device 48.

In some embodiments, the operations can further include identifying, by the computer 42 from data input at the input device 46, potential recipient choices corresponding to the presentation; and outputting 18 the choices at said output device 48.

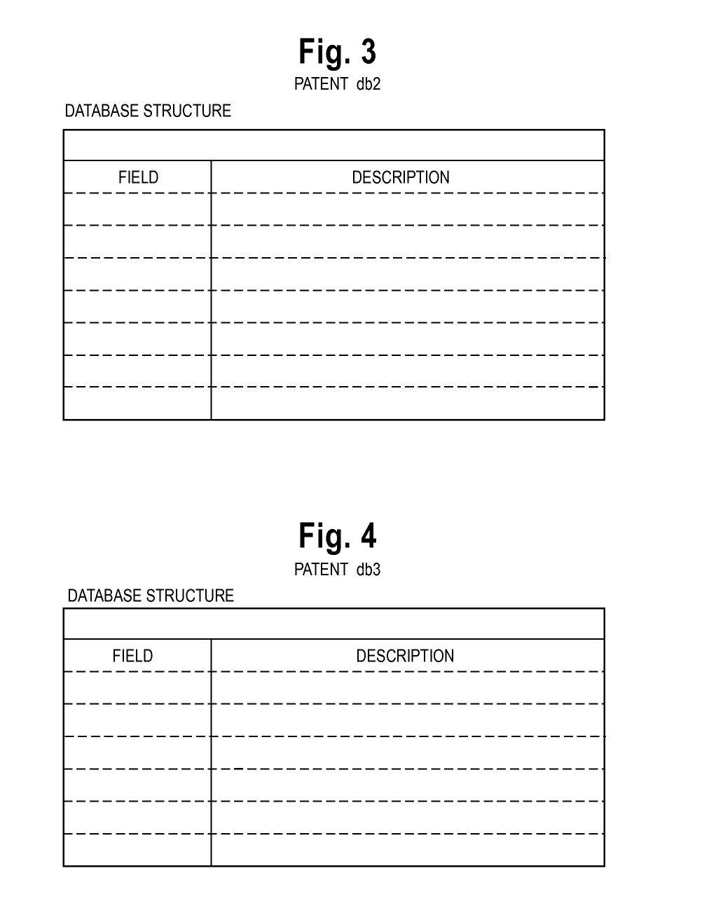

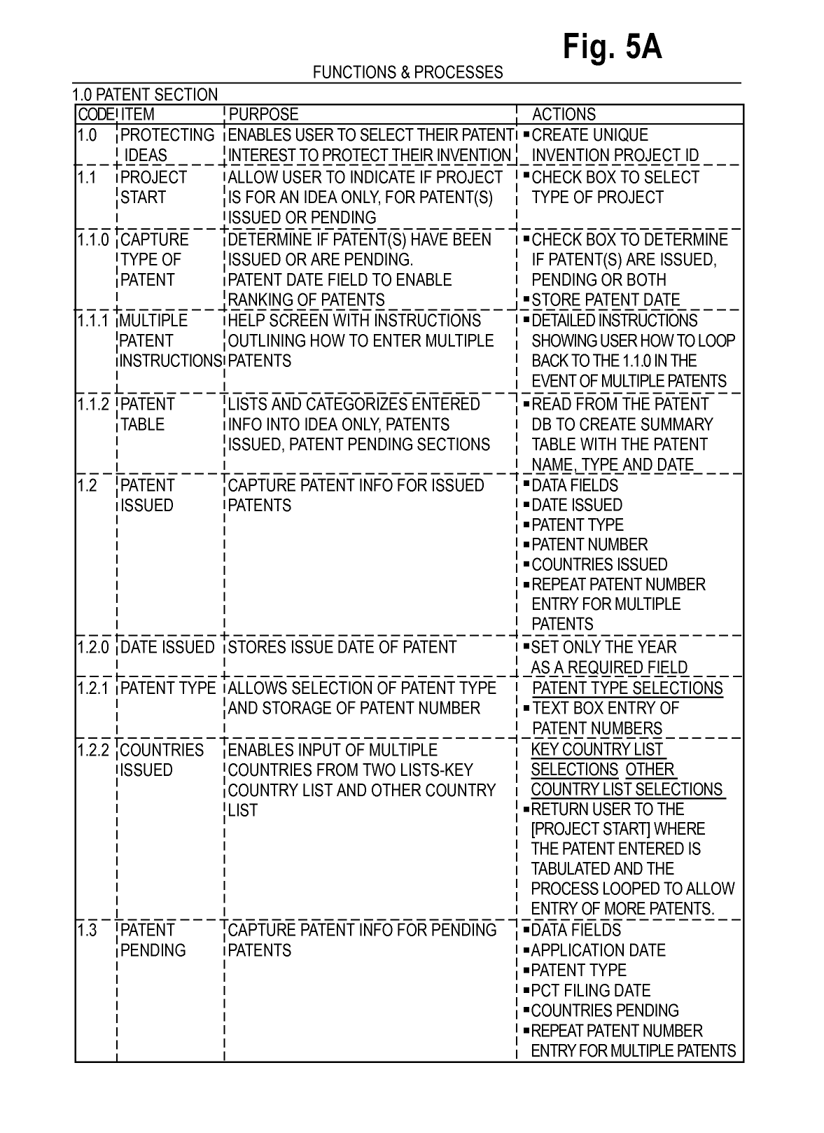

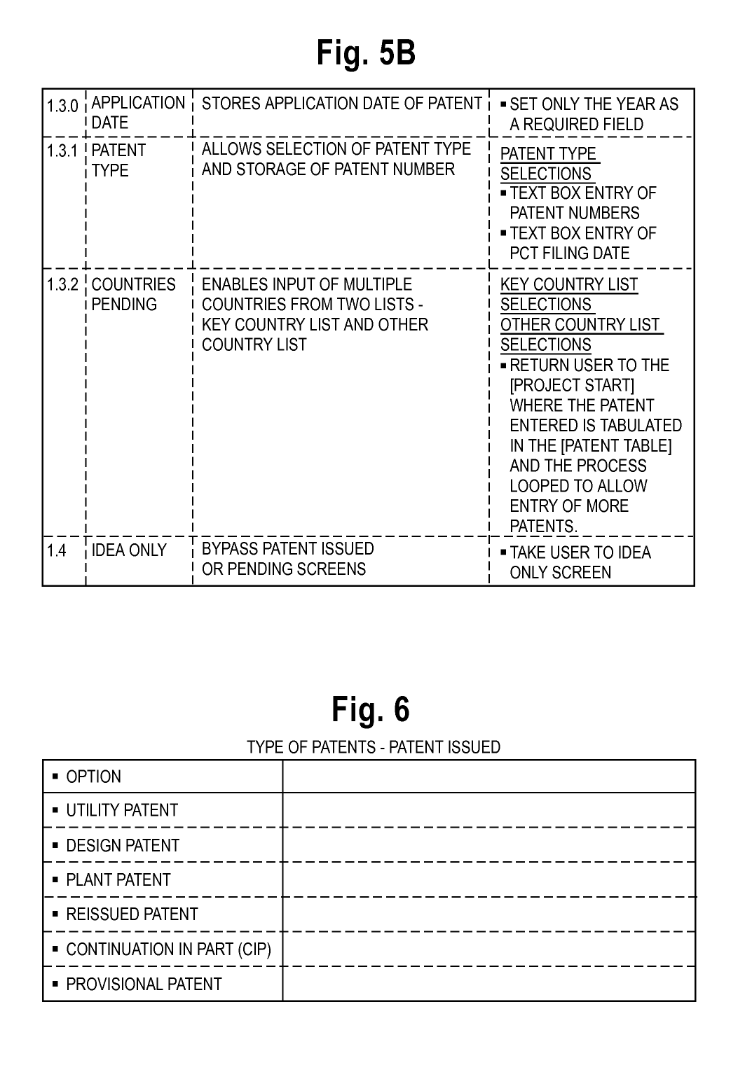

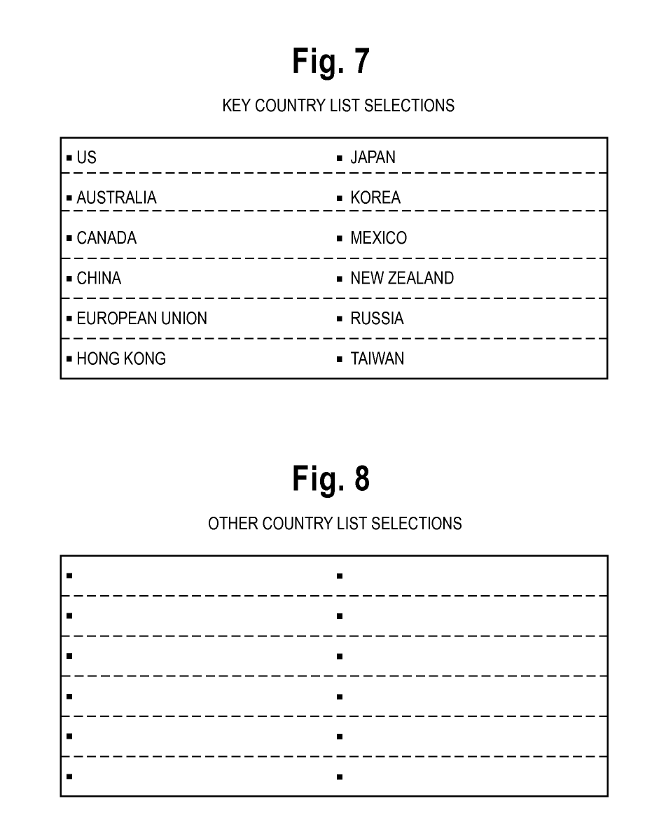

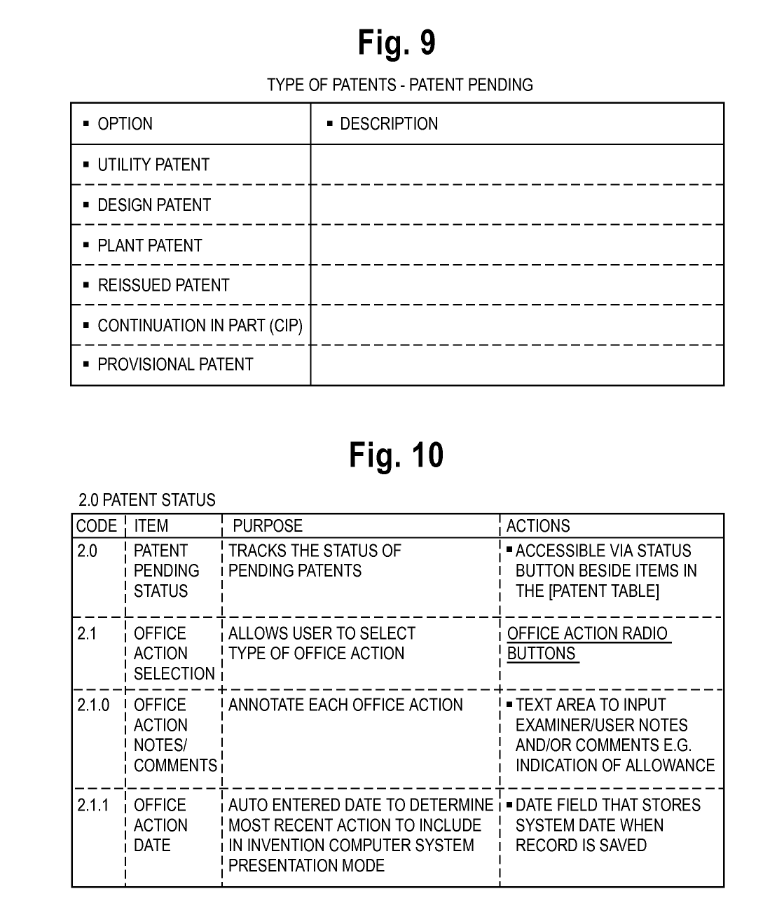

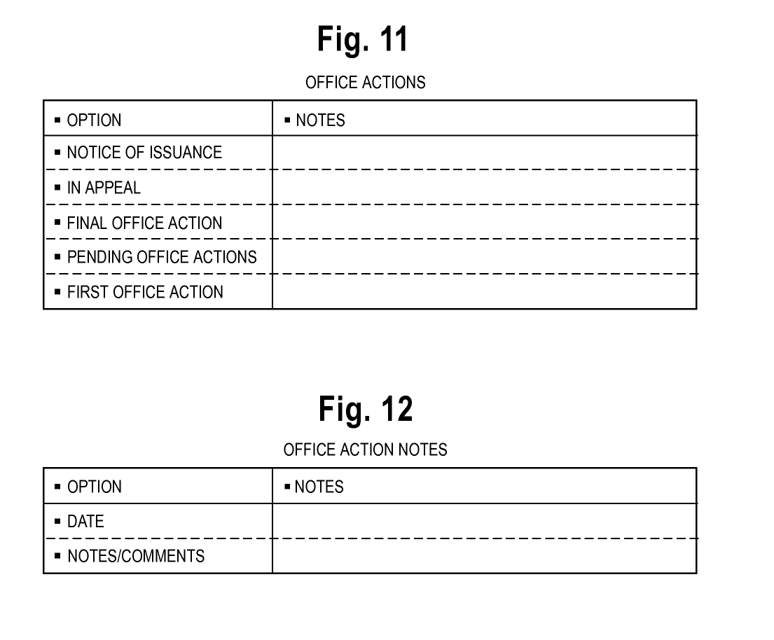

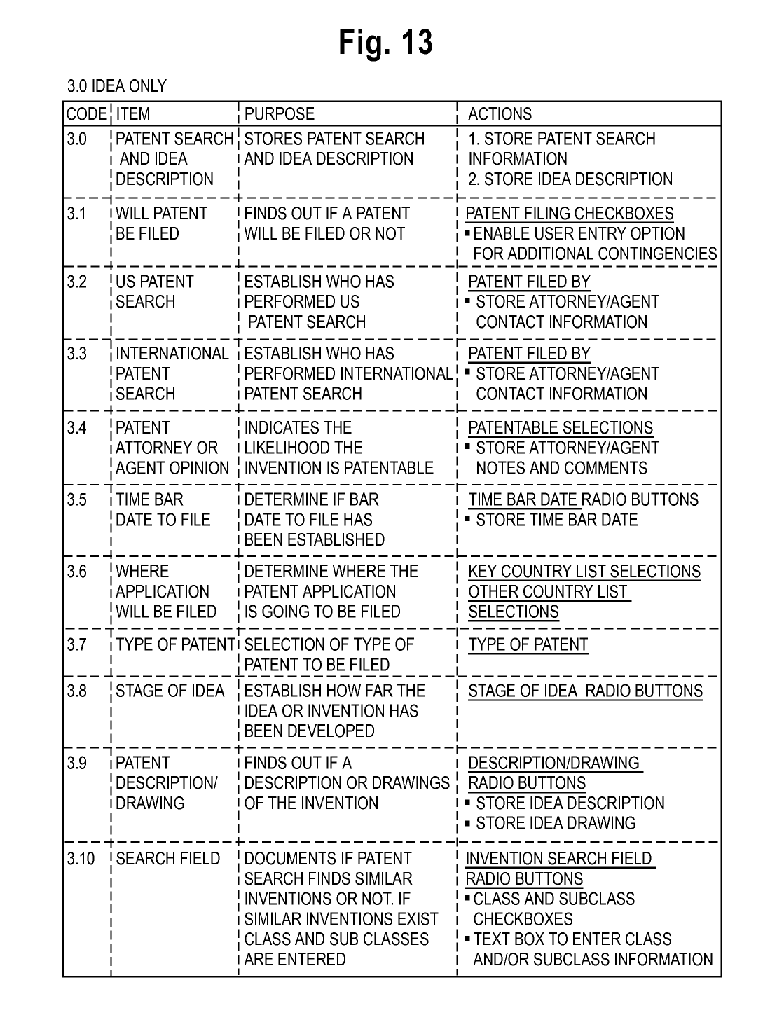

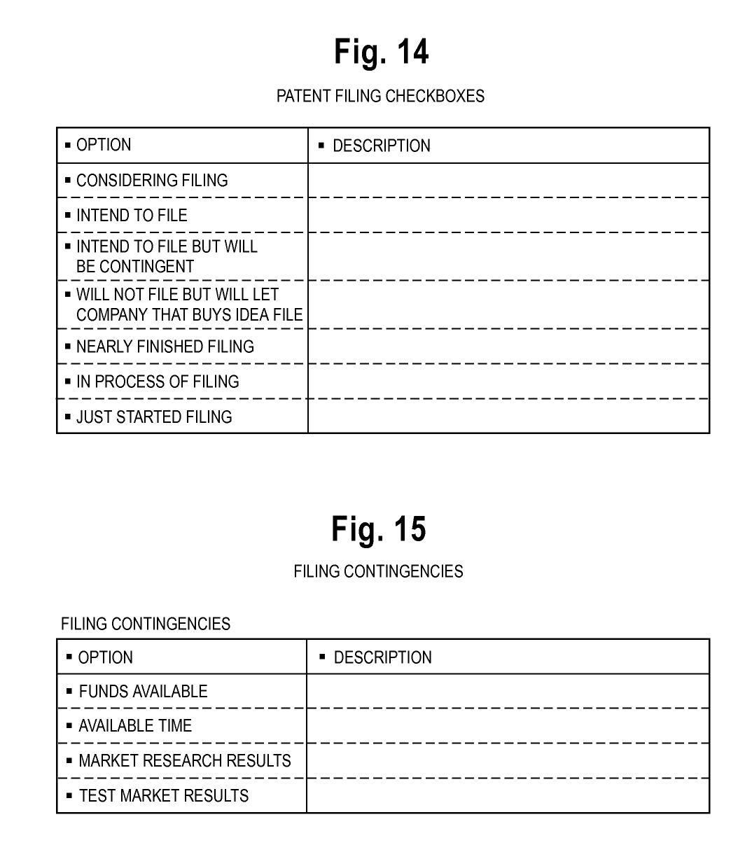

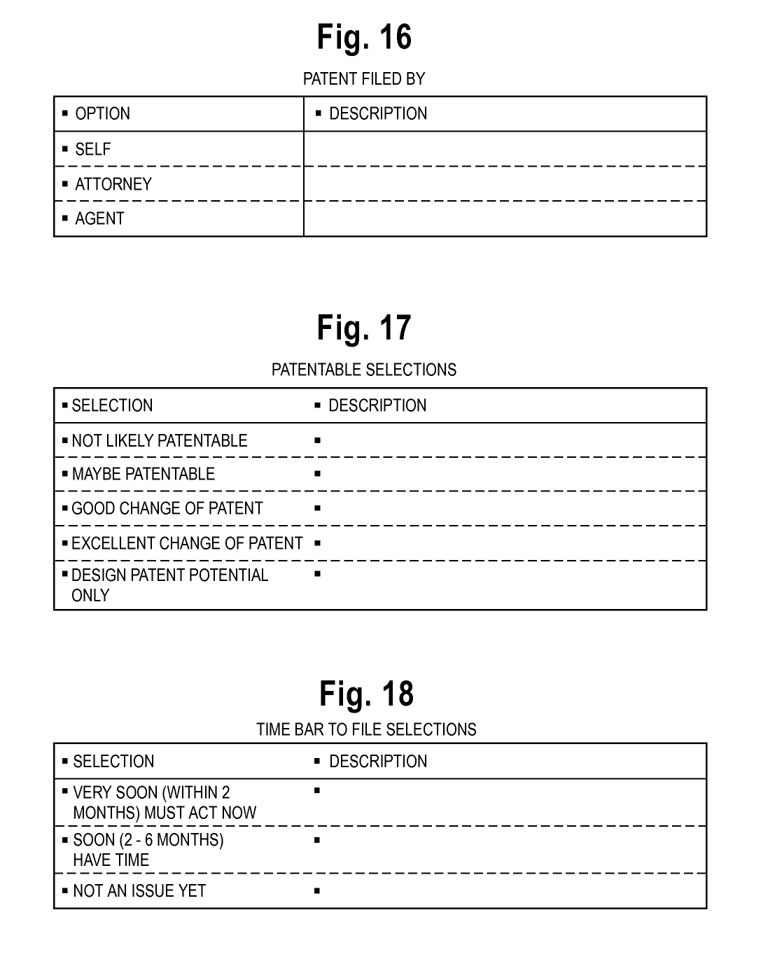

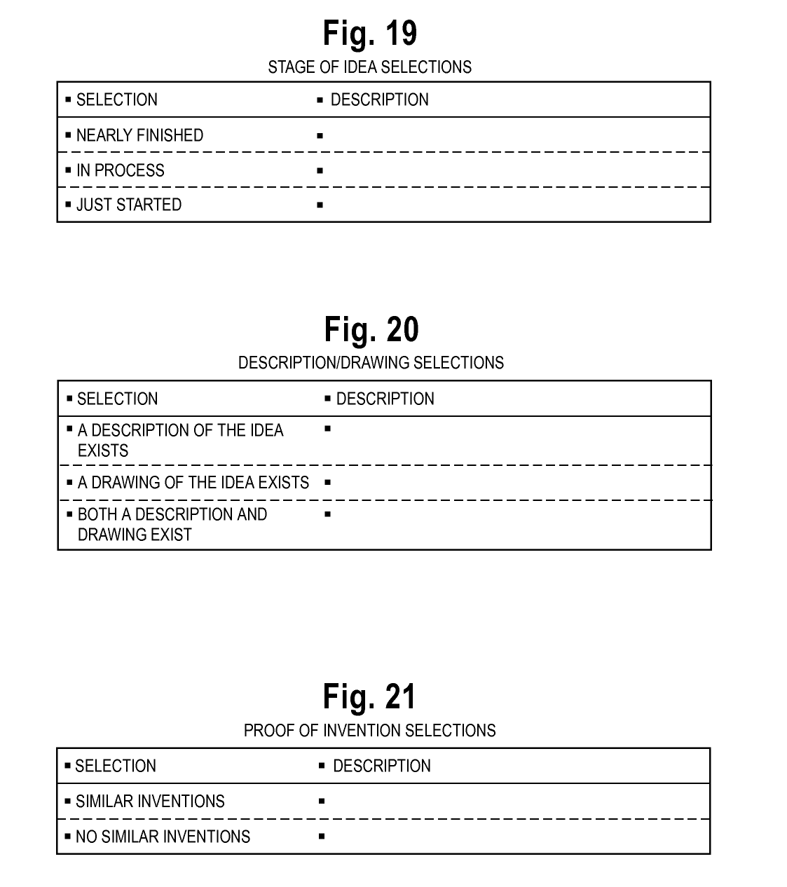

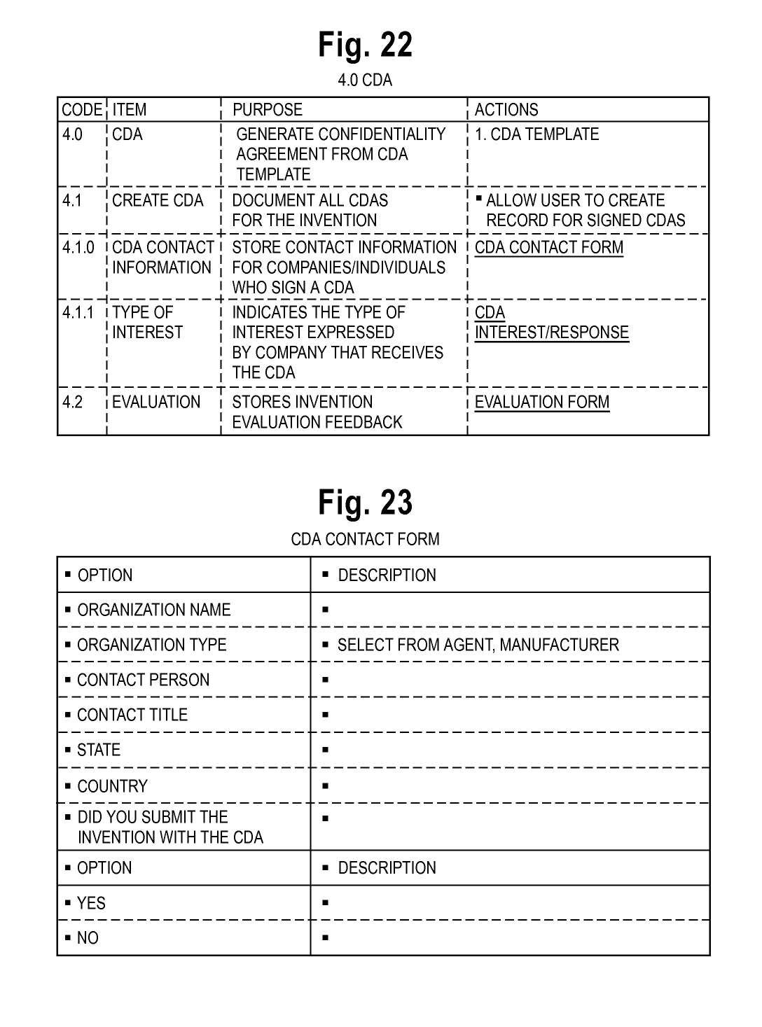

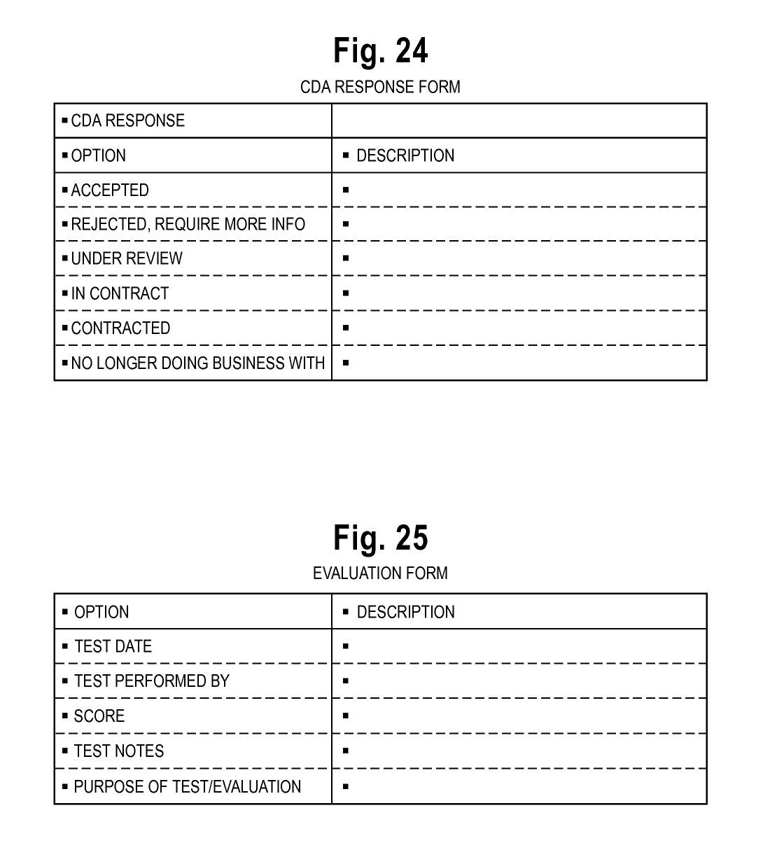

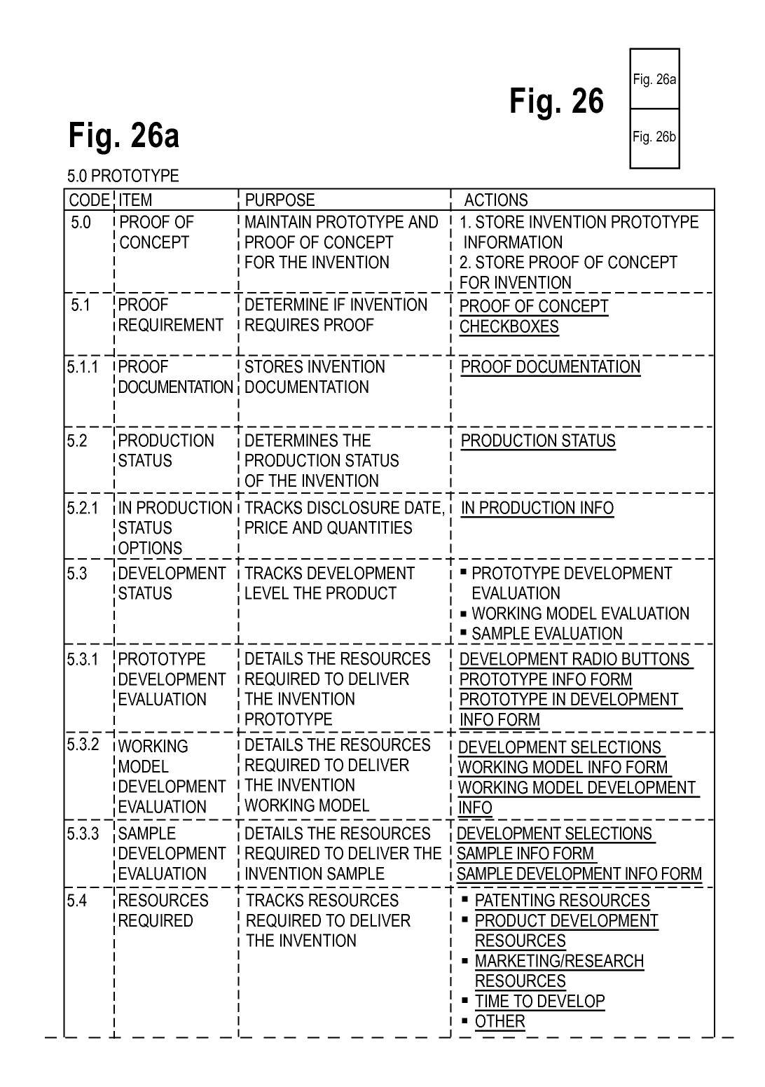

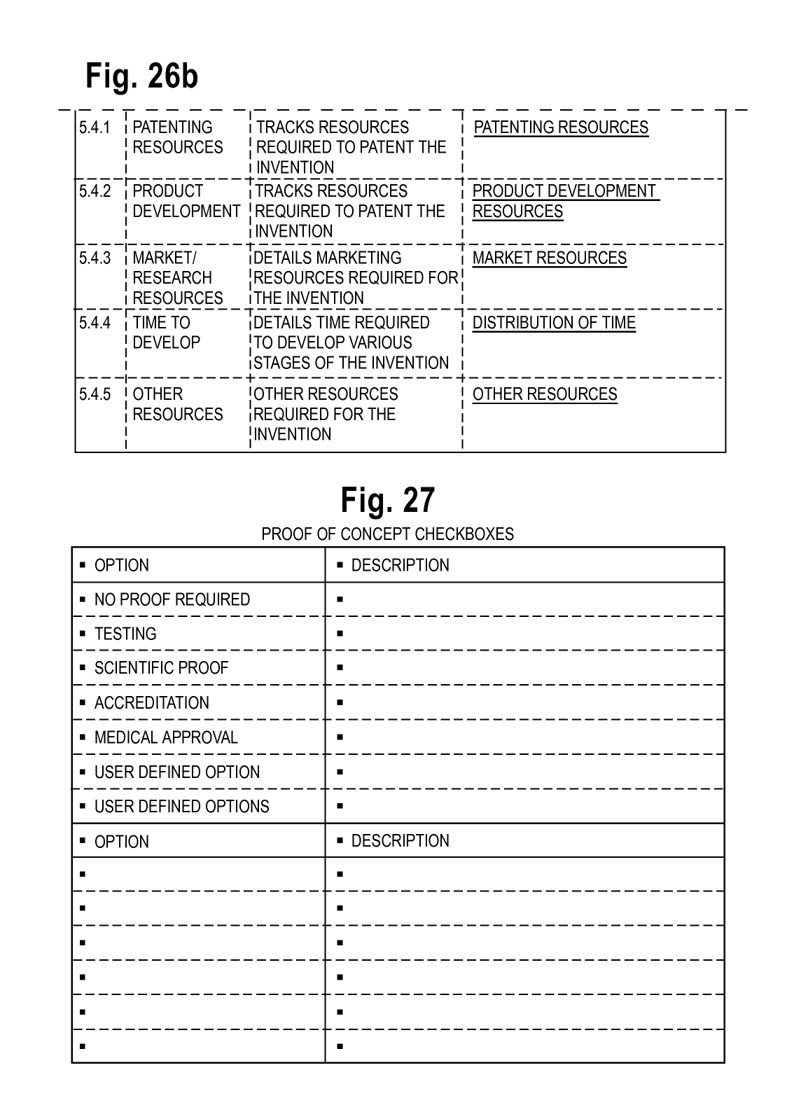

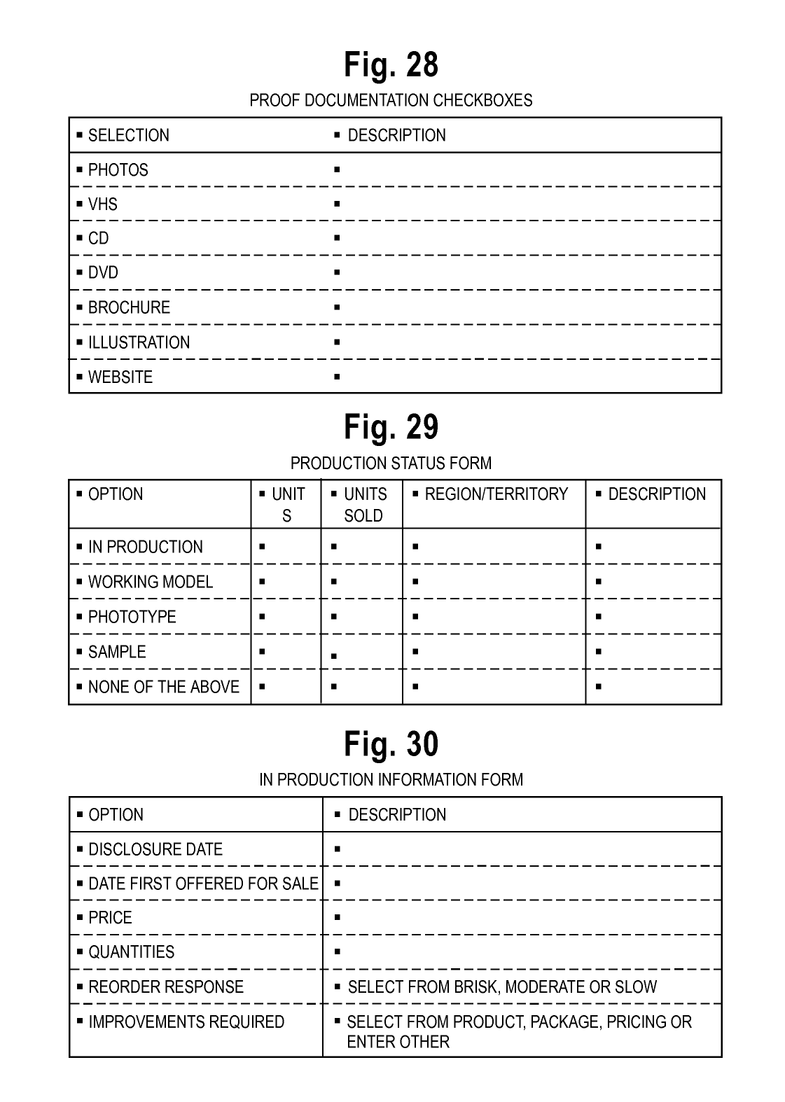

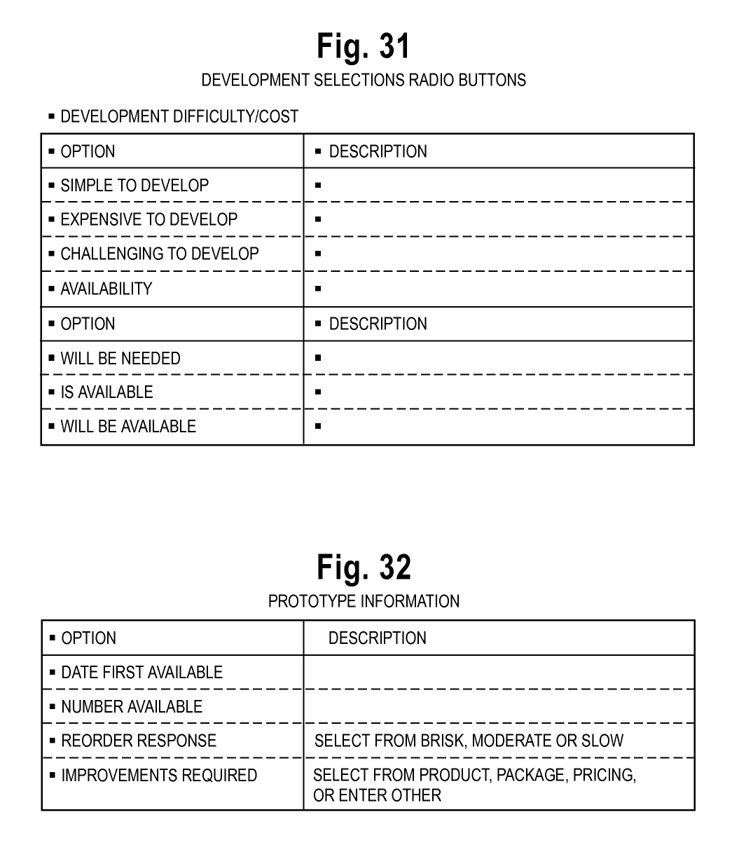

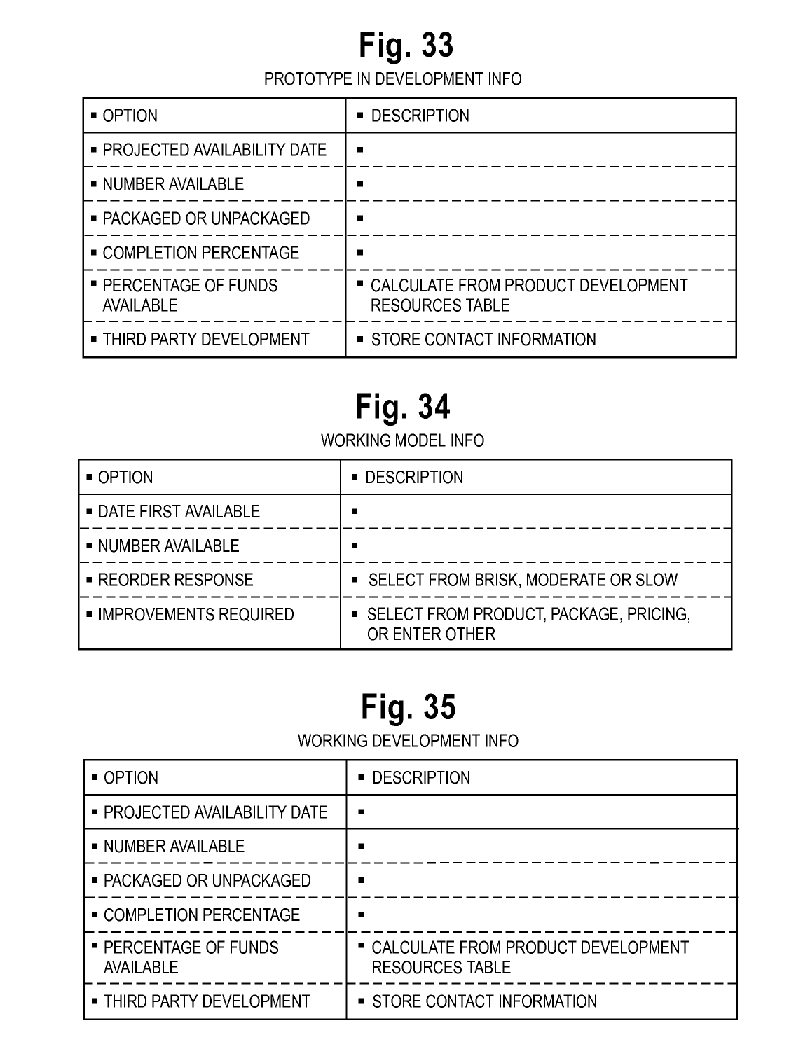

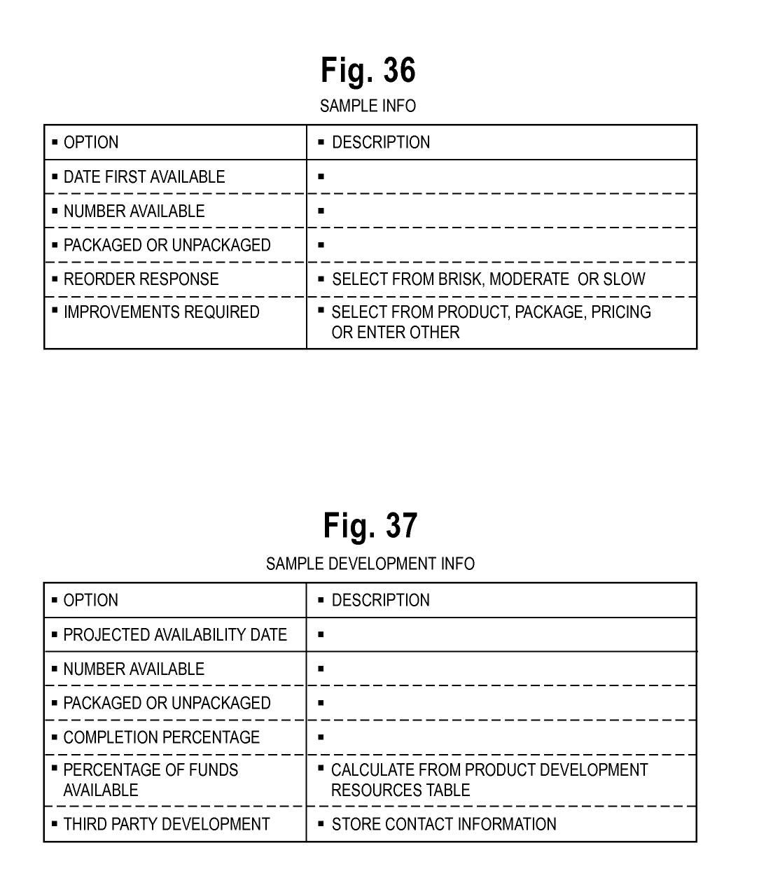

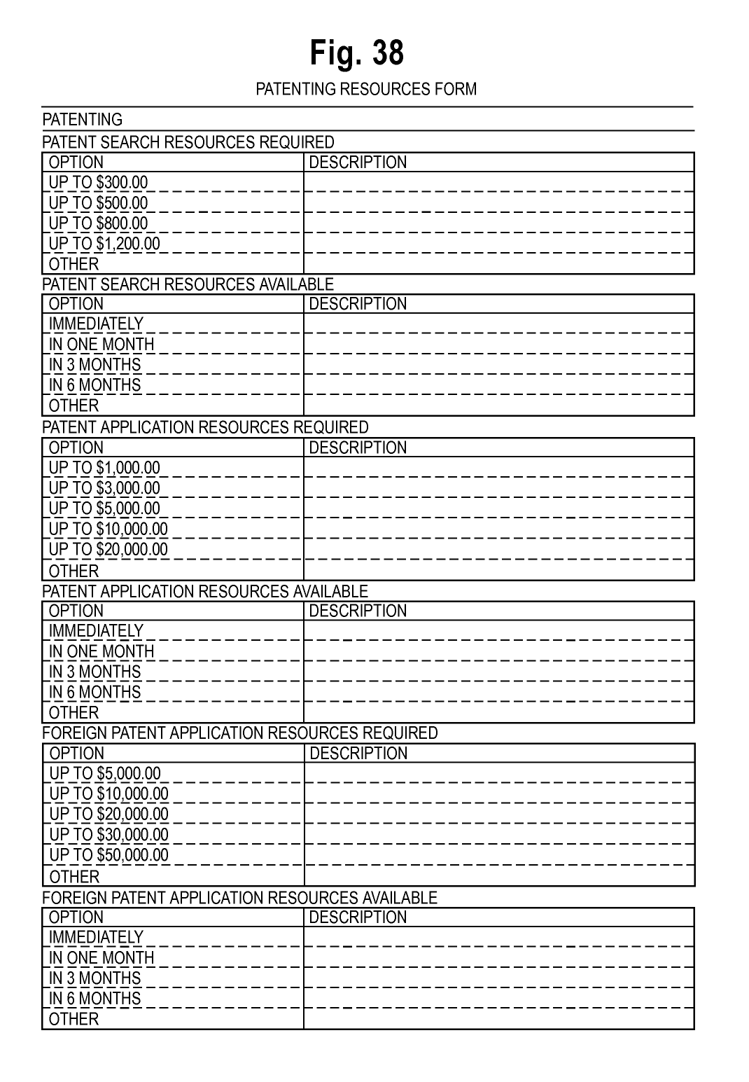

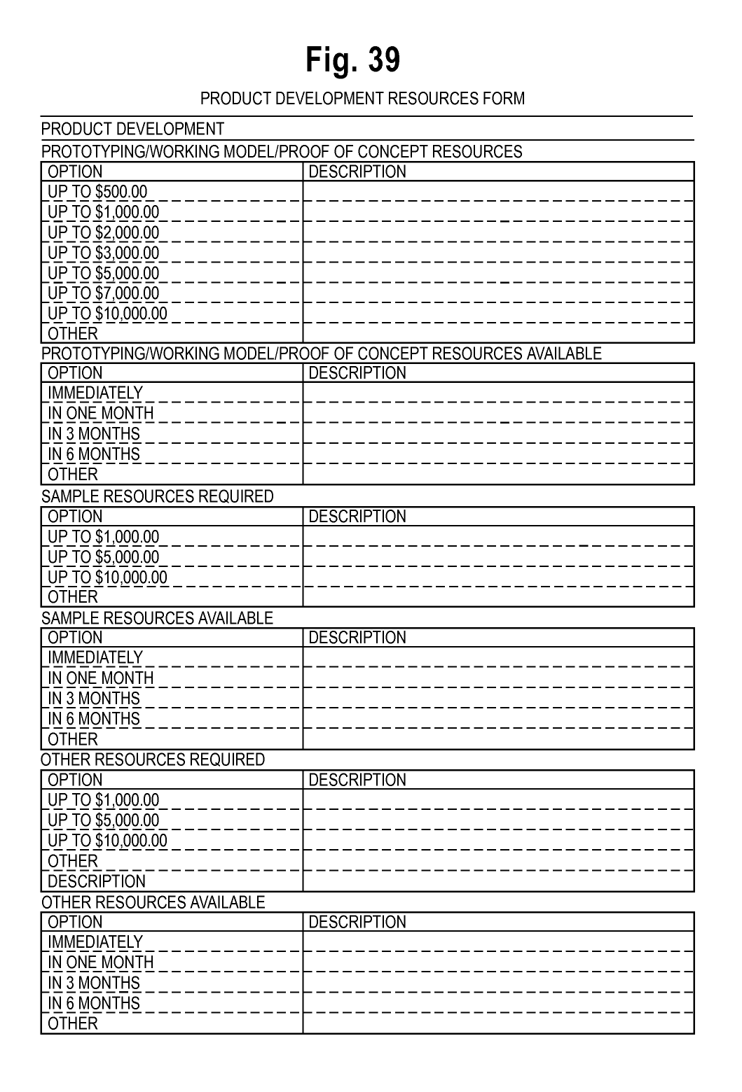

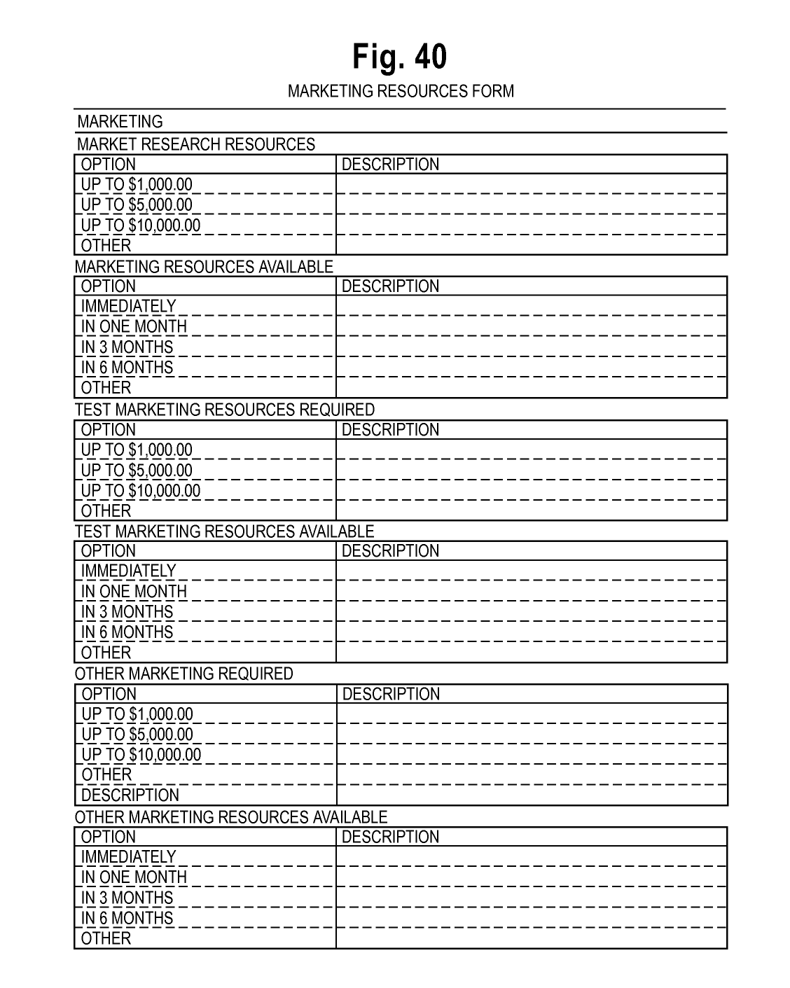

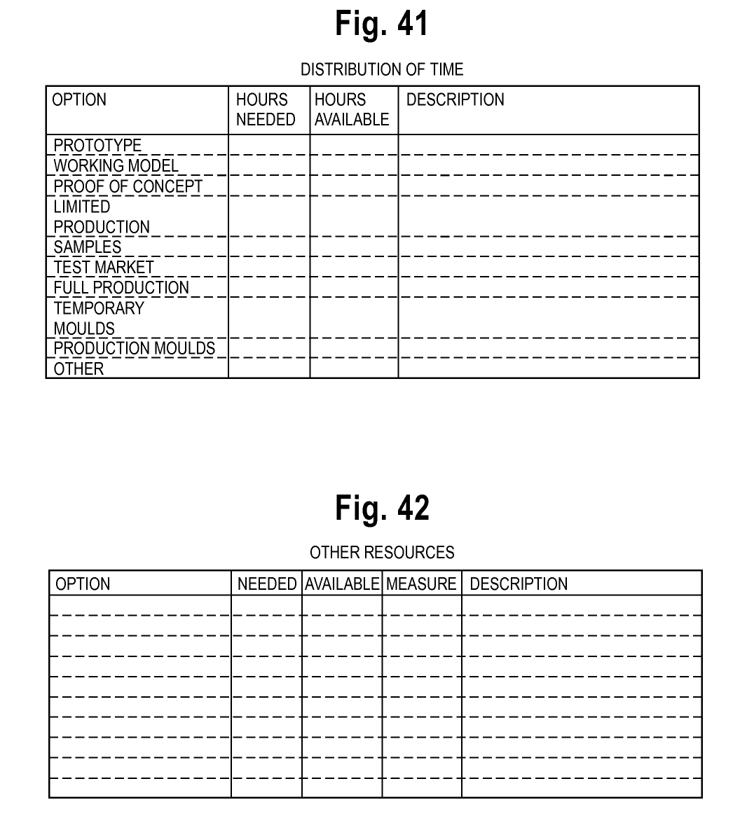

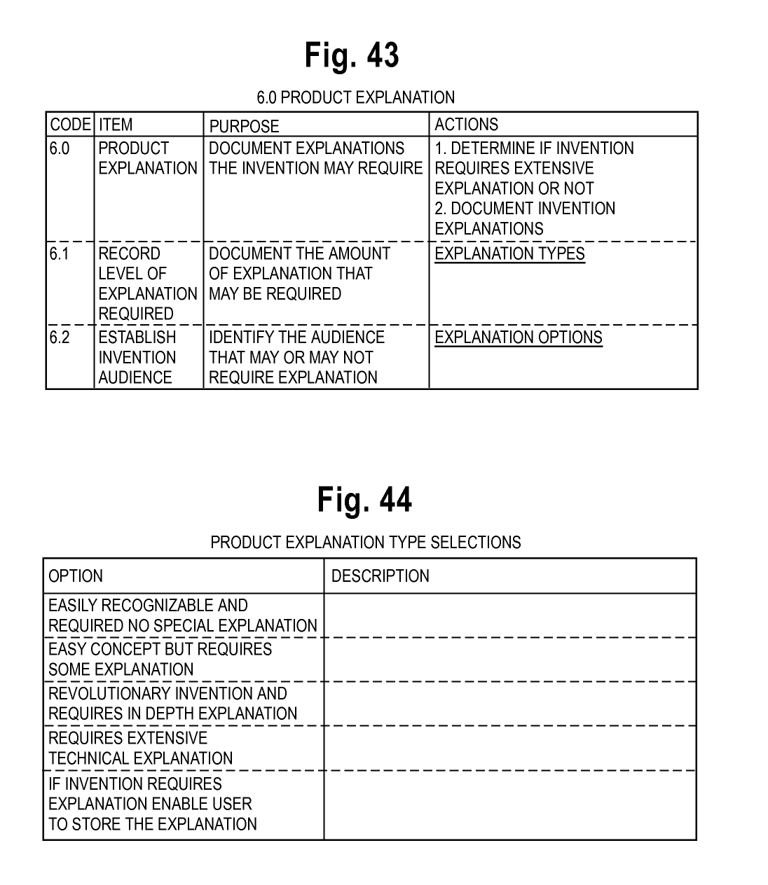

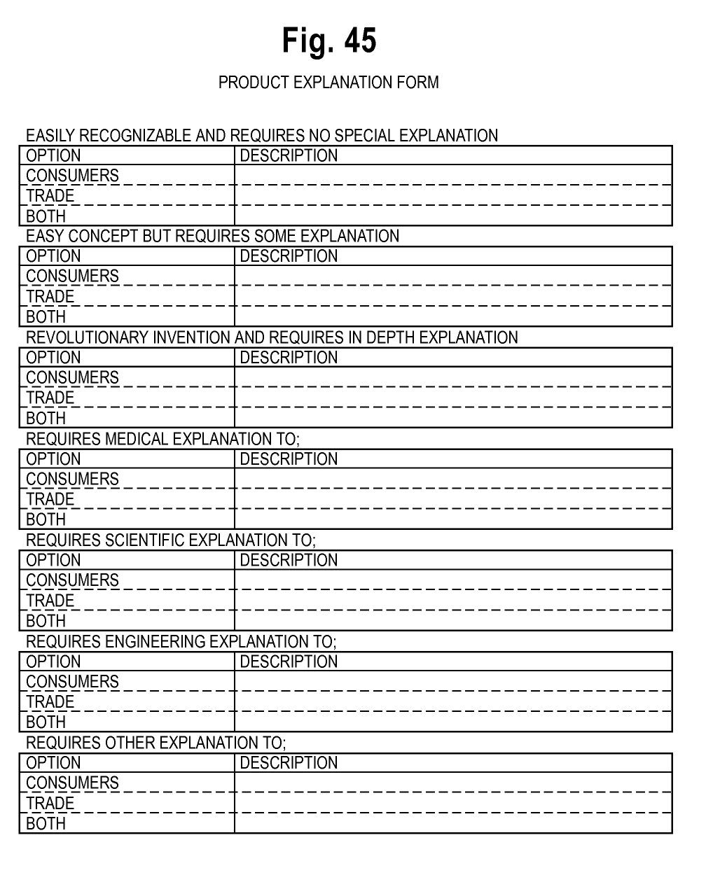

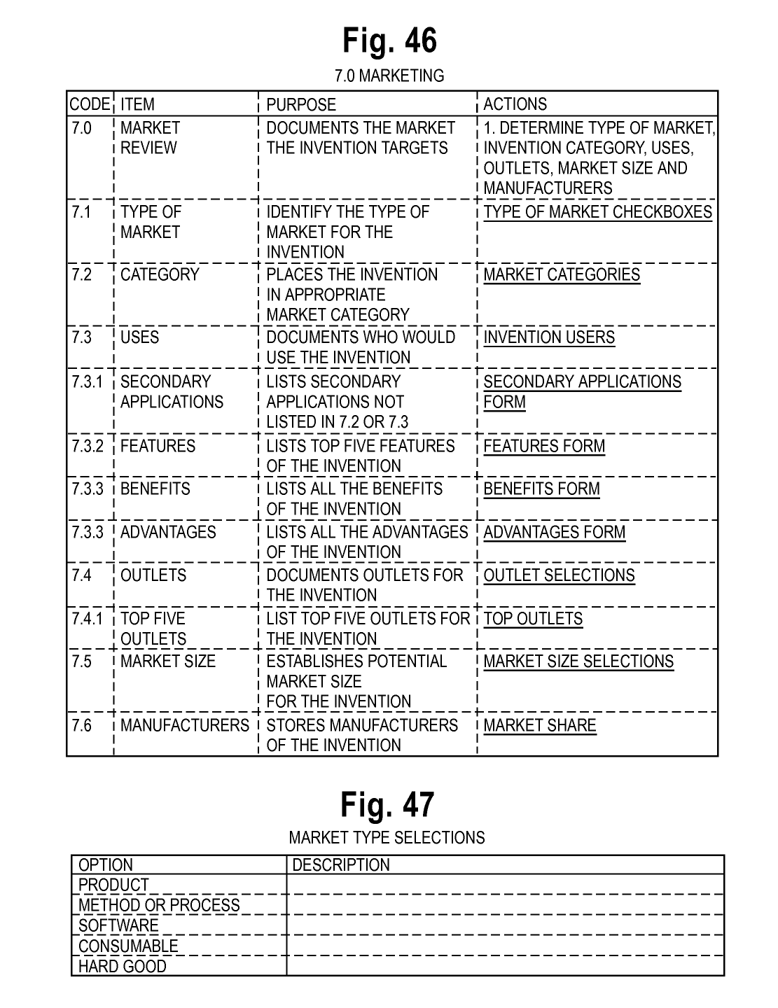

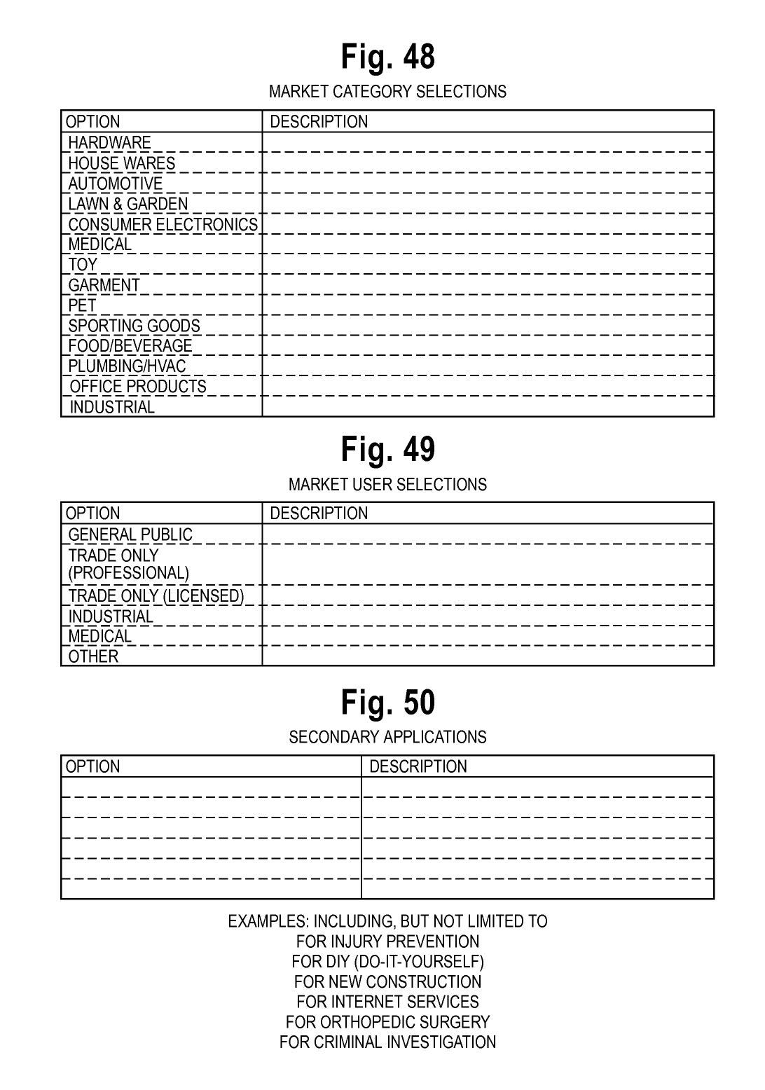

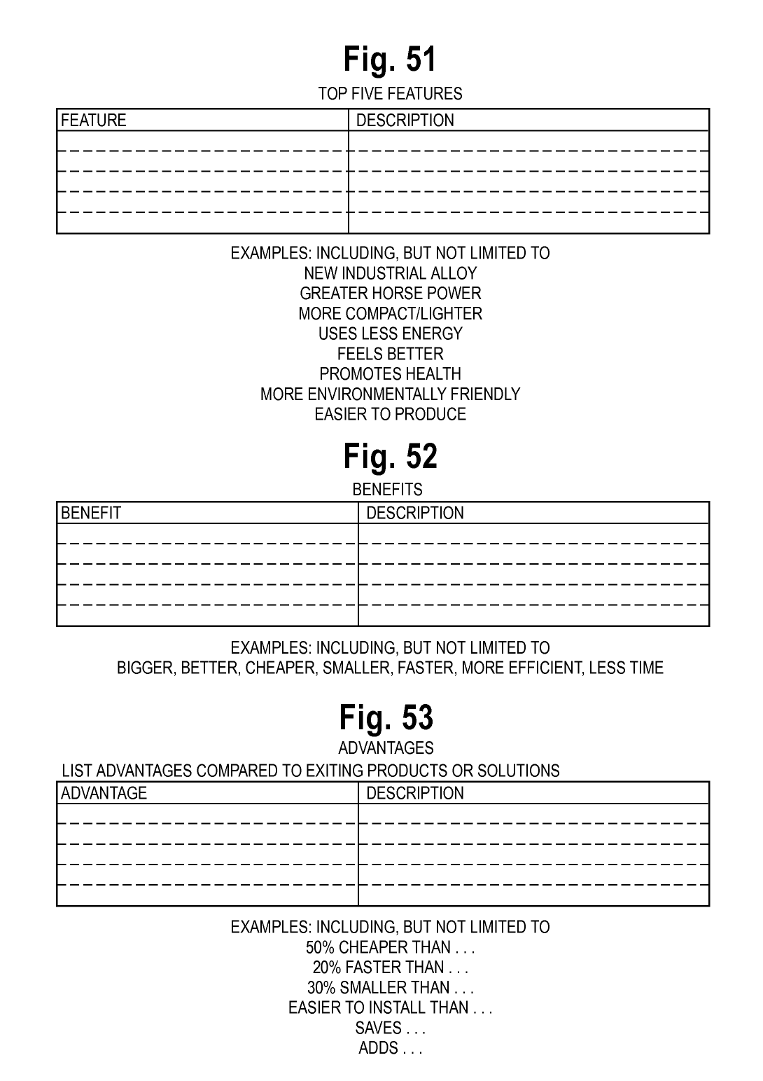

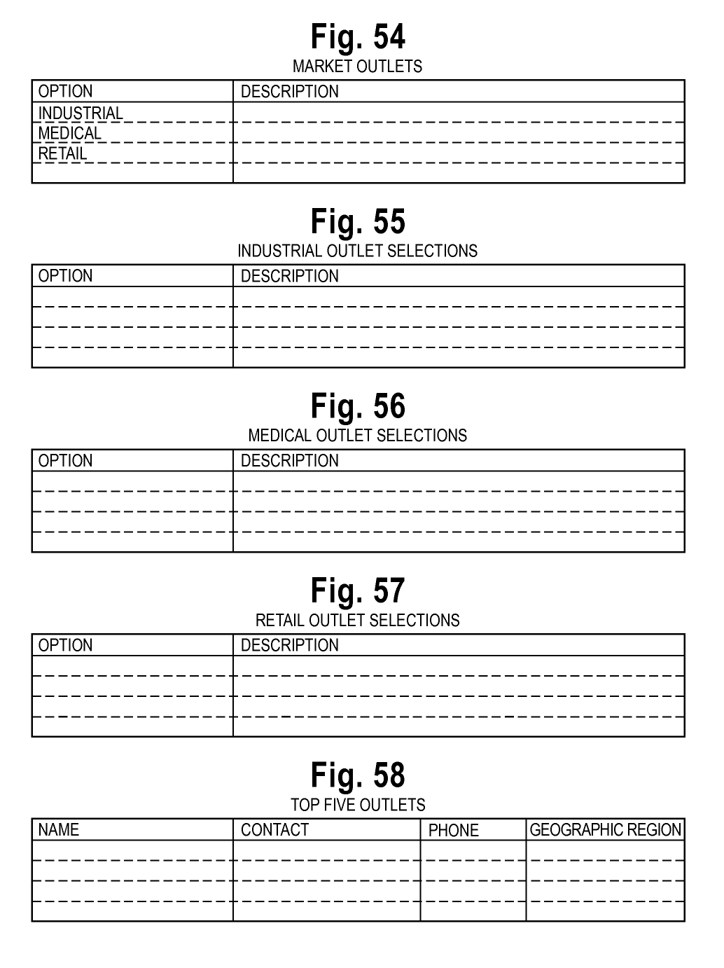

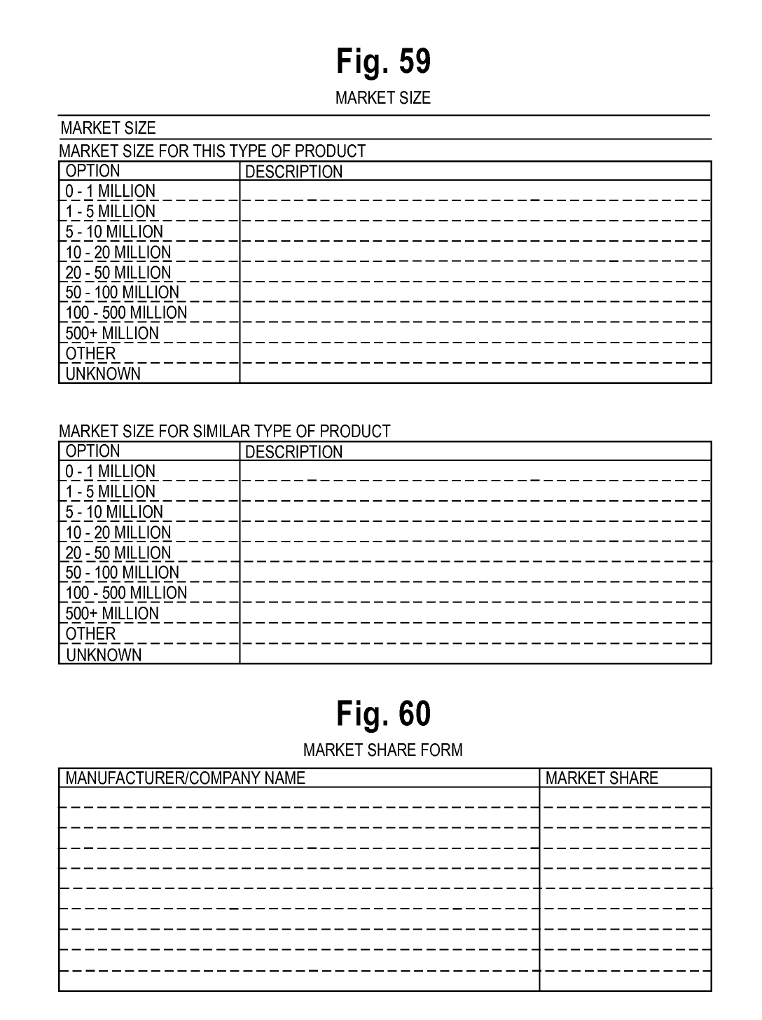

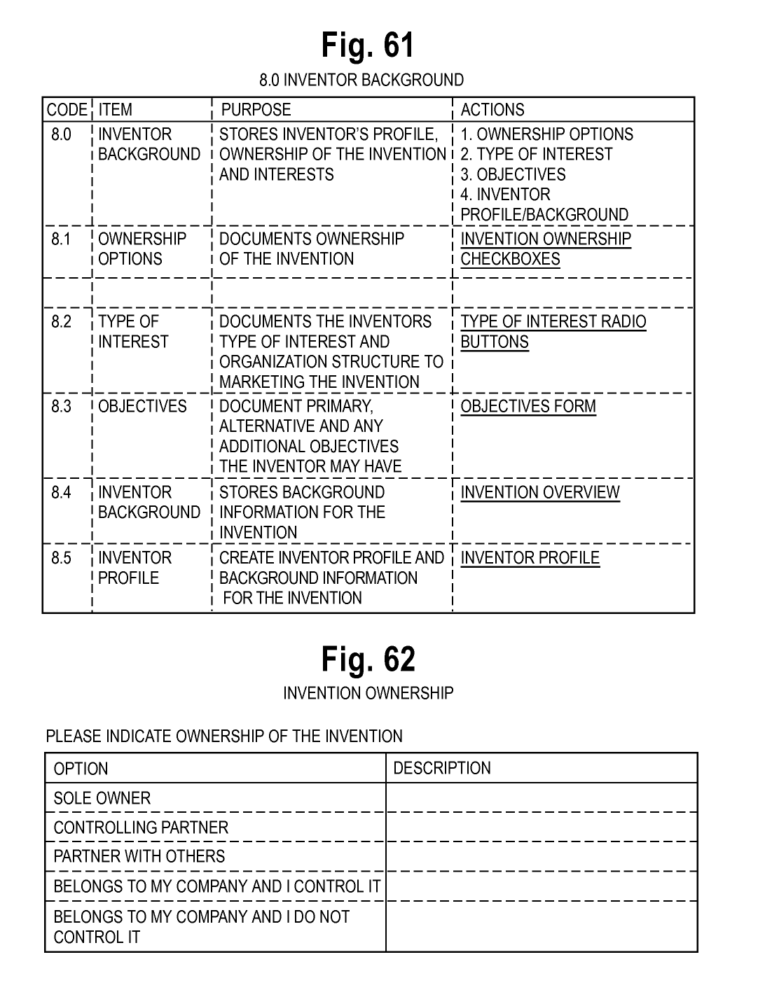

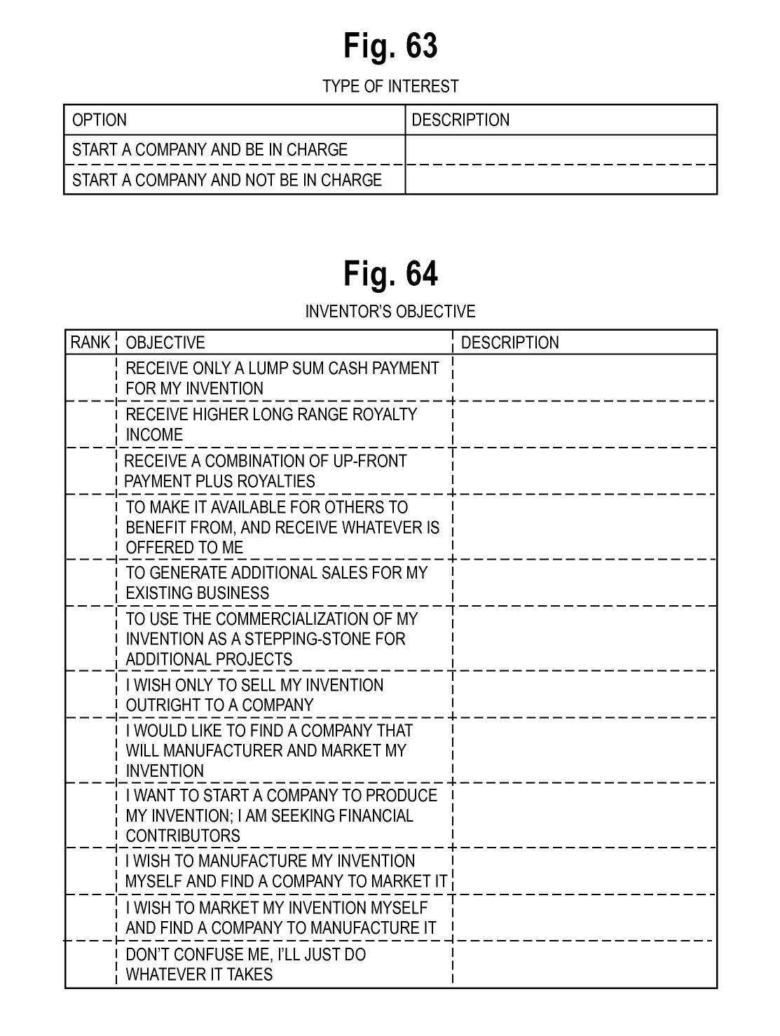

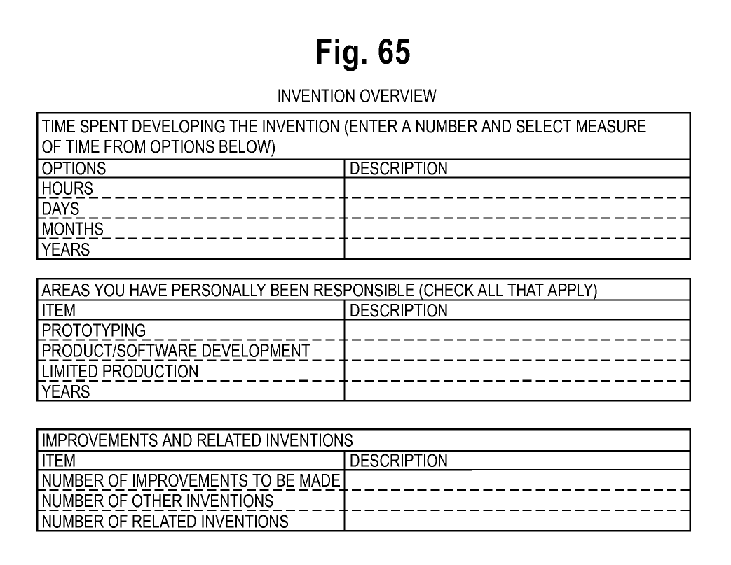

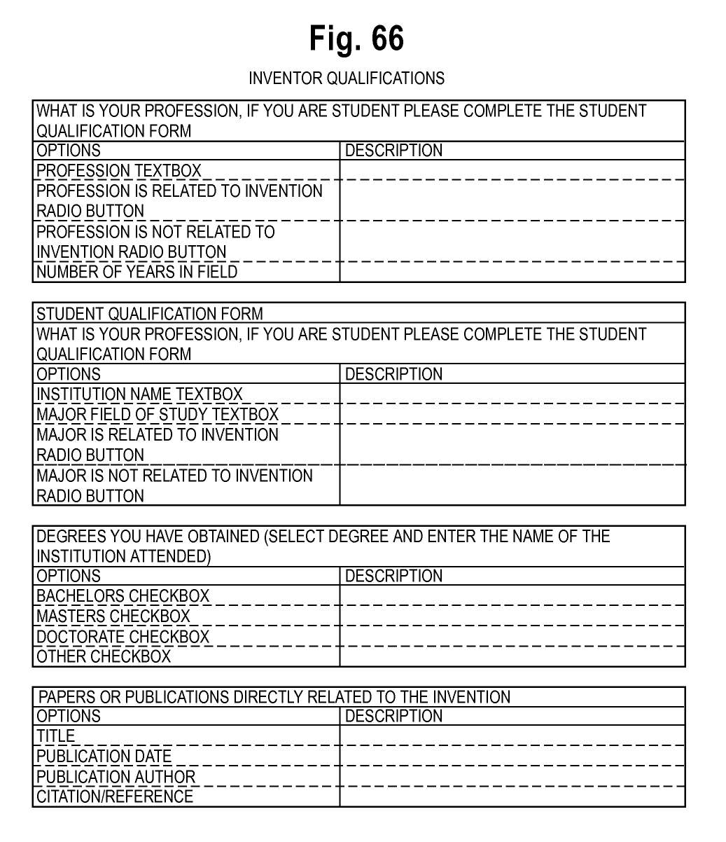

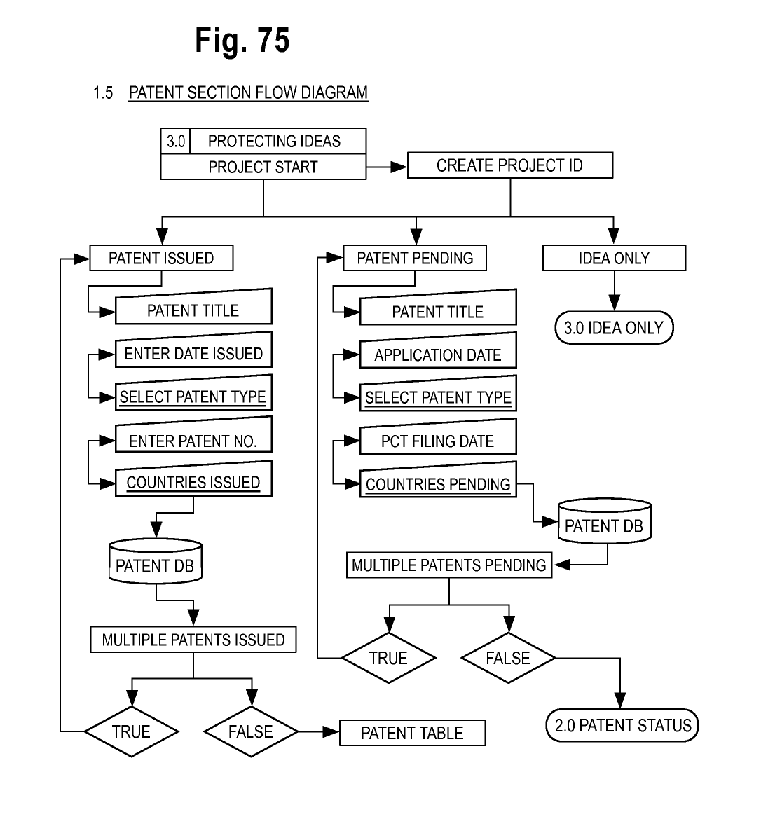

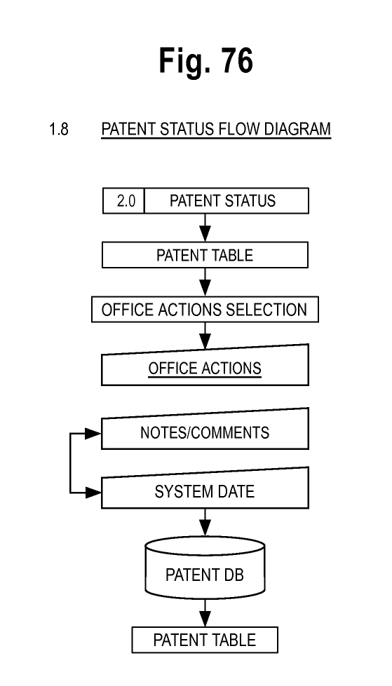

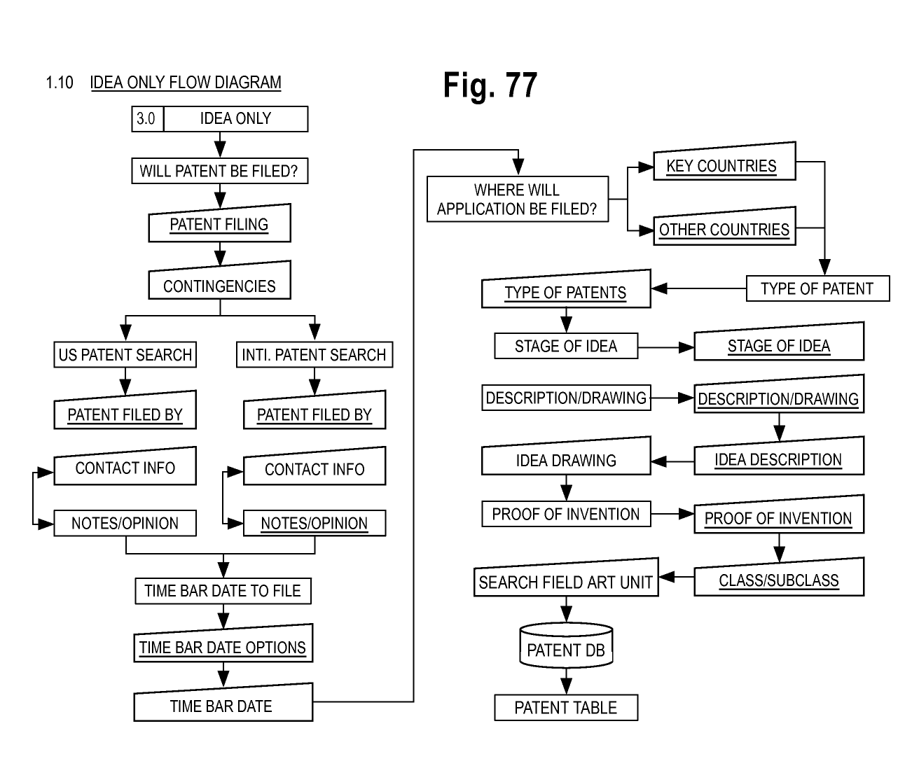

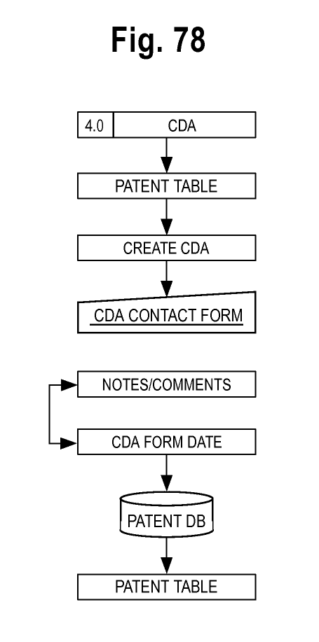

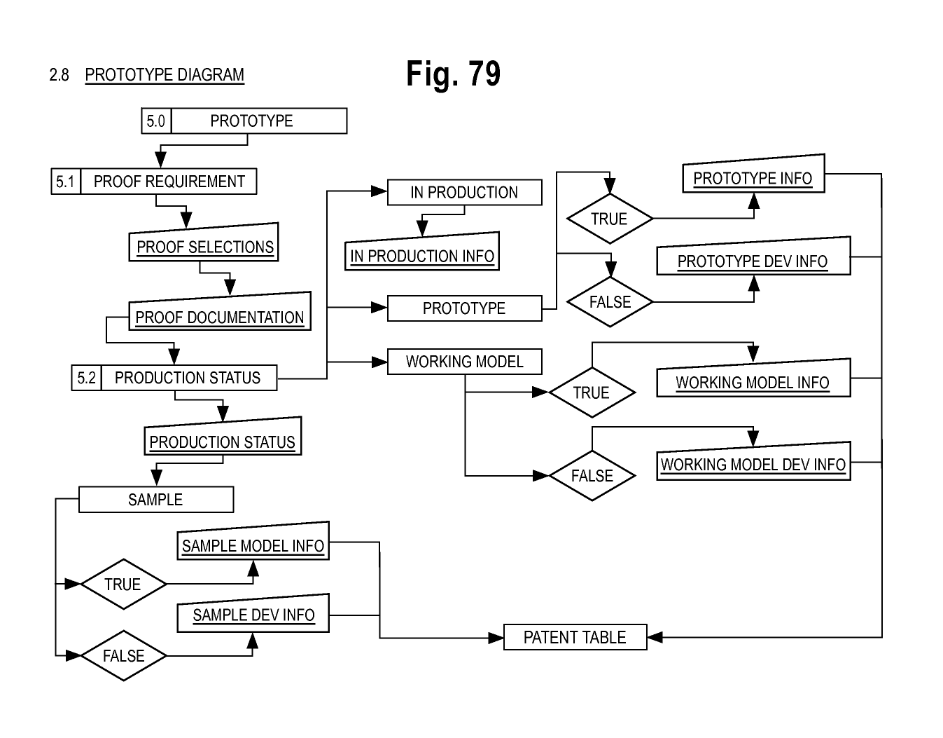

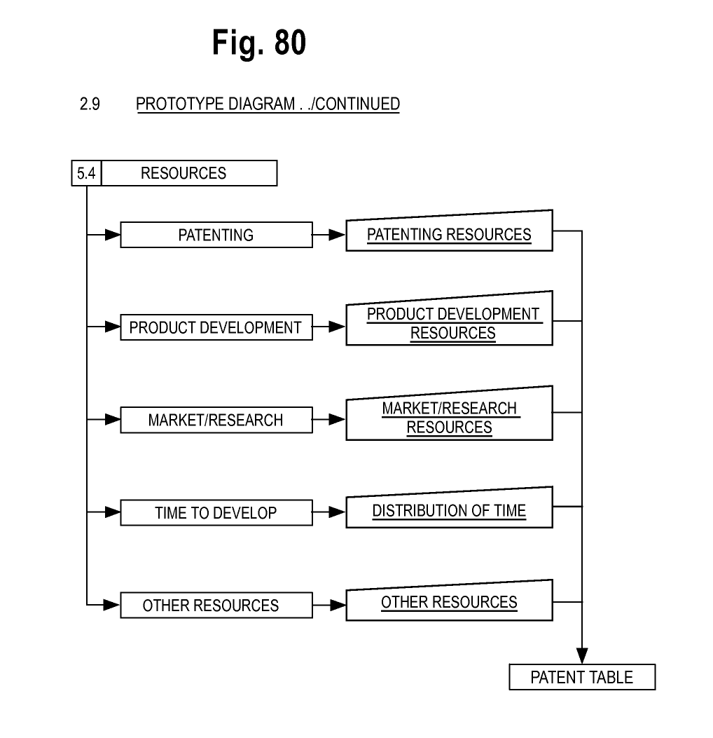

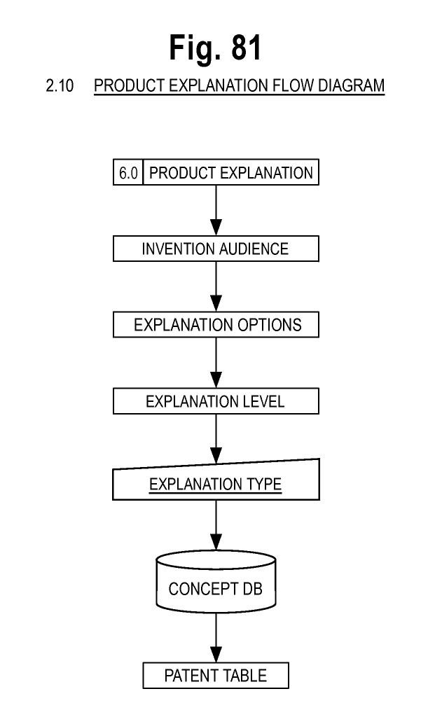

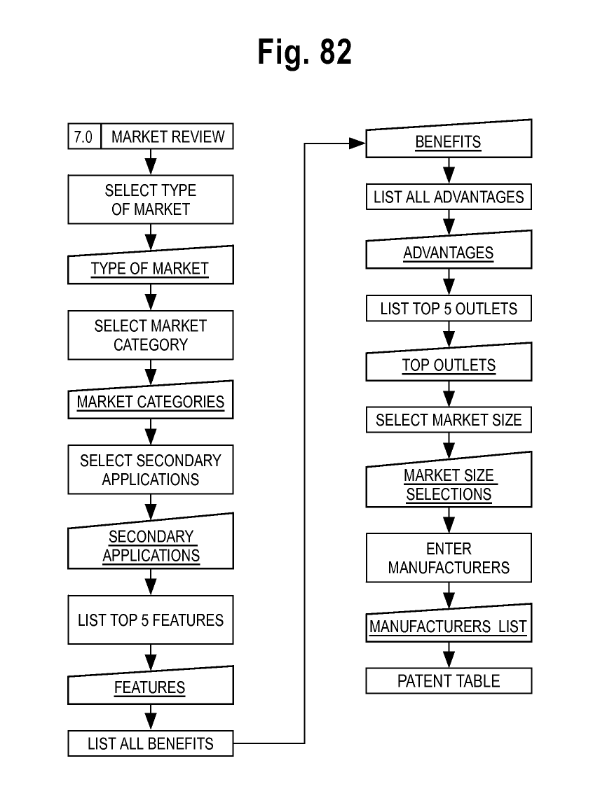

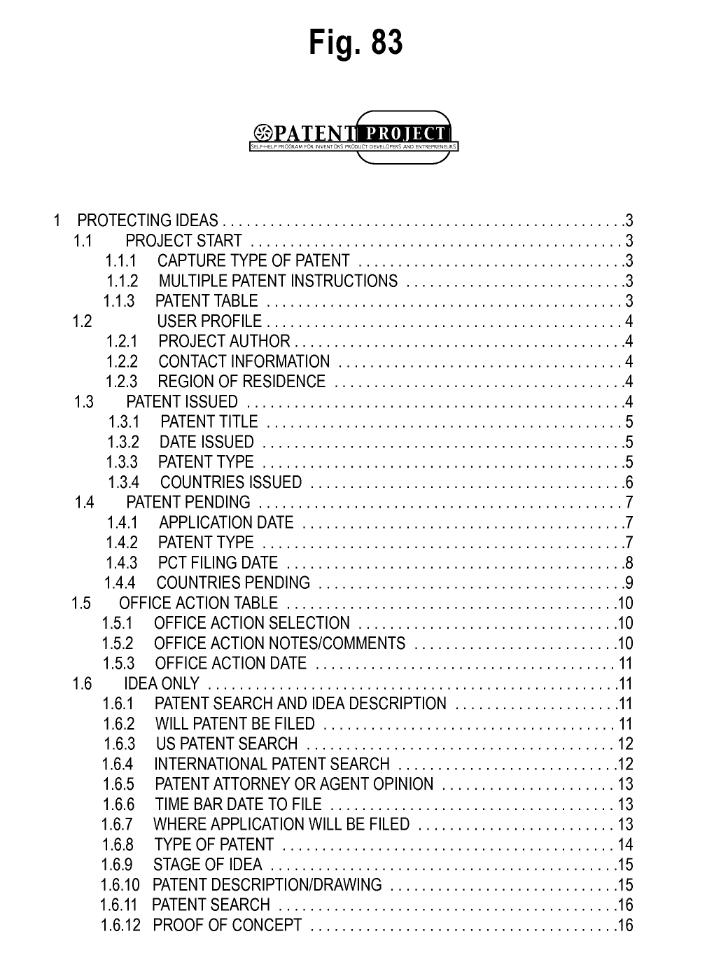

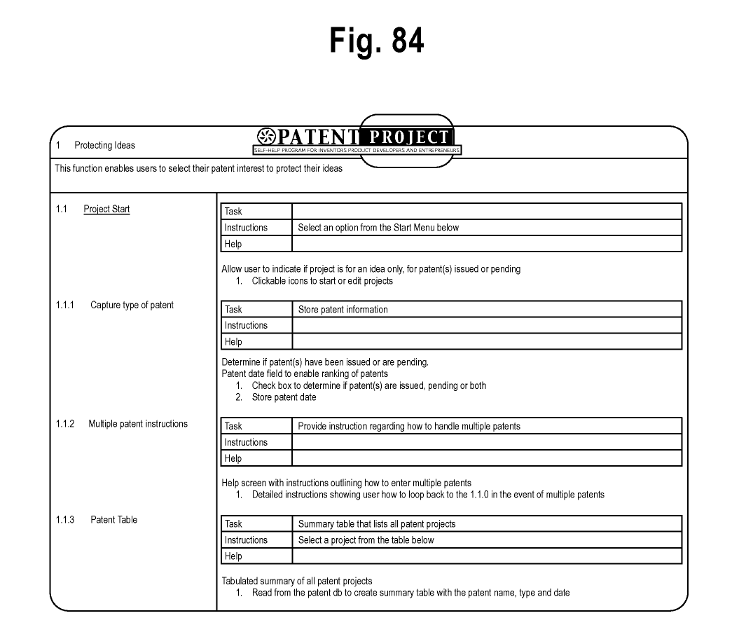

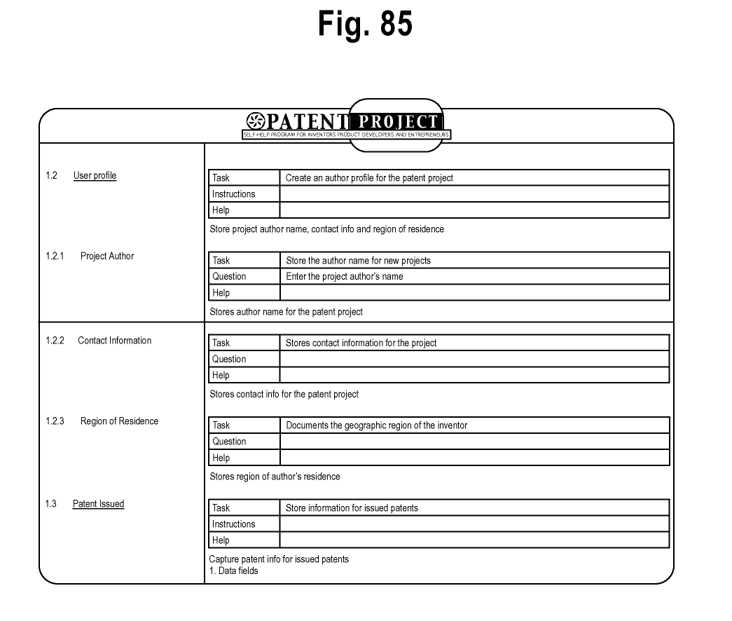

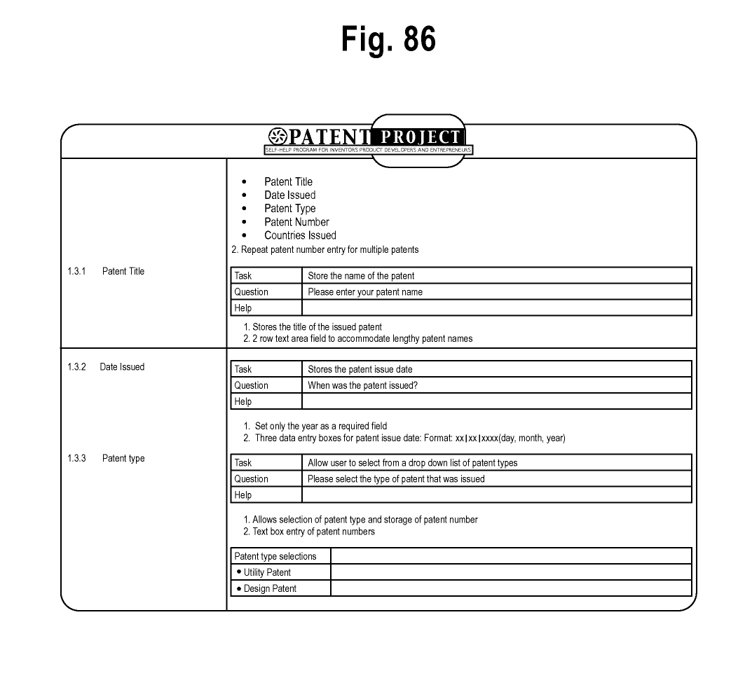

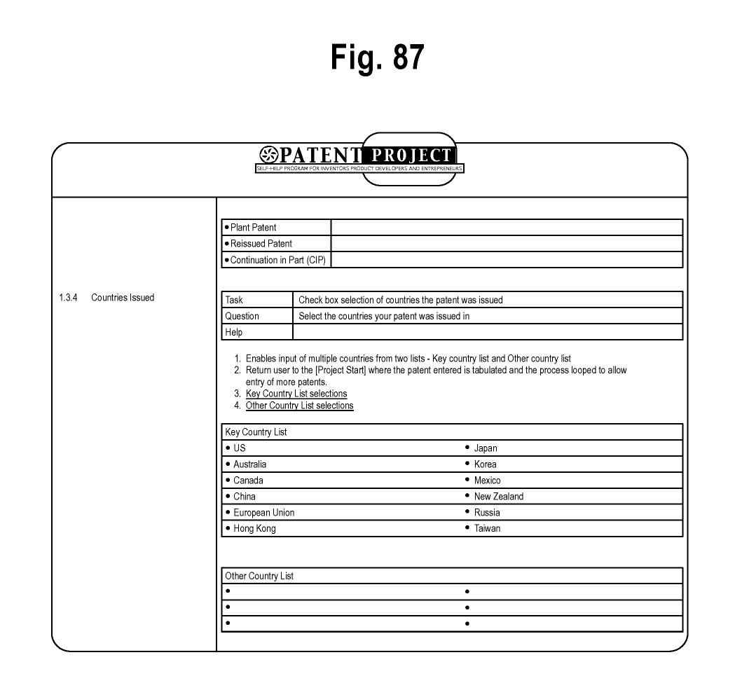

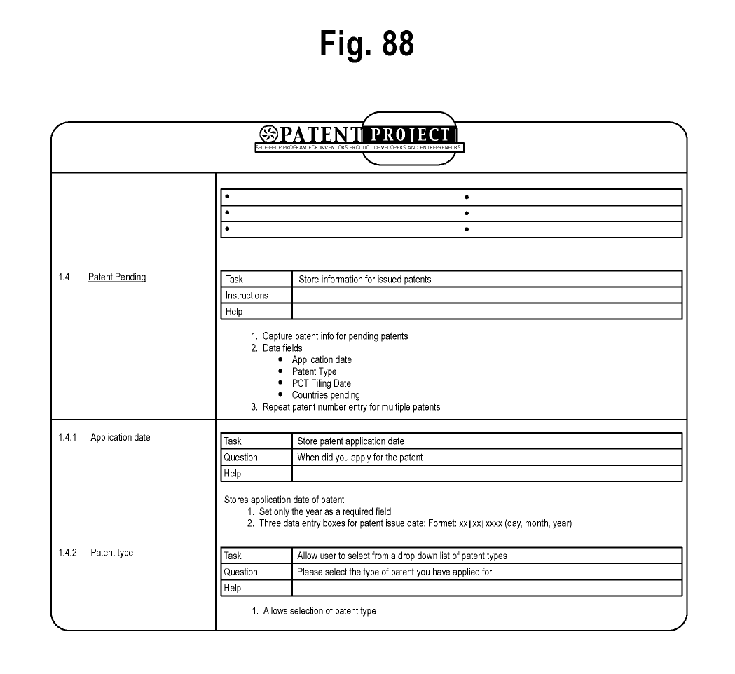

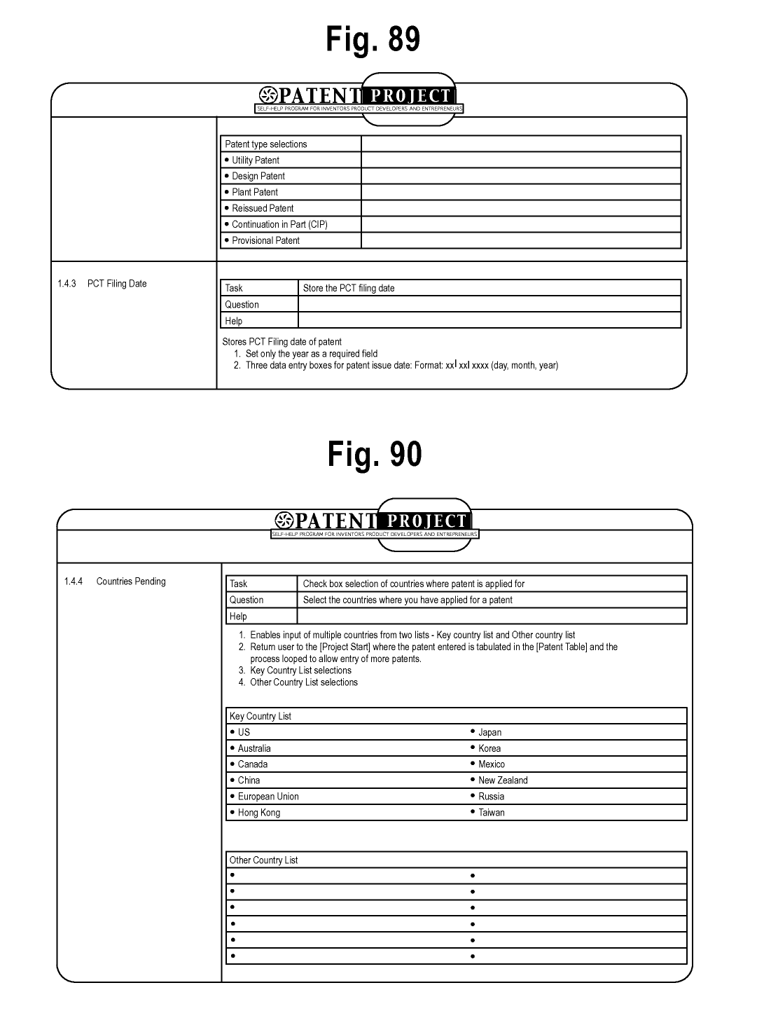

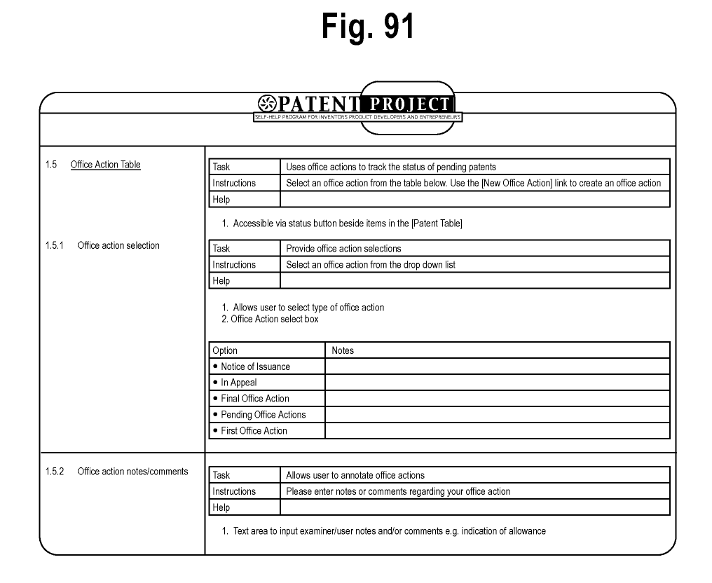

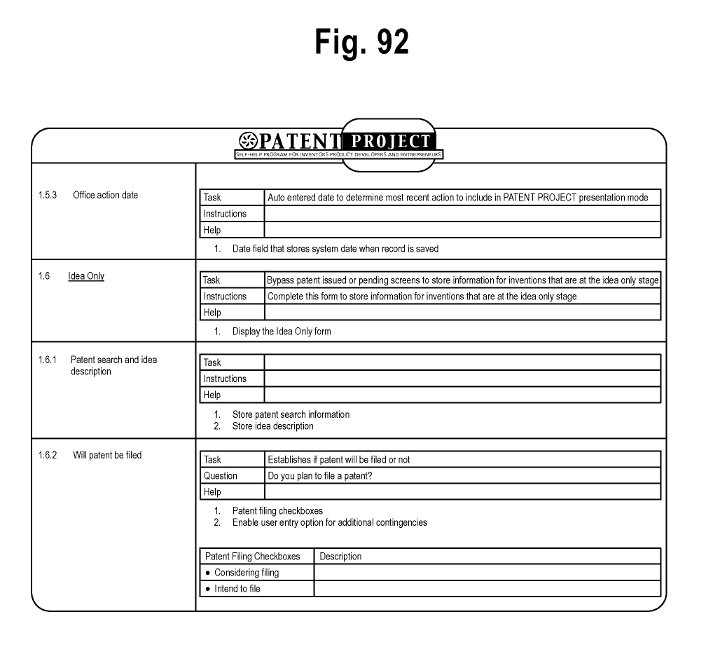

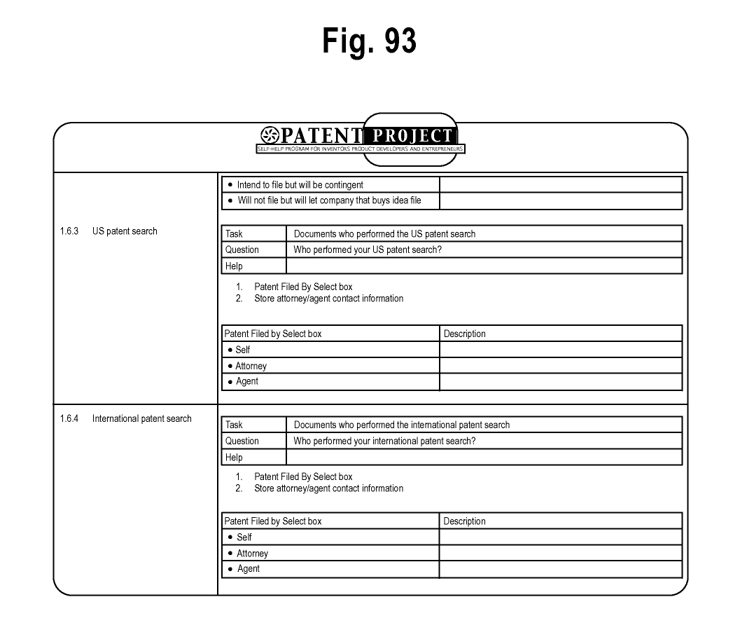

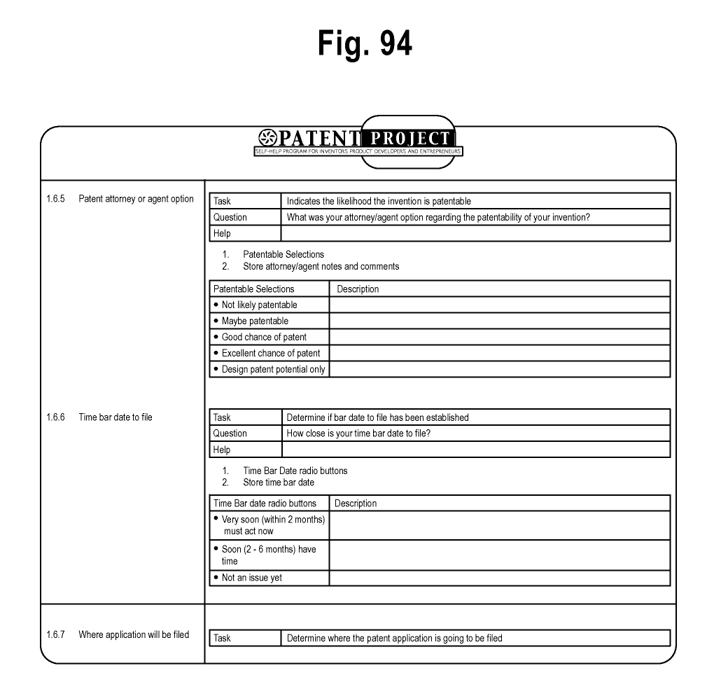

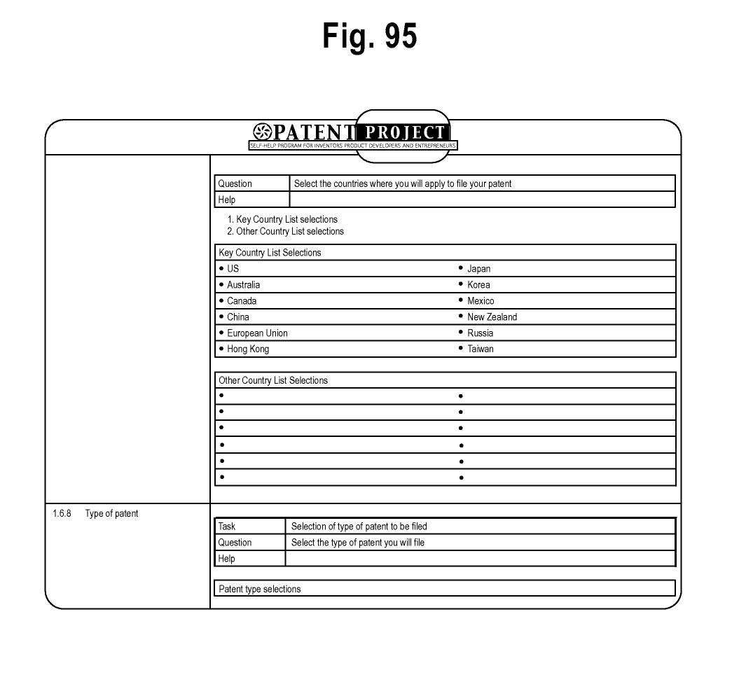

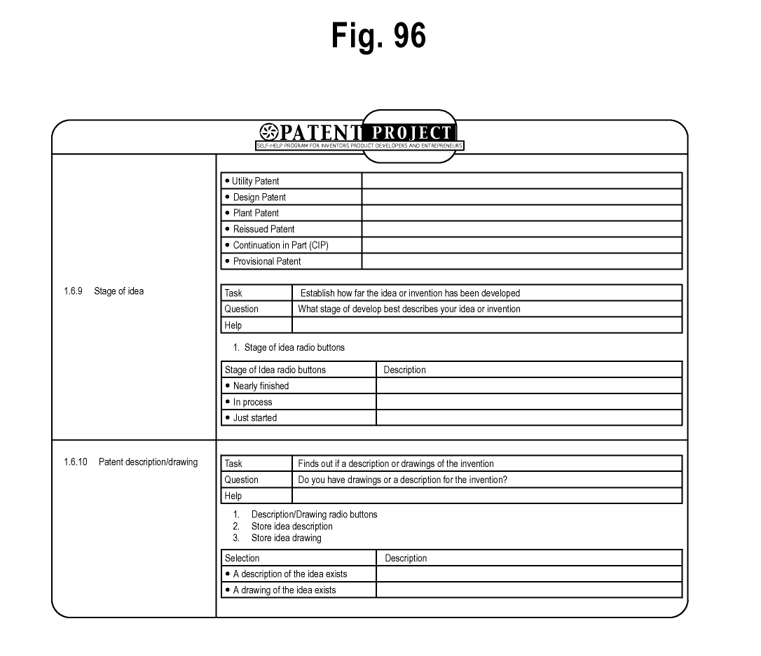

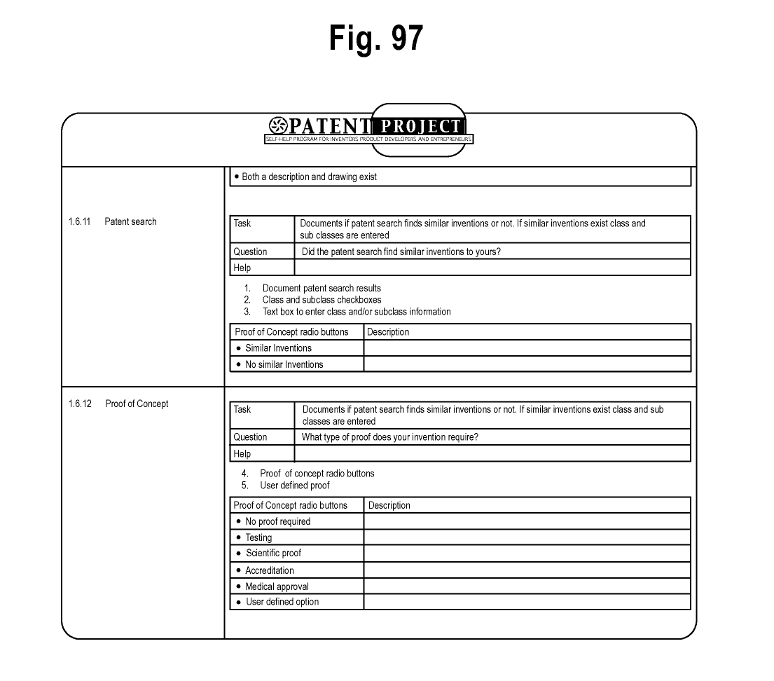

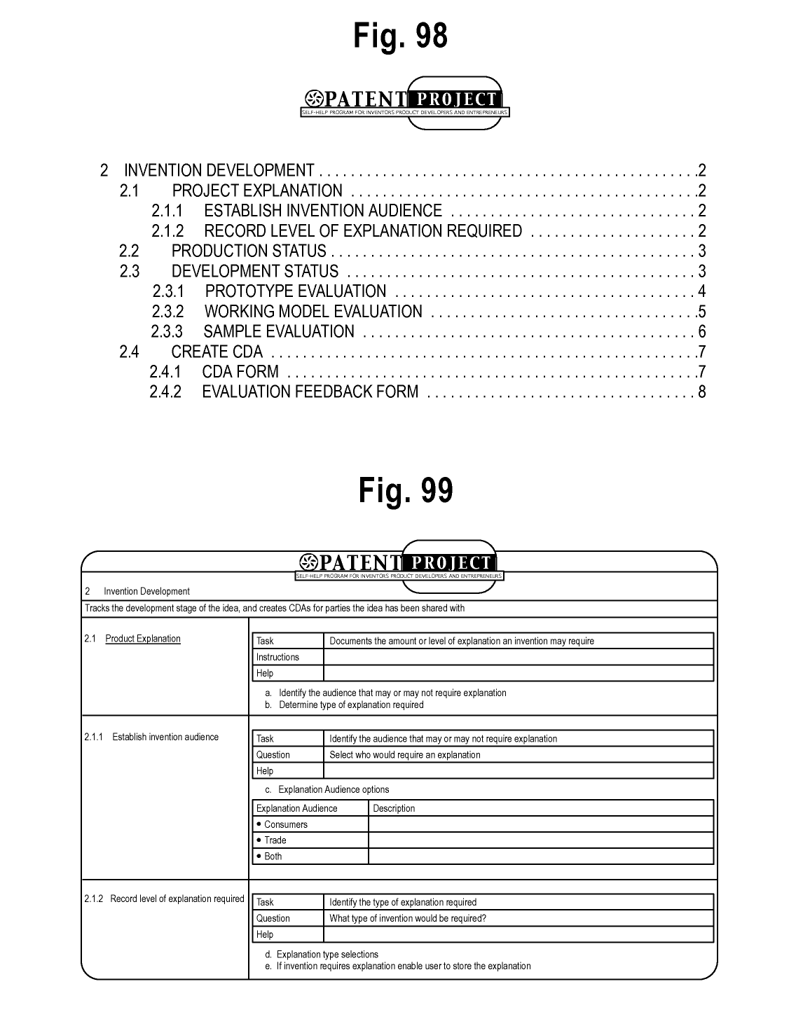

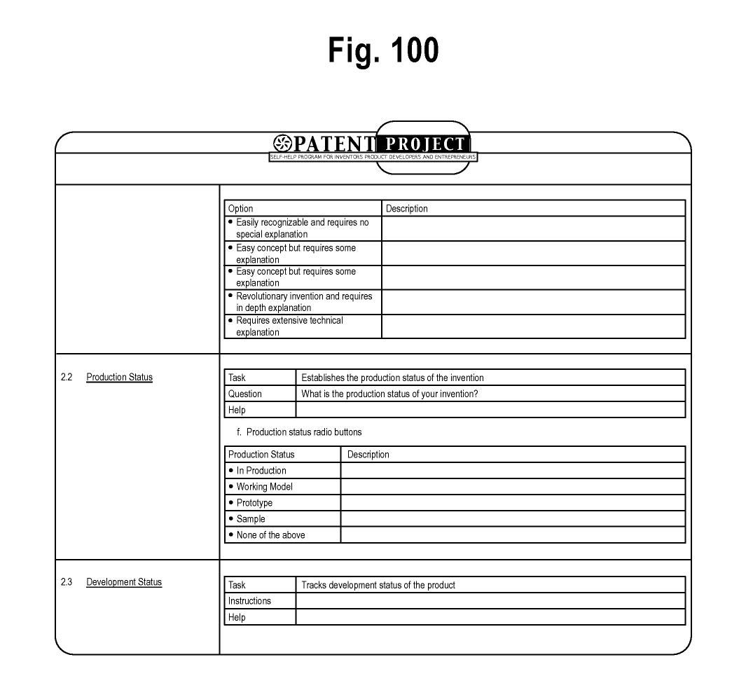

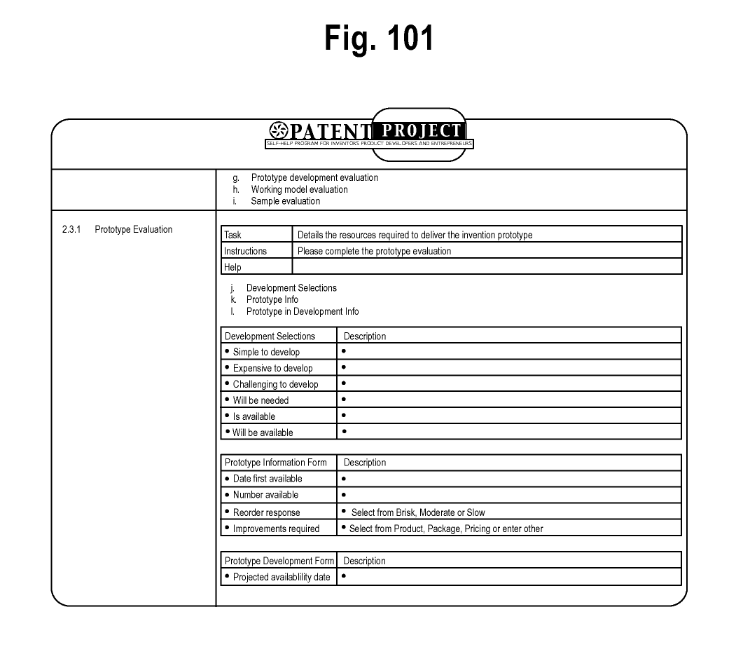

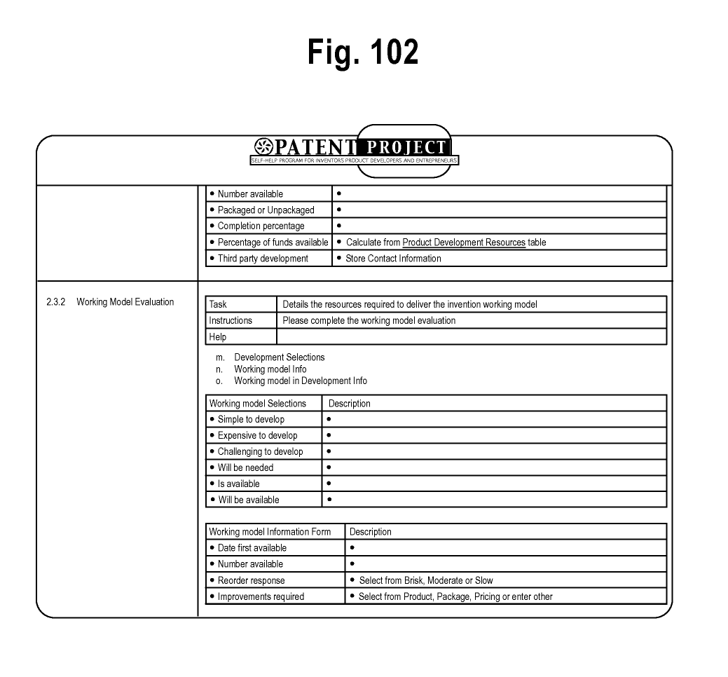

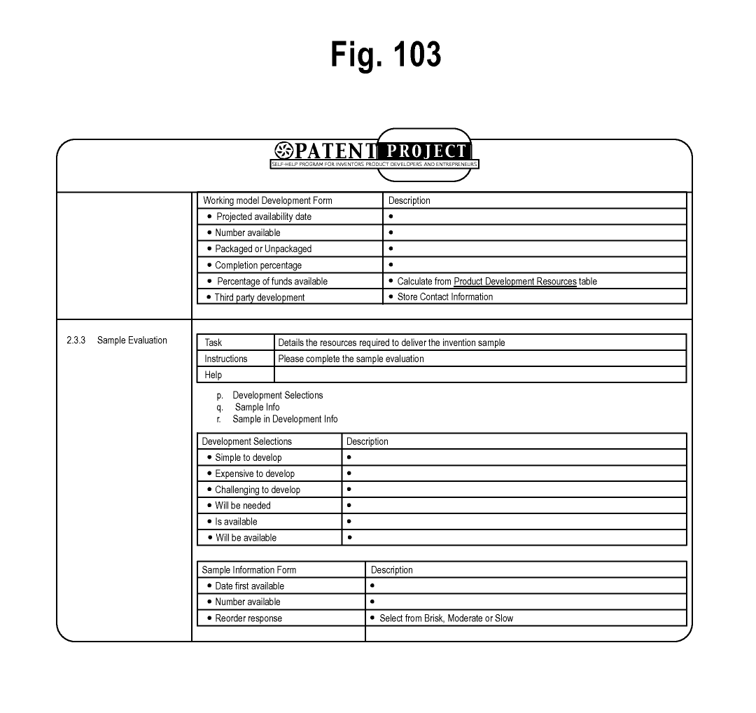

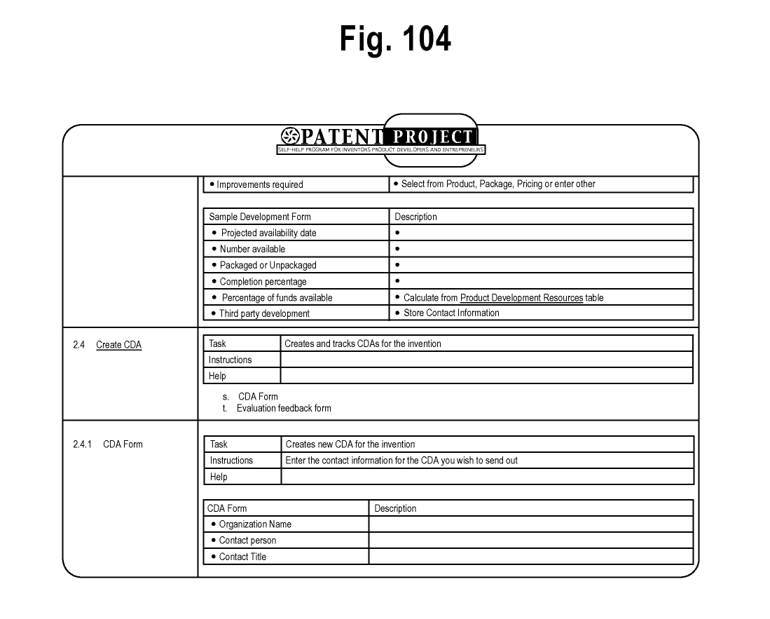

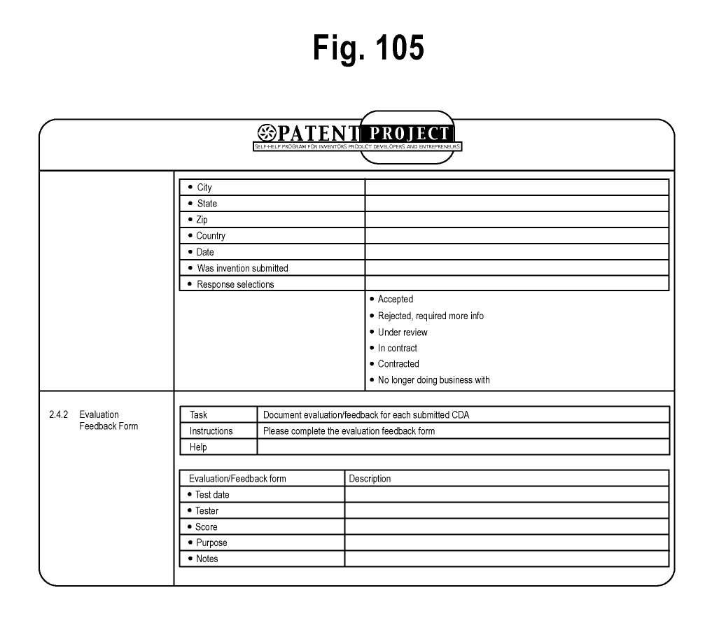

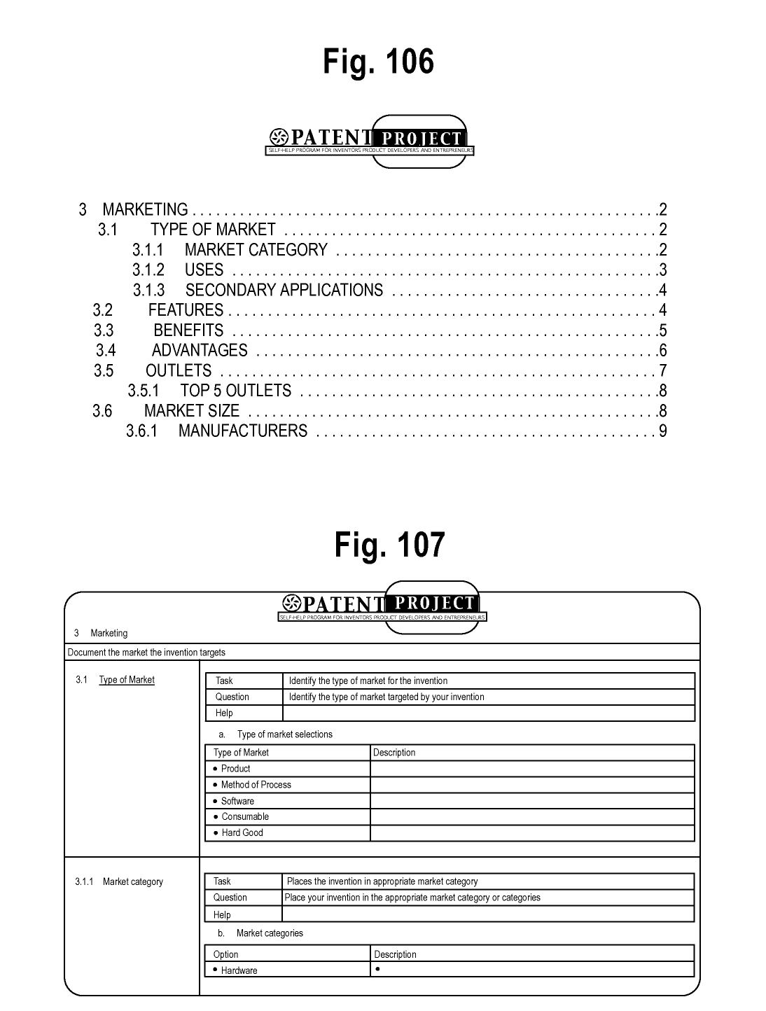

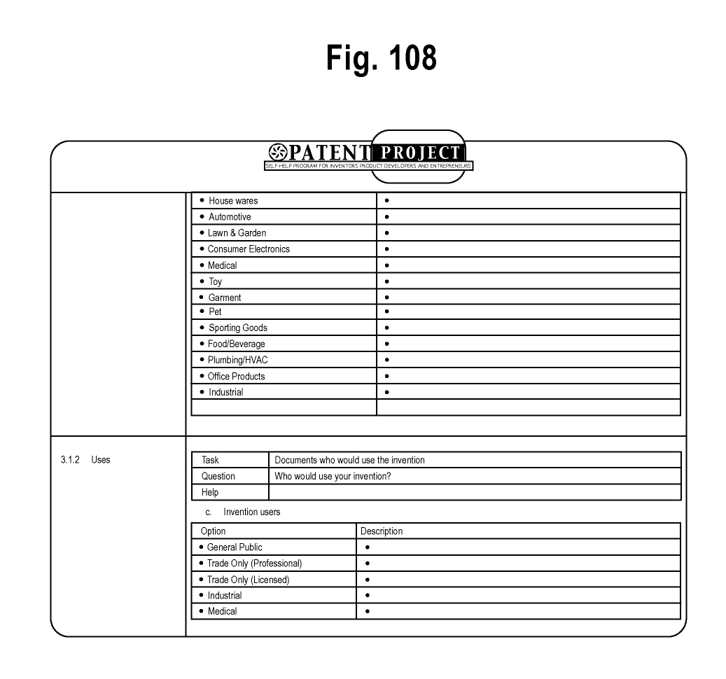

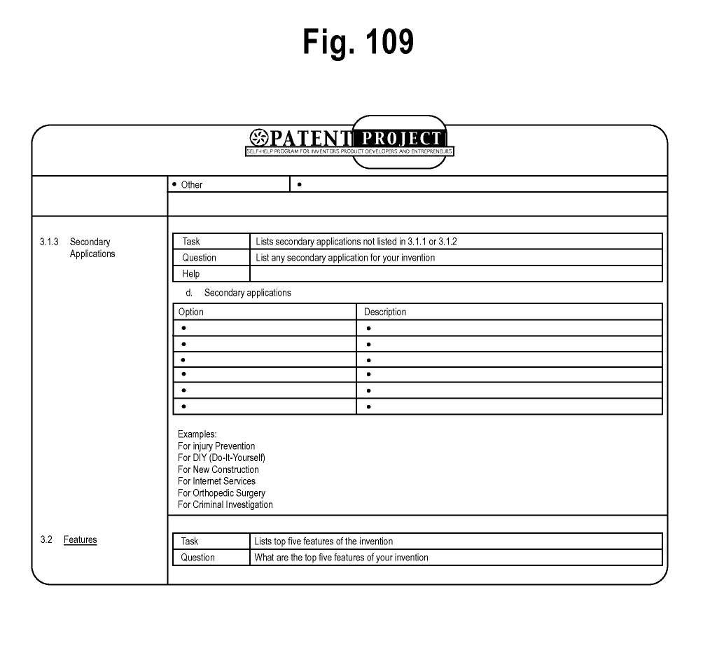

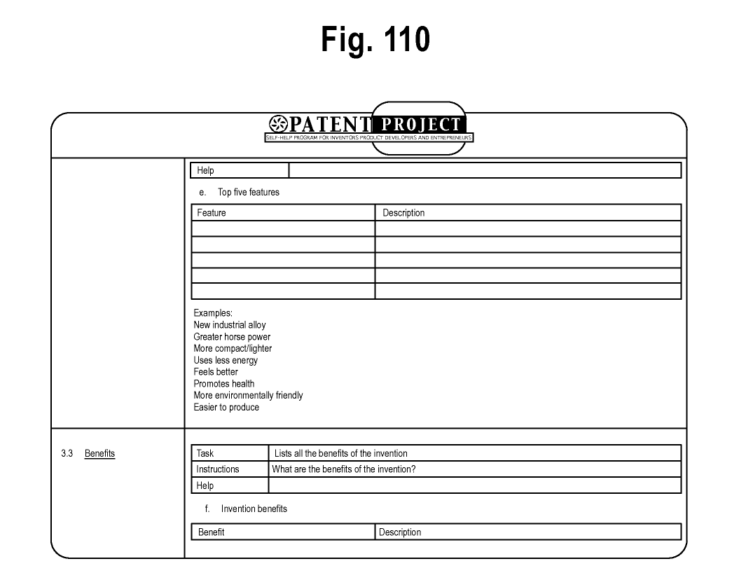

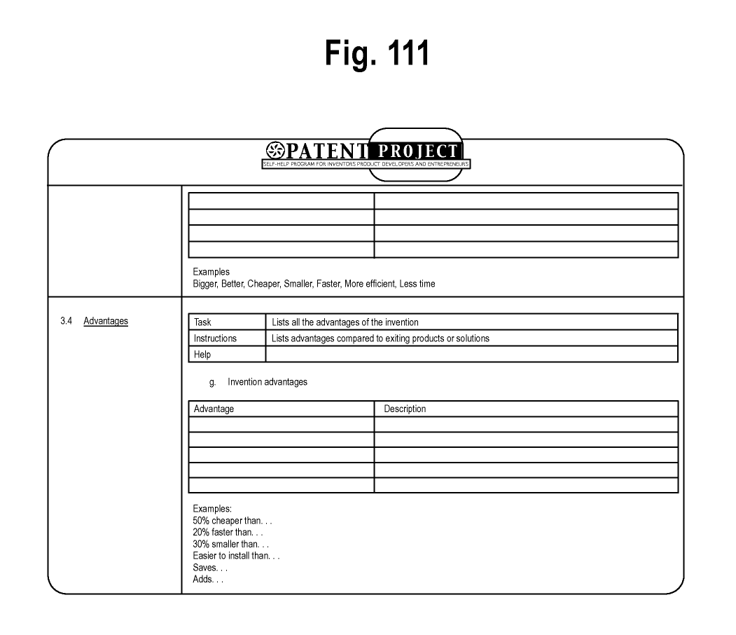

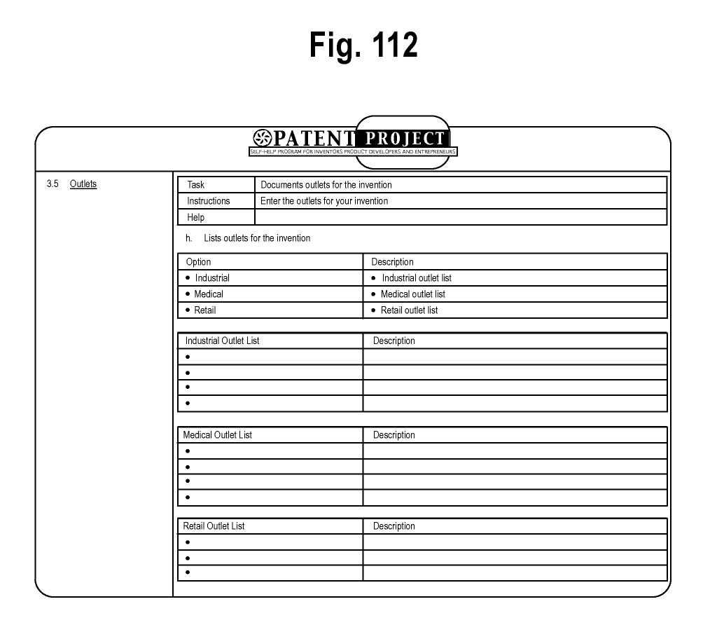

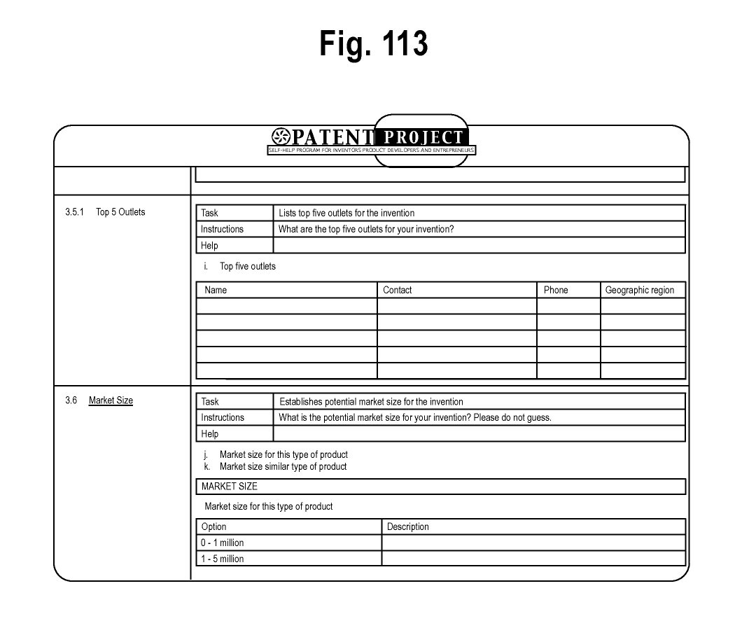

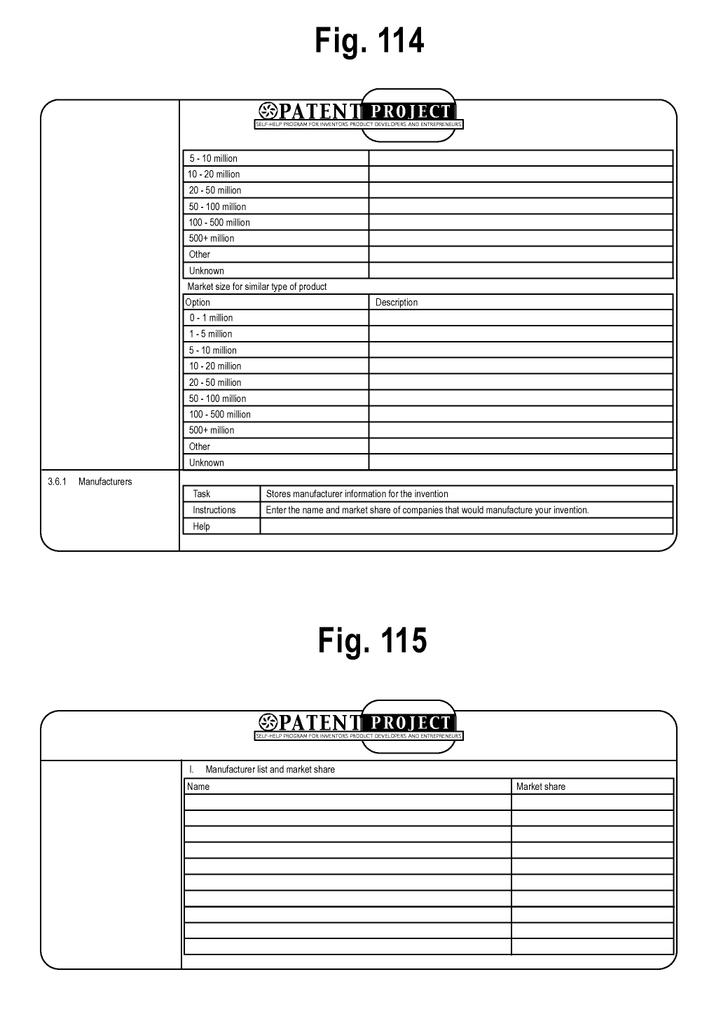

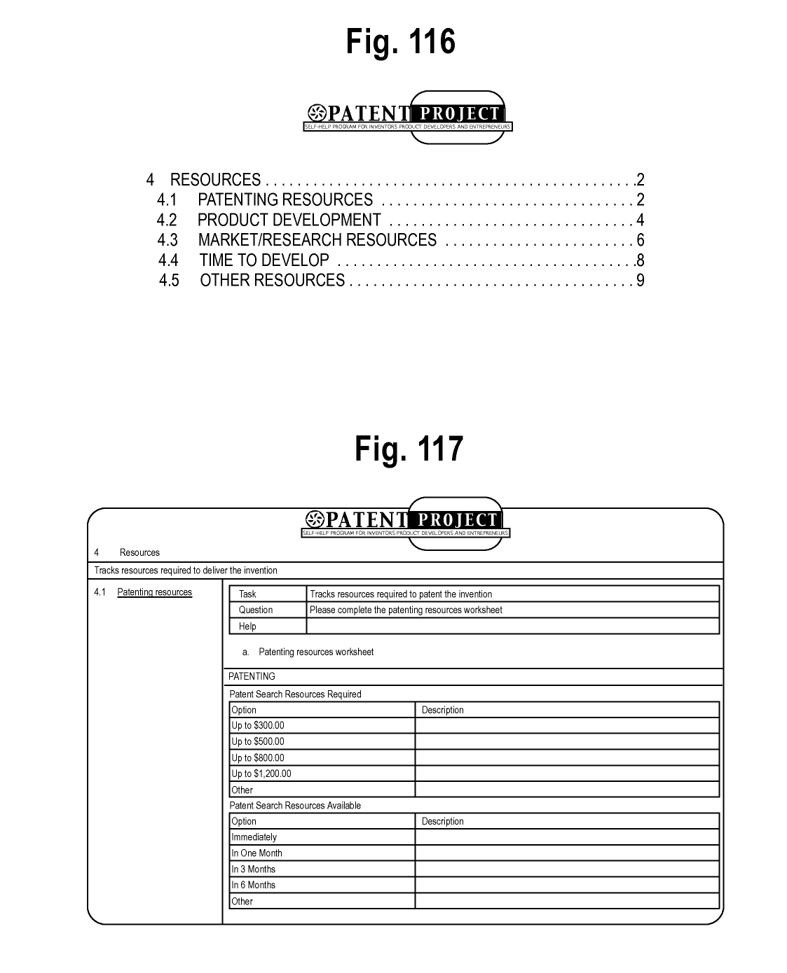

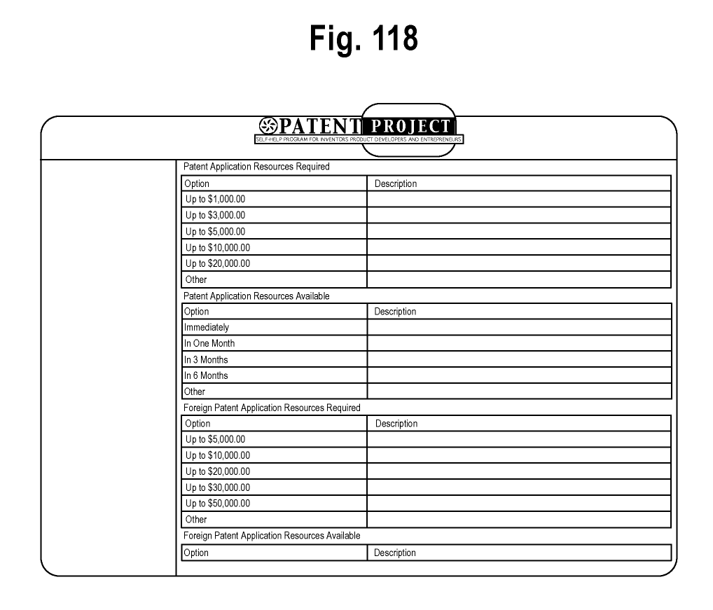

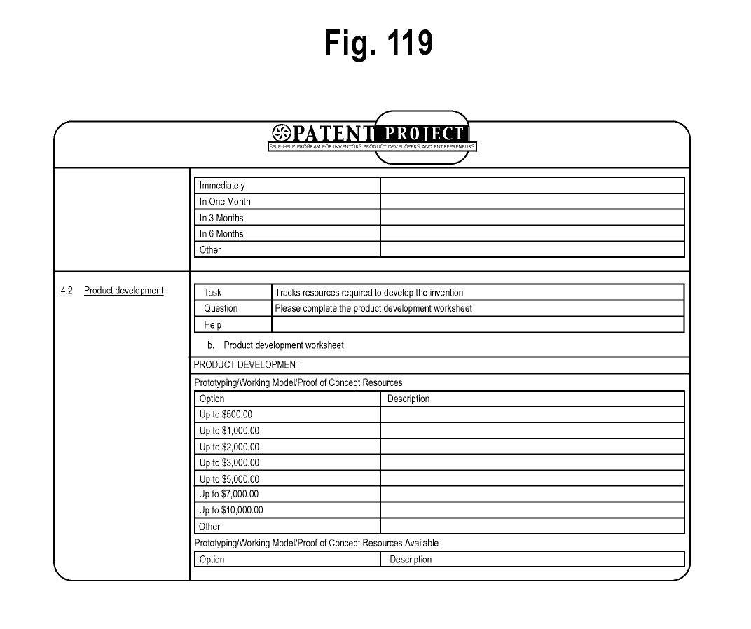

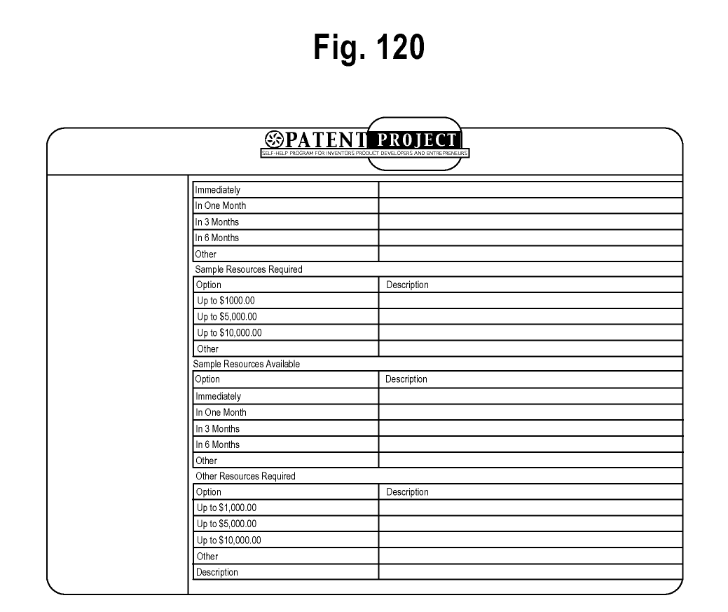

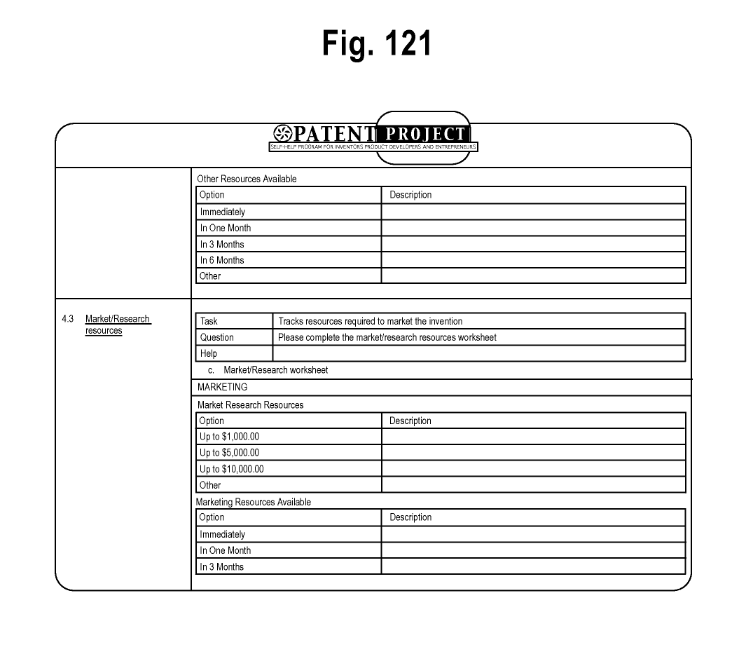

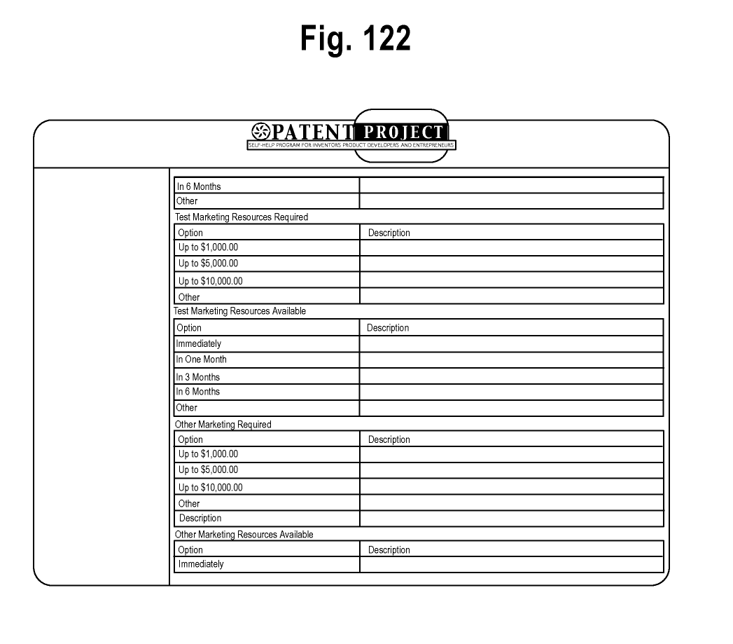

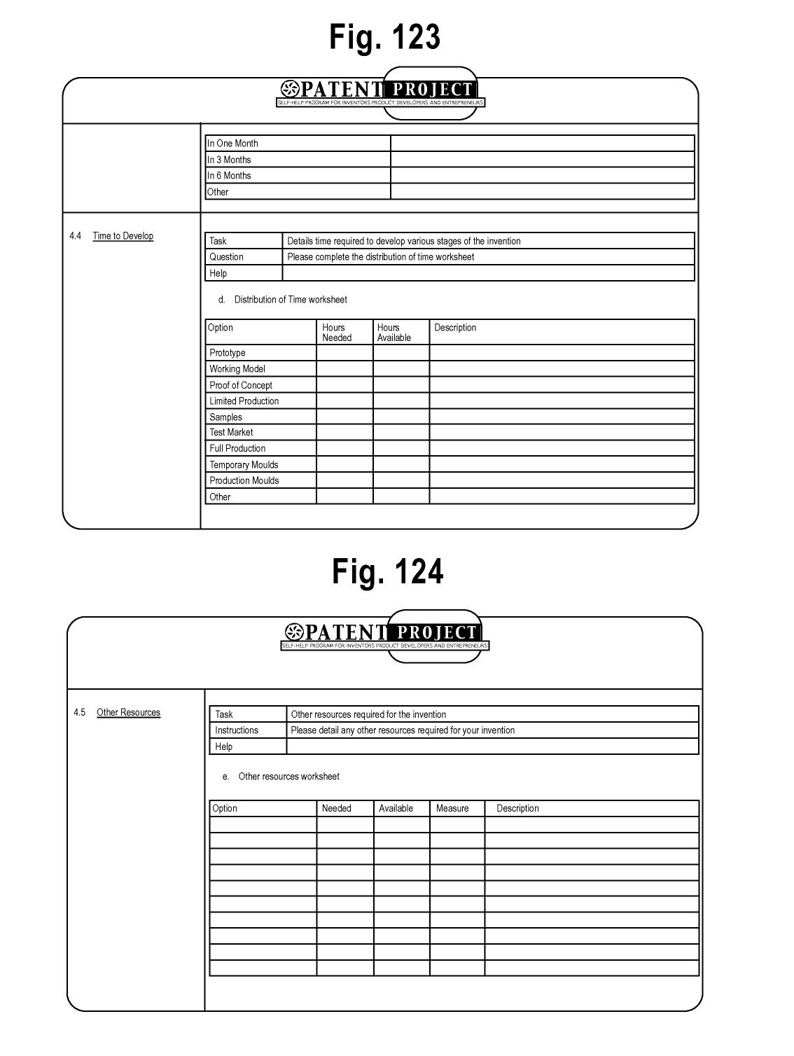

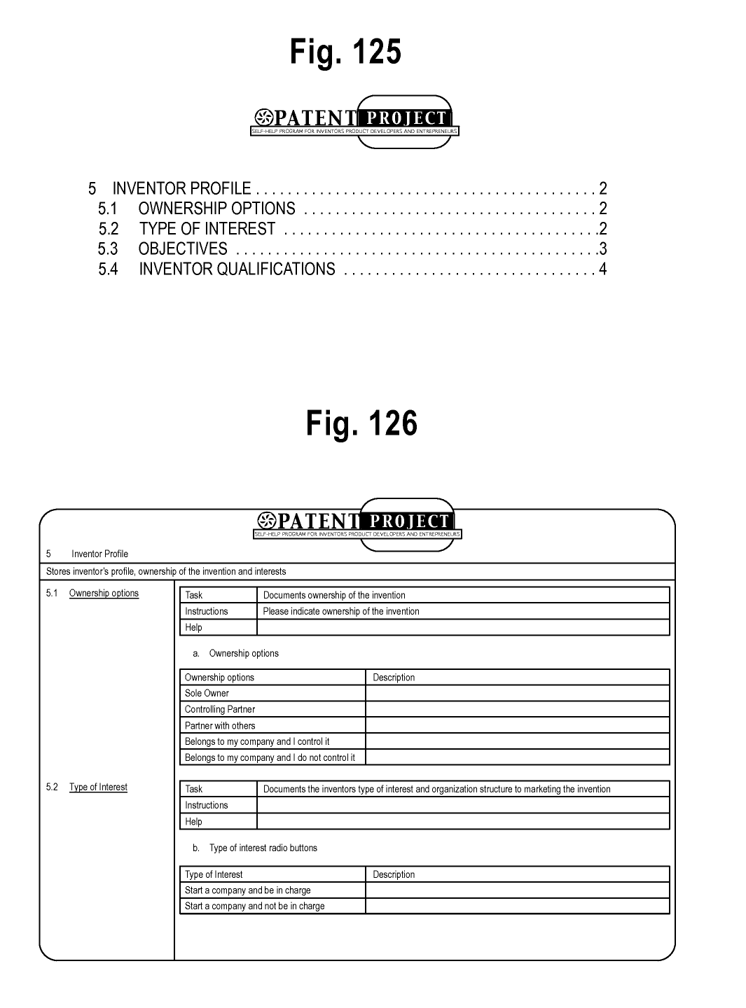

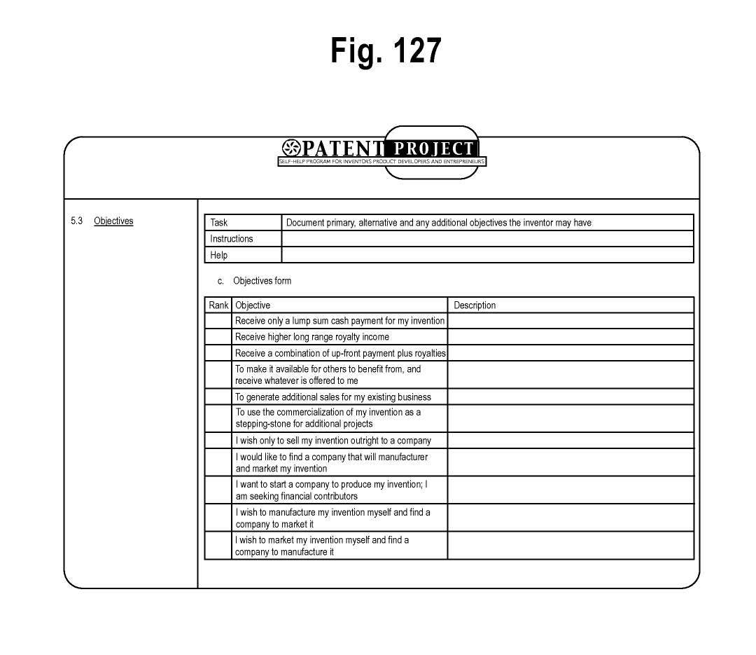

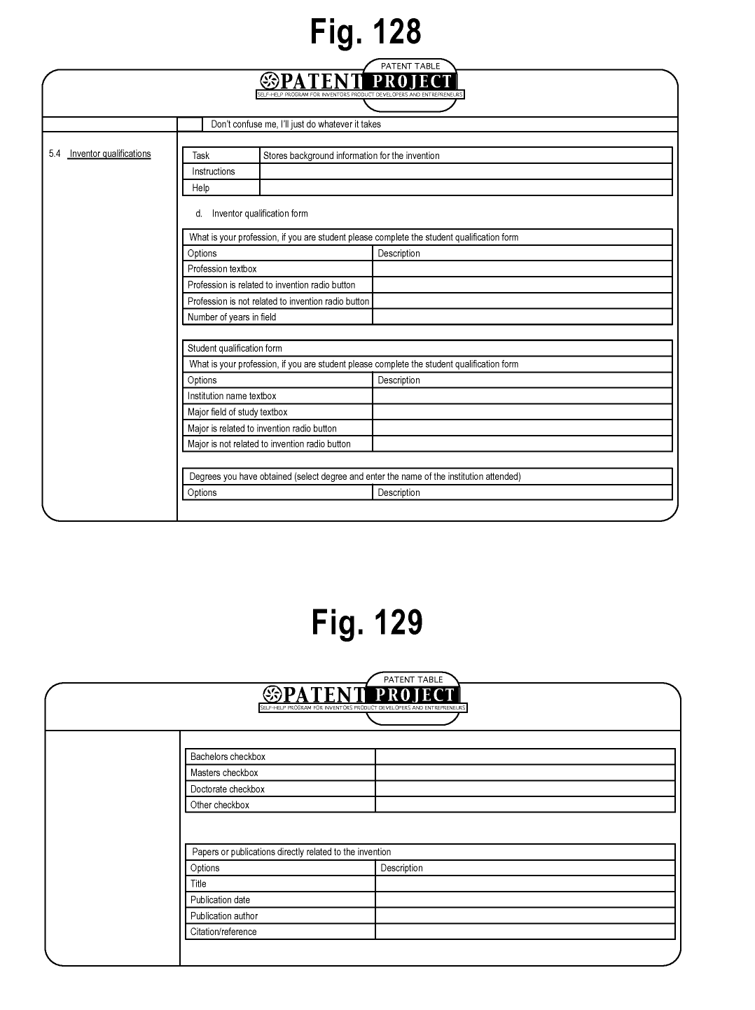

With respect to FIGS. 3-66 are illustrative of data and structures pertaining thereto, 67-74 are illustrative screens or screen shots, and FIGS. 75-82 are illustrative flow descriptions, and FIGS. 83129 are illustrative of other embodiments with respect to FIGS. 3-66.

Consider an “INVENTION COMPUTER SYSTEM” as an easy-to-use, self-help system, e.g., for inventors, product developers, and entrepreneurs. A user (i.e., innovator 2) fills in blanks and/or makes selections from an existing data base, and tutorial guides help the user through all the steps.

Depending on the configuration preferred for a particular implementation, the INVENTION COMPUTER SYSTEM Introductory Program can include three phases.

Phase I. This phase establishes a baseline of information for inventions to provide self-help advice, and points users in the right direction. At the same time, it automatically creates a presentation for invention projects.

Phase II. This phase points out the value of an invention, which companies to approach, and how to start developing strategies to maximize potential income from an invention.

Phase III. Guides users through steps to present an invention to appropriate manufacturers and companies that may want to either purchase or license the invention. It is in this stage that inventors may discover whether they have a winner or not. Even if the invention does not seem to be a winner, the information gathered through this phase helps to improve and redesign an invention so that it does subsequently receive better acceptance in the industry.

In whatever embodiment is preferred, an implementation can involve answering questions—filling in the blanks—and the INVENTION COMPUTER SYSTEM computer system carries out the implementation. Further, a tutorial is provided to facilitate the process. A help guide wizard answers questions along the way and defines terms that may be unfamiliar.

One of the unique features of INVENTION COMPUTER SYSTEM is that a user need not reveal the trade secrets of an invention to anyone, if so desired. This can be significant when seeking to learn about the value of an invention, and garnering other valuable information.

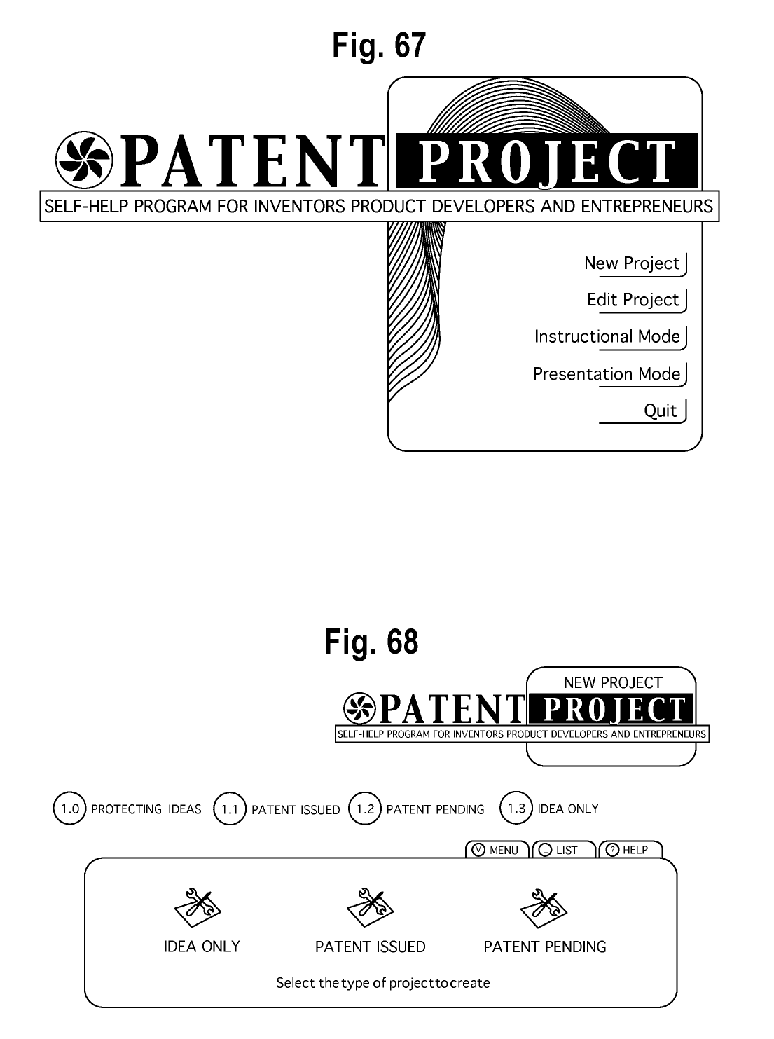

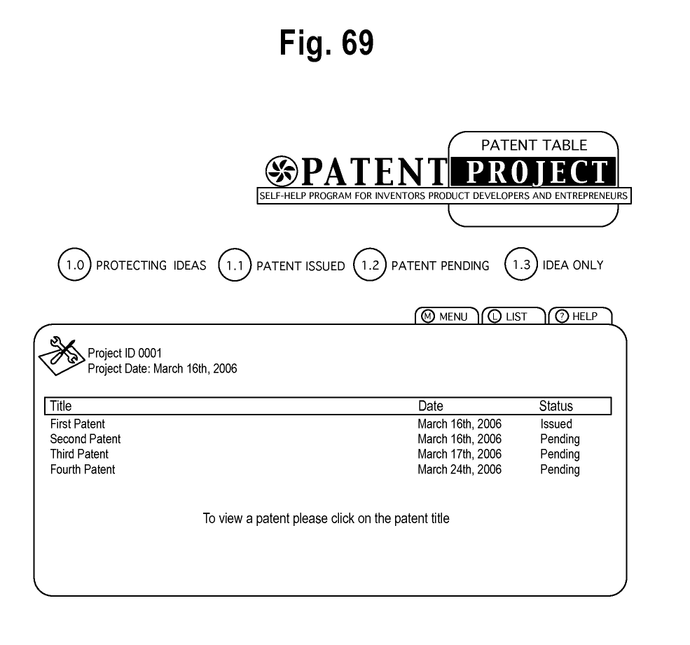

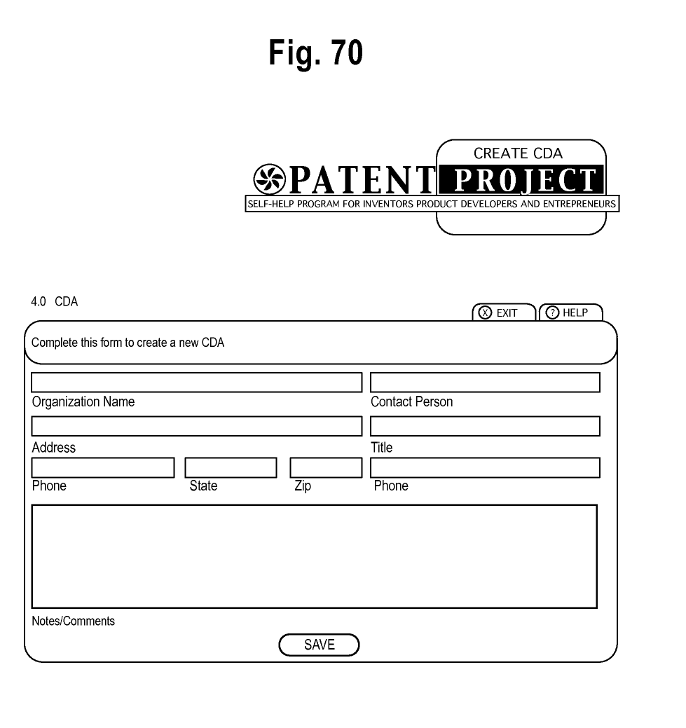

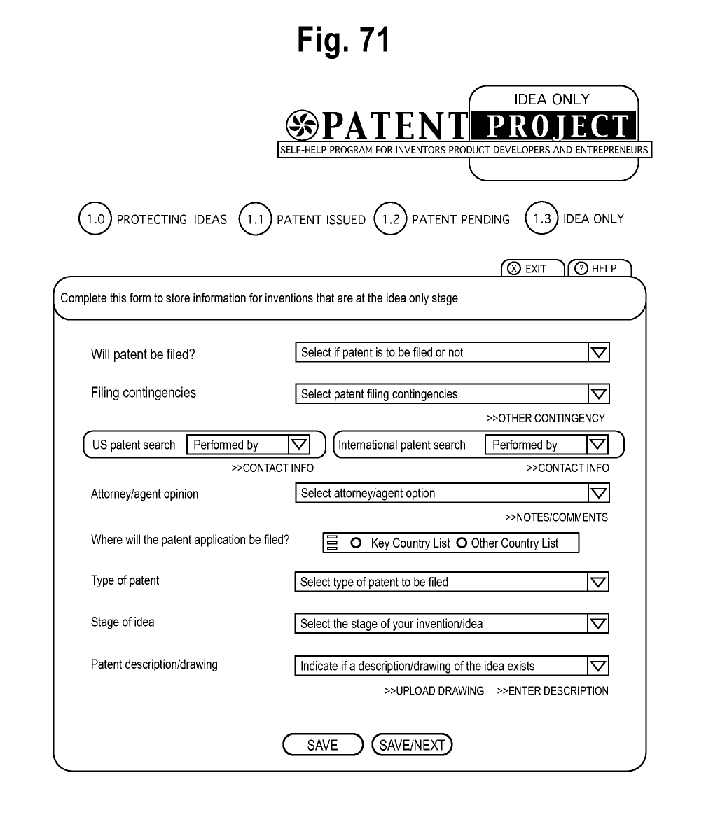

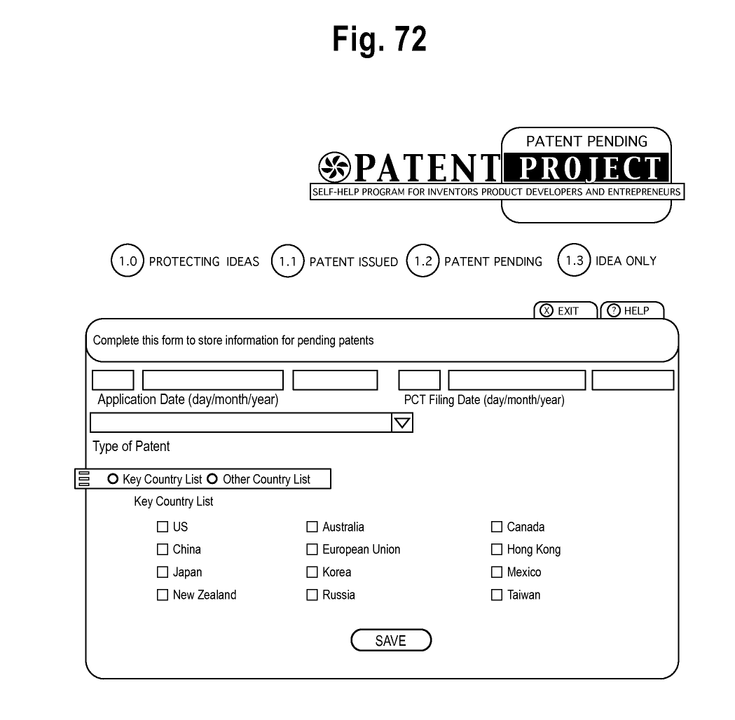

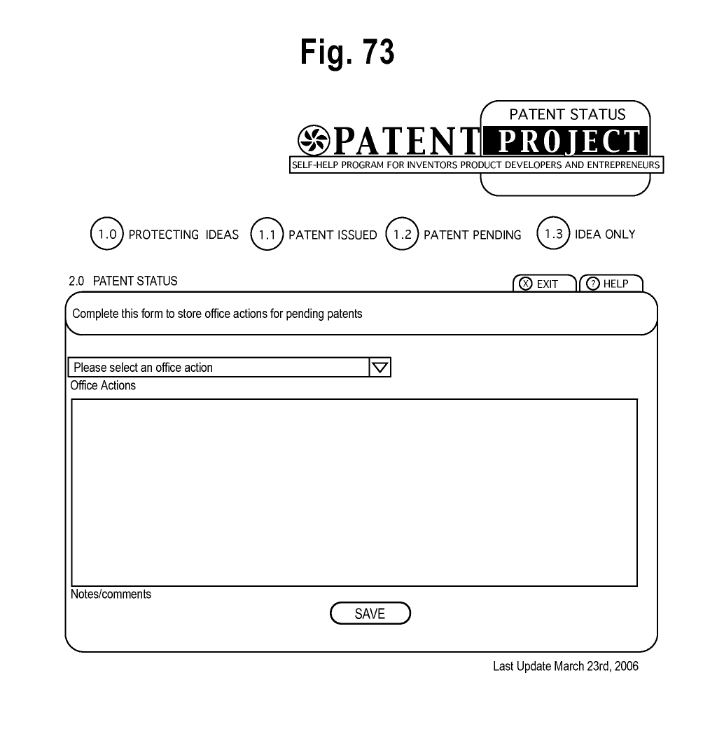

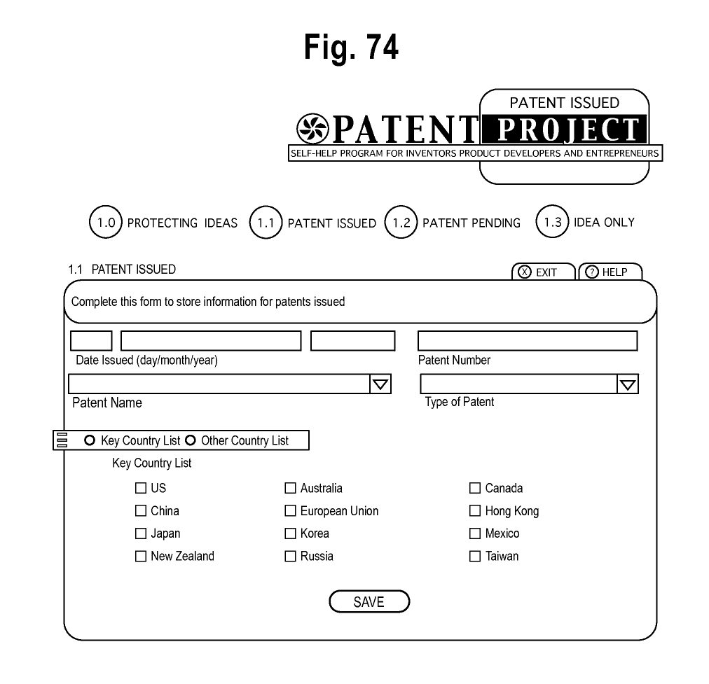

Information that a user enters in the INVENTION COMPUTER SYSTEM program may be stored in the user's computer. Depending on the implementation, the user never has to reveal any of the information contained in this computer program-related apparatus and method, if the user does not want to, thereby affording user control over this aspect of confidentiality. More importantly, the system guides the user with a pre-determined set of questions, which when answered by the user, automatically creates a presentation for use by the user that is devoid of any information that may potentially compromise confidentiality regarding the user's invention. The user can choose one of two different modes—either Instructional or Presentation, as shown in FIG. 67:

Instructional Mode INVENTION COMPUTER SYSTEM gives advice about the risks and attributes of an invention project based on answers provided. INVENTION COMPUTER SYSTEM alerts the user to potential weak or vulnerable factors in the development of an invention, and informs users how to get help to overcome them. This includes information about patenting, product development, which steps to take and in which order, and other valuable information. This mode may be customized for each user based on the information the user provides as input data to the system. In essence, it is the user that determines which of a set of variable instructions they might receive. The more input provided by the user, the more specific the information they will receive from the system.

Presentation Mode INVENTION COMPUTER SYSTEM takes entered information and reconfigures it into a customized presentation all about an invention. One of the exceptional unique features of INVENTION COMPUTER SYSTEM is the manner it creates a presentation without forcing the user to reveal the trade secrets of their inventions. It is amazing to see this develop before your very eyes! Users can print and use this presentation for interested investors, share it with colleagues, help save time with a patent attorney, or present it to interested companies or manufacturers who may want to purchase or license the invention. An embodiment can have one or more of the following database structures and corresponding data, as shown in FIG. 3, etc.

INVENTION COMPUTER SYSTEM does not get you a patent. However, it does provide the user with a ‘safety net’. In today's competitive world, it is important to know when and how to reveal the invention, and to whom. This is true whether an inventor is only at the idea stage, patent pending, and even when the inventor has a patent.

Since the cost of patenting is so expensive, and the information gained from INVENTION COMPUTER SYSTEM may help improve the patent application, pick the right time to make a patent application, and develop a superior patent position even if a patent has already been obtained.

Getting Results

INVENTION COMPUTER SYSTEM Introductory Phase I also provides the user with the groundwork for moving on to Phases II and III, if the user chooses to do this.

Each phase puts the user closer to either making the invention a commercial success, or it will help to provide the user with answers as to why the invention may not be commercially viable. This is important because since we know that 99% of all inventions will never make it to the market, it is important that the user know when to cut losses (no inventor would want to do this unless the inventor is absolutely sure that the invention is not worth pursuing). INVENTION COMPUTER SYSTEM helps the user gather this information so the user can make informed decisions about the invention project.

The user can print and use this presentation for interested investors, share it with colleagues, help save time with a patent attorney, and present it to interested companies or manufacturers who may want to purchase or license the invention, and more.

Instructions

If the user makes a mistake at any point during the INVENTION COMPUTER SYSTEM program, all the user has to do is click on the ‘edit’ or ‘back’ button and the user can always change answers. However, if the user wants to save the advice given for the current combination of answers, click on ‘save this version’. A new version will begin, and the user can always go back to view an earlier version.

To view the advice given in the Instructional mode at any point, click ‘Instructional’. To view the Presentation mode at any point, click ‘Presentation’. Any time the user is not sure about an answer, simply click ‘does not apply’. The user can always return to the question later.

The user should fill in some questions with the best guess, even if the user is not sure. The user can be alerted when this is the case. At other times, the user will be instructed to not answer the question unless the user is absolutely certain of the answer. Again, the user can be alerted to these special circumstances.

Illustrative of an embodiment forming a presentation is as follows:

I (name) of (address) (region) am presenting an invention titled (Invention title).

### Intellectual Property Protection

(Invention title) is protected by a register (Trademark/Service Mark). The (Trademark/Service Mark) name is (trademark name).
(Invention title) (qualifies/may qualify) for Trade Secret protection.
The (Invention title) is (patented, patent pending, or an idea).

(If patented) A (country) (utility) patent number (patent number) entitled (patent name) was issued (date of issuance).

Other patents include, a (use the above information).

(If patent pending) A (country) (utility) patent is pending. It has received (office action) (if notice of issuance, also include) the planned date of issuance is (date of issuance).

(If PCT) A Patent Cooperation Treaty (PCT) application has been made. The following countries have been designated for foreign filing in the national patent phase (countries).

(If idea) The (Invention title) is in the idea stage and a patent application has not yet been filed. We (do/do not) anticipate filing a patent application in the near future. (We are hoping to find a company that is willing to help pay the expenses for the patent application.) (Use this if indicated on the questionnaire.)

A (country) patent search was performed. (In addition, an international patent search was performed.) (Use only as indicated.) According to an opinion received from a patent professional, there is a (what kind of chance) likelihood of potentially receiving a (utility) patent. (Notes:)

### Illustrative Forming of a Presentation

Illustrative of an embodiment forming a market presentation is as follows:

More specifically, the (Invention title) is described as (brief description of invention). The (Invention title) is a (product, process), and is a (consumable/hard good) type of product (if applicable). The primary category for the (Invention title) is (primary category). Additional categories include (secondary and other categories). The (Invention title) is intended to be used by (general public, trade only, etc.) (list specific trade if appropriate).

The primary application is for (injury prevention, etc. (applications).) Additional applications include (secondary and other applications). Some of the unique features of the (Invention title) include (features). The benefits to the user of the (Invention title) include (benefits). The advantages of the (Invention title) include (advantages). The (Invention title) may be sold in the (industrial, general, medical) markets, in outlets such as (list top five outlets). It is estimated that the potential annual sales for ((Invention title)) may reach (sales projection annually). This is based on (comparable sales for similar products) and (other factors).

Other manufacturers who sell similar or complimentary (products, items) in this category include (list manufacturers).

### Illustrative Forming of a Presentation

Illustrative of an embodiment forming a development presentation is as follows:

Thus far, a (working model, prototype, etc.) has been developed. Yet to be done is the generation of a (working model, prototype). Developing the (prototype, working model) will be (challenging, easy, etc.).

It is anticipated that this will be finished by (date). Contingent on (resource required) (and) or available funding.

The following information about the (invention title) is available: (VHS, drawing, etc.).

There has already been (test markets) of the (invention title).

(Number of units) have been sold at an average sale price (sale price) in the following outlets (outlets sold). Sales have been (slow, brisk). Sales should improve if we can (factors influencing sales).

Helping the general public to understand the (Invention title) should be (challenging, easy). Helping the (trade, professionals) to understand the (Invention title) should be (easy, challenging, etc.).

(Number of units) (samples, working models, production units) are available.

The (Invention title) has been evaluated by (name of evaluators) and the results are as follows: (results of evaluation).

The following companies have signed confidentiality agreements in order to review the (Invention title): (name of people signing CDA's). The following companies have already reviewed the (Invention title): (names of companies) and they indicate the following response: (response of evaluators).

In order to continue with the patent process, the following resources are required (amount of resources) within (amount of time). For further invention development, the following resources are required (same as above).

For test marketing, the following resources are required (same as above).

For further testing and evaluation, the following resources are required (same as above).

The inventor has (amount of time) available to help with (product development, prototyping, test marketing, etc.).

### Illustrative Forming of a Presentation

Illustrative of an embodiment forming an inventors profile presentation is as follows: (Inventor/project owner name) is the (sole owner, partner, etc.) of the (Invention title).

The (Invention title) belongs to (a company, other individual) (and/who is) the managing partner in charge of this project is (name).

Inventor received (bachelor's, master's, etc.) at (college name) (year) (repeat for the number of degrees).

Inventor has been an author in the following publications: (title, date and name of publications). Inventor has special training and expertise in (inventor's explanation of any special expertise skills and training that he has that (may or may not) pertain to the (Invention title)).

(Inventor's name) is interested in (receiving a lump sum, etc.) and (receiving a royalty) and (etc).

### Project Checklist

### Project Checklist

The following are potential elements of a checklist that would include check boxes for completion dates.

1. Description of invention
2. Drawing of invention
3. Patent search
4. Consult with patent attorney
5. In-field market research
6. Interviews with distributors and second tier contacts
7. Manufacturers/potential licensees identified
8. Catalogs and reports ordered from manufacturers
9. Alternative markets and applications investigated
10. Interview with manufacturers
11. Recheck all research information
12. File patent, if appropriate
13. Contact manufacturer's references
14. Submit invention to manufacturer(s)
15. Follow-up with manufacture(s) to whom you submitted
17. Document manufacture response
18. Seek professional assistance if needed to help with negotiation
19. Contact a CPA (Certified Public Accountant) for tax considerations
20. Contact a patent attorney specializing in negotiating licenses
21. Decide license/commercialization/patent strategy
22. Negotiate license or follow the alternative strategy
23. Follow-up on project with at least one contact per month

### Illustrative Forming of a Presentation

Illustrative of an embodiment forming a confidentiality presentation is as follows:

Has anyone signed an agreement of confidentiality or non-disclosure relating to your invention? Yes or No?

If Yes, please list the individuals or companies who have signed. If you have information regarding the name of the company and its address, please list it. Also, list the approximate date in which the agreement was signed, or at least the year.

Include either a copy of the signed document as an addendum to this program, or add the confidentiality form that you used as a file in this program. Incorporate it as a link here. In the event that you wish to have a confidentiality agreement to use with your invention, please refer to The Inventor's Bible, or visit docie.com/confidentialitagreement via http:// for information about a confidentiality form for you to use.

### Illustrative Further Information

Illustrative of further information for an embodiment is as follows. Here is an example of a INVENTION COMPUTER SYSTEM Help menu section:

### I. Patenting and Protecting

Check one box only.

### II. Patent Status

2a. Utility—(Help or Define button)—Most common patents are utility patents. Current patent numbers start with a 4, 5, 6 or 7, and are in the single digit millions. So, if your number is U.S. Pat. No. 6,875,432, for example, then you know that it's a utility patent. (Help)

Utility patents can cover an apparatus, a method, or both. Some method patents cover software programs and business models.

2b. Design—If your patent number starts with the numeral “D”, then it is a design patent. For example, D514,860. Design patents are for the ornamental appearance only and there will be only sketches and illustrations of your invention, not a written description or claims.

Design patents are normally considered much more limiting in scope than utility patents. For more information about this, see The Inventor's Bible, Chapter 2. (Help)

2c. Plant—Plant patents are used to cover botany, asexual plants, and are not nearly as common as either the utility or design patents. (Help)

2d. Provisional—To be perfectly clear, there is no such thing as a “provisional patent”. However, you can have a provisional patent ‘application’. This is because when you file a provisional application, it is the preliminary step for making the formal filing of a utility patent. (Help).

After filing a provisional application, you have one year in which to convert your application into a formal utility patent application. In the meantime, you are considered to be in a patent pending status.

When you file a provisional application, you need to fully describe the invention just as you would a regular utility patent application, however, you do not need to supply formal drawings and illustrations, vs. the claims of your patent until you make the formal application for a utility patent.

Unless you divulge specific information about the status of your patent application, the fact that you have a provisional application pending or a full utility patent application pending is private and confidential between you, your patent attorney or agent, and the patent office.

2e. & 2f. PCT—PCT stands for Patent Cooperation Treaty. Once you have filed a patent application in the U.S., you normally have approximately one year in which to file under the PCT. If you don't file either a PCT or in the individual county with the one year, you lose any chance for the foreign rights. (Help)

When you file under the PCT, you reserve the right to file a patent application in designated foreign countries at a later date. These dates vary and many are approximately thirty months, more or less, from the time of your application. These dates become very complicated and there are exceptions, so it is extremely important to work closely with, and get the advice from, a patent attorney with familiarity in filing for foreign patent applications.

The costs of filing foreign patent applications increase almost exponentially compared to filing a U.S. patent application. For example, you may budget $5,000 to $10,000, at the most, for a common U.S. patent application. The PCT application alone may cost an additional amount in this range, however, when you later get to the national phase for filing in the individual countries, the cost for filing in each foreign country can be this much or more. Therefore, if you were to file patent applications in the European Union, China, Japan, Canada, Australia, and maybe a few other progressive developed regions, the budget for doing so may easily range from $30,000 to $100,000, or more.

In addition to the cost for filing a foreign patent application, the translation fees for certain countries can equal the cost of the application itself. Plus, various countries have maintenance fees for maintaining the patent over time, much like the maintenance fees for a U.S. patent. Therefore, you also have a substantial on-going budget for maintaining your patent in foreign countries.

In the event you intend to file a foreign patent application, your initial patent application will be published by the Patent office for the public to see after 18 months from your application date.

2g. (4b.) (also Kind Codes (I earlier called it ‘Type Patent’) International Patent Search—

The letter and number designation at the end of a patent number indicates the type of patent search performed, if any. This ‘kind code’ may be “A1” or “B2”, for example (Help)

You have a choice with regard to which international country performs your foreign patent search. The cost may vary dramatically depending on which country you choose. It is thought that international patent searches originating from certain countries are better or more thorough than others.

At the writing of this document, European patent searches are considered quite thorough. Some inventors have their international search performed in Eastern European countries such as Russia, and these may be much cheaper, but there is also a question regarding their affective thoroughness.

Because of the differences in these international searches, the type rating on your patent application, or on the patent itself, alerts others as to what type of search was performed.

### Patent Pending Status

3a. Received Notice of Issuance—In the final stages of your patent application, after your patent is allowed, the final step is issuance. After ‘allowance’, you don't automatically receive a valid issued patent. You still have another step, and this is to pay the issuance fee. (Help)

Your patent attorney or agent normally will require that you pay them in full for their services before they will finalize this last step for you. After you have paid the issuance fee, it will still take a couple months to have your patent issued. You will receive a notice telling you the patent number and the intended issuance date.

Upon issuance, your patent number, your name, classification, an abstract or claim describing your invention, and maybe one illustration will be published in the Official Gazette of the U.S. Patent and Trademark Office, which is published biweekly. This is the first absolutely unavoidable date in which the information you have divulged in your patent will become public knowledge and in the public domain. This is an extremely crucial date because you must have all the proper filings for any foreign patent application done by this date because thereafter, you will lose the right to do so forever.

If it is your desire to file a foreign patent, and if you receive notice of issuance, then you should immediately contact your patent professional to have a PCT or foreign filing done prior to the current patent issuance date.

3b. First Office Action Received—Several months after you file your patent application, you will receive your first notice from the examiner at the patent office who is examining your patent application. In this first ‘office action’, they will write back to you or your patent professional, if you have one, and inform you of any problems with the application that needs corrected. Of the various possible actions, the examiner may reject one or more of the ‘claims’ in your patent, or he/she may allow certain claims, etc. (Help)

This first office action is very telling because it gives an indication with regard to how hard a battle you have ahead of you to obtain your patent. Further, the patent examiner will likely site references to ‘prior art’ that you have never seen before. Regardless of how good a patent search you originally performed, it is normal for the patent examiner to cite references not previously known by you. It is based on these new references that you must re-evaluate your strategy with regard to your likelihood of receiving a valid patent.

Many times companies who are interested in an inventor's invention will rely on the response of the first office action as a basis for either taking the invention seriously or declining because of the limitations made reference to in the office action. Therefore, the response of the first office action is an extremely pivotal point in the patenting process.

### Notice of Allowance—

Claims—Patent applications, other than design and provisionals, have a section entitled ‘claims’. This is a section of your patent whereby your claiming what it is about your invention that makes it different from all others. The claims also limit what it is that you can protect with your patent. (Help)

The claims section is the ‘meat and potatoes’ of your patent. All other information in your patent including the drawings, description, and background are primarily used as a source of reference for clarifying what it is that you are ‘claiming’ in your patent.

The commercial value of your patent is generally based on the claims. Anyone interested in purchasing or licensing your patent is primarily concerned with the breadth and scope of what it is that you claim. The broader the scope of your patent claims, the more valuable your patent. For more information about this, see Chapter 2 in The Inventor's Bible.

Examiner—A person employed by the US Patent and Trademark Office (or other national patent office if foreign) who is skilled in your category of invention and who examines your patent application. This examiner decides whether your patent should be issued or not, and if not, why not. An appeals court can override an examiner's final decision. (Help)

3c. Final Office Action—The final office action will generally come at some point in time after your first office action. It typically takes at least one to two years from your application date to receive the final office action.

Your final office action is also a pivotal point in your patent strategy. This is when you learn if any claims have been allowed or not. The patent examiner will indicate the limiting factors that are preventing your any claims from being allowed. For example, you may have 1 out of 10 claims allowed, 19 of 20, all or none.

Even though it is called a ‘final’ office action, there are still alternatives for various actions. For example, you may appeal the patent examiner's decision and continue to fight for the claims that you believe you deserve. Sometimes the patent examiner is just dead wrong on their decision to reject your patent application and it forces you to have to appeal the process in order to overcome this. This adds both time and expense on your part and you must weigh if it is commercially viable to make such an expenditure.

It is at stages like this in your patenting process that you appreciate the value of getting a preliminary marketability and licensability indication so that you can make informed decisions based on the potential commercial value of your invention. This must be weighed against the expenditures that you may need in order to take a chance on getting a patent.

3d. In Appeal—After your patent examiner has rejected your claims; and when you still believe that you have a right to those claims, you can appeal the patent examiner's decision. In this case an appeals court will decide whether the patent examiner was right or wrong in his/her decision. (Help)

Of the various consequences, the appellate court may deny your request, it may override the patent examiner's decision, and/or you may be thrown into re-examination. At this point, the choices are far more complicated and it is important to pay attention to the advice of your patent professional.

Decisions regarding spending more money on your patent must be weighed against your commercial strategic findings. Other possibilities may include making additional patent applications and so forth.

4k. Art Unit—After a patent application is filed, the patent office assigns a primary ‘art unit’ to your invention, and sometimes a secondary art unit. It is within these art units that various other patents and ‘prior art’ for your invention will be searched. (Help)

Therefore, if you want to research and find various other similar, complimentary, and/or competitive technologies relating to your invention, these will mostly be found in the patents and prior art located within your search art unit(s).

Prior Art—(Whenever the term ‘prior art’ is used, apply this definition.) ‘Prior art’ is all the inventions, products/technology and published information similar to your invention that existed prior to the date of your patent application. (Help)

When examiners at the patent office and others are searching for other inventions similar to yours, in an effort to discover whether your invention is truly novel, they will search what is referred to as an ‘art field’. The field of ‘art’ is basically the collection of all inventions and published material that may already describe an invention similar to yours.

The word ‘art’ is used loosely to define all inventions, products and technology. Therefore, ‘prior art’ is everything disclosed publicly or published prior to the date of your patent application. The date of your patent application is also called the ‘priority’ date.

Product Development—Here you list the status of your product/technological development. The five primary stages of development are: 1) Proof of Concept, 2) Prototype, 3) Working Model, 4) Samples, and 5) Production.

Answer all that apply.

Proof of Concept—If you have ‘proof of concept’, it means that you have established the scientific or other proof necessary to prove that your invention will do what you claim it will do. Alternatively, your invention may be sufficiently simplistic enough that no such proof of concept is required because it uses standard parts and/or proven engineering principles. (Help)

Prototype—The prototype is your first opportunity to reduce your invention to a practical form whereby it may either look something like or work something like it eventually should. A prototype is your first or rough working model/concept. (Help)

A prototype may be a ‘looks like’, ‘works like’, or both. It may be sufficient to build a prototype that works, and yet looks nothing like the final model, or vice versa. You may have several generations of prototypes in the course of improving and changing your invention.

Working Model—A working model for the sake of our definition, is one step beyond the prototype stage. A working model is generally more refined than a prototype. For example, in a working model, the buttons may be where they are suppose to be, someone other than you may be able to operate the invention without going through any extra special processes, and it would generally look more like the final end product. A working model will perform all or most of the functions that the invention is intended to do. (Help)

Samples—You may have several working models of your invention, and not yet be in production. For example, you may produce several working models from a temporary mold so that the end-user can try out the product. (Help)

Your product may not be packaged, as it would be on the retail shelf, for example, and it may not look exactly like the final product, however, people can nonetheless try it out and see what they think about. Their responses may help you refine the invention, and their feedback may assist you with the marketing/licensing of your invention.

Production—The production stage is when you are producing your invention in a final form available for either trail use or for sale. (Help)

7. Consumer—The ‘consumer’, or end-user would be the final person to purchase or use your invention.

Examples: For a retail product such as a packaged utility knife targeted toward the DIY (do-it-yourself) handyman, and/or carpenter, etc, the consumer and end-user would be one in the same. In other words, the consumer would be the customer in the store

For a hospital operating room device such as an oxygen mask, the consumer may be either the anesthesiologist or the hospital, even though the patient benefits from the device. The patient has very little direct say or discretion in the buying process. Technically, the end-user in this case may be the patient, however, we will generally refer to the consumer as the last person to purchase the product. In this example, the consumer would be the anesthesiologist/hospital. There may be exceptions to this from time to time. (Help)

Trade—We define the trade as those people in the distribution chain, other than the consumers. For example: The manufacturer may sell to a distributor, who would sell to the retailer, who would sell to the end-user, or consumer. In this case, the manufacturer, distributor, and retailer are all members of the trade in which the invention is sold. (Help)

Generally speaking, people in the trade will have a much deeper understanding of their market, and of other products available to the consumer. They will typically be able to understand the features and benefits of an invention more readily than what a consumer would. The feedback you receive from members of the trade will often be substantially different from what you receive from the end-user/consumer.

For the purpose of performing the research in INVENTION COMPUTER SYSTEM, it will be important to distinguish between consumers and members of your trade.

7. Consumable—A consumable product would not be reused or saved. Examples of consumable items are: food, shampoo, fuel, and anything else that you would use and have to replenish. (Help)

Hard Goods—Hard or durable goods are other than consumables and are reused or saved. Examples are: hammers, clothing, furniture, vehicles, etc. It matters not whether a product is physically hard to the touch; consumable items can be hard and a hard good can be soft.

### (Help)

Consumer products, for the sake of this questionnaire, will generally refer to products and goods sold in a retail store. This may include both consumable and durable goods. (Help)

General Public—When a product or technology is available to anyone who walks off the street to purchase it, it is considered available to the general public. This differs from a ‘trade only’ item whereby the invention may be purchased only by trades people such as plumbers for use in their work while making a repair; doctors and others who require a special license for its use, etc. Some inventions may be available to the trade, and in another version or configuration also be available to the general public. (Help)

Trade Only—A product or technology that is available only to those members of a specific trade, such as plumbers who use a special tool to make repairs, or doctors who use a particular scalpel for operating, etc. Some inventions may be available to the trade, and in another version or configuration also be available to the general public. (Help)

Applications—Earlier you listed the product ‘category’ and the ‘types’ of people who would use your invention. Here, list the ‘uses’ of your invention within that category. For example, it may be an orthopedic surgeon that uses your invention, and its ‘application’ would be for knee surgeries, etc. Your utility knife may be in the category of hardware; used by do-it-yourselfers, and its ‘applications’ would be for use in cutting carpet, general purpose cutting, in the construction of new buildings, etc. List all possible applications for use of your invention. (Help)

Features—The features of your invention would be its attributes and traits. For example, the tool may be more form fitting to their hand, or ergonomic. It may be able to operate at higher temperatures, interfaces with a variety of systems, etc. You can be as specific as you want without revealing the trade secrets of your invention, or if you have adequate patent protection or are otherwise willing to reveal your invention at this time, you may go into details about certain prominent features of your invention.

It is recommended that you limit the number of entries to the top five most prominent and important features. Add more if necessary. (Help)

Benefits—One of the ‘features’ of your invention may be that it uses less wattage, and the resulting ‘benefit’ would be that it saves the consumer money. The benefits are the tangible affects that people appreciate about the invention. In other words, how it positively affects them. (Help)

The distinction between a feature and a benefit is that the consumer may not know how a certain feature will benefit them. They may not know the significance of higher amperage or lower wattage, but they do know if they want something warmer and cheaper. While the trade may care about and understand the features, the consumer has their eye on the benefits.

Solely by listing the applications, features, benefits, and advantages of your invention, this alone may help to pinpoint the top manufacturers or companies that may want to purchase or license your invention. This is one of the trick to pre-qualifying companies in your industry WITHOUT revealing the trade secrets of your invention.

For example, if a manufacturer prides itself for offering only high quality products to the more expensive end of the consumer market, offering a cost saving product to them may not be high on their list of features or benefits.

This is why the listing of your applications, features, benefits, and advantages are all critical in helping to pre-qualify which manufactures or companies may be the top candidates for purchasing or licensing your invention. Listing even generic information in these four categories enables you to potentially target the right companies without even revealing the trade secrets of your invention.

Advantages—Advantages are ‘benefits’ that are ‘better’ than other things that exist. This is more of a ‘comparison’ with other products/technologies in your category. For example, your invention may be 50% cheaper than ______, 20% faster than ______, 30% smaller than ______, easier to install than ______, etc.

You need not necessarily have a point of reference for comparison in order to list an advantage, however, if your invention does have such a distinct advantage over products or technologies known to the consumer or the trade, then this is a good place to list it. (Help)

To be Defined—Market, License (see glossary in The Inventor's Bible).

If a product, is it consumable, a hard good, other, or both?
Use the definitions in INVENTION COMPUTER SYSTEM Help for more information.

3.1 Type of market Please first choose, is your invention a product or method or process? Can choose one or both.

If your product is a method or process, it is computer software, a business model, a method or process associated with the product, either or all?

3.1.1 Market category Please list all the categories that apply for your invention. If more than one, indicate primary category and secondary category. Also, list a choice of: other.

3.1.2 Uses This is straight forward and works adequately the way it is already listed.

3.1.3 Applications

Indicate for what specific application your invention may be utilized.
List of primary application, and any secondary or additional applications.
Need detailed examples.

3.2 Features Need to limit the number of words to keep it brief. Please make reference to a limit of 50 words near the Feature tab.

3.3 Benefits Please list all benefits in summary form. Use in conjunction with Benefits and Advantages, of INVENTION COMPUTER SYSTEM Help.

3.5 Outlets Select the types of outlets where your invention would be sold. Use the drop-down list to include a checkbox for Wal-Mart, Home Depot, hardware stores, department stores, mass merchandisers such as Target, Fred Meyer, etc., plumbing supplies, pharmacies, lumbar yards, hospitals, specialty stores (please list the type of store, that is, book store, cellular phone store, etc.) An option here is to have data about major retailers for further use in the system. List all other types of generic categories, and a space for other.

3.5.1 Top five outlets Please list the top five outlets by name where you think your invention will be sold. Include the name of the outlet, possibly the address, if known, in addition to contact person, phone and geographic region. For example: Wal-Mart, Kmart, etc. Home Depot, Lowe's, ACE, True Value, etc. Walgreen, Revco, CVS, etc. Bed, Bath and Beyond, Federated Department Stores, etc.

3.6 Market size If you have a good idea of the potential sales in your given market, please list the possible range here for annual sales after your new product is established in the marketplace.

In the description, please list the basis for your estimate of the market. For example, based on your 20 years experience in this trade, based on estimates of sales of similar products, based on the number of outlets that may be served, based on estimates from professionals in the industry, based on the information gathering advise made reference to in this system, etc.

3.6.1 Manufacturers Please list here the manufacturers who are already established in the market category or market position for your type of invention, if known. Please list as prominent and secondary, if known. If you also know the approximate market share of those companies already in this market, list that beside the company name. (Have a separate column for market share beside the name column. Note that the Inventor's Bible serves to explain much about how to approach industry, interview key personnel, perform primary market research, and generally take you through the invention commercialization process by way of licensing.

The Inventor's Bible Workbook starts to get more specific, informing you step-by-step of the kinds of questions to ask of whom. It helps to organize and document the data received, particularly when it comes to analyzing the differences between the choices of potential licensees.

What is not effectively achieved by both the book and workbook is the easy translation and summary of data as it relates to the market potential for your invention. When raw market data, specifically selected by the INVENTION COMPUTER SYSTEM program, is input into the program, INVENTION COMPUTER SYSTEM automatically calculates the parameters used to extrapolate data, and creates customized market volume parameters, sales parameters, and even sales expectations for certain market venues.

Market projections are achieved from both the data already contained within the INVENTION COMPUTER SYSTEM program, and from the information provided by the user, for each given project. Conversely, said projections may also be obtained solely from the data provided by the user and computed by INVENTION COMPUTER SYSTEM.

For example, the user is directed to perform interviews and perform market research. From this information is derived a set of numbers and in some cases the names of certain sales venues that may be candidates for selling the invention. Many of the major retail and other sales venues have a known number of stores, known sales volume per product category, fixed number of product turns within a given time period and so forth. From this information, and other information asked for by the program and provided by the user, the INVENTION COMPUTER SYSTEM program can establish a baseline parameter for sales given the market conditions provide by the user.

As such, it is the interaction of data provided by the user, combined with data already established by the INVENTION COMPUTER SYSTEM program that creates an easy to obtain market value estimate for any given invention. In order to be effective, data utilized within the program is updated on a regular basis to correspond to current market demographics and conditions.

In another embodiment, the users themselves provide all the raw data of variable information into the fixed parameters of the INVENTION COMPUTER SYSTEM program, and INVENTION COMPUTER SYSTEM computes the information to obtain the desired result.

A further embodiment of the invention is to use a tutorial similar to the one described above, however instead in inputting data strictly for the attainment of financial and sales projections, the user provides information, as asked of the program, to the program regarding companies found in the field resulting from the primary market research performed by the user. The INVENTION COMPUTER SYSTEM program then computes the variables and provides the user with the most likely matches of potential licensees. Unlike a dating service, however, all variable information for this aspect of the program is input by the user for details concerning both themselves and the potential licensing candidate. Then, the program utilizes a formula for determining and rating the potential viability, and pros and cons of the various choices.

Consider embodiments herein as an improvement, and consider the following excerpted from The Inventor's Bible Workbook copyright 2001 and 2004, also incorporated by reference, with inserted comments referencing the improvements and phases of embodiments herein presented

Improving thereon, an embodiment can use data, combine data, and compute in ways heretofore unprecedented. Dropdown-type menus of INVENTION COMPUTER SYSTEM allow analyzing a response and formulating a further question or logic branch, within a set of given parameters that correspond to the particular situation appropriate for the user. For example this can include a looping of the criteria 12 and 32 in evolving a presentation to be sent by the innovator 2 to the recipient 4.

Further, typically a user would not have ready access to all the information that will be asked of them by the INVENTION COMPUTER SYSTEM program. The INVENTION COMPUTER SYSTEM program will direct the user to seek additional information, and in some cases even direct the user to the sources of information, including names of establishment, contact information and directions to the facility, e.g., using GPS. The INVENTION COMPUTER SYSTEM will further explain to the user what to ask, how to ask, and why the user is seeking such information. In essence, the computer system acts as an interactive virtual manager of the invention project, directing the user based on information provided by the user. (The dropdown menus for phases II and III would be about the size of those for Phase I.)

In sum, appreciation is requested for the robust range of possibilities flowing from the core teaching herein. More broadly, however, the terms and expressions which have been employed herein are used as terms of teaching and not of limitation, and there is no intention, in the use of such terms and expressions, of excluding equivalents of the features shown and described, or portions thereof, it being recognized that various modifications are possible within the scope of the embodiments contemplated and suggested herein. Further, various embodiments are as described and suggested herein. Although the disclosure herein has been described with reference to specific embodiments, the disclosures are intended to be illustrative and are not intended to be limiting. Various modifications and applications may occur to those skilled in the art without departing from the true spirit and scope defined in the appended claims.

Thus, although only a few exemplary embodiments have been described in detail above, those skilled in the art will readily appreciate from the foregoing that many modifications are possible in the exemplary embodiments without materially departing from the novel teachings and advantages herein. Accordingly, all such modifications are intended to be included within the scope defined by one or more claims. In the claims, means-plus-function claims are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment fastening wooden parts, a nail and a screw may be equivalent structures.

I claim:

1. A self-help apparatus to develop a presentation of an invention characterization without a central controller, the apparatus including:
a digital computer system comprising a computer operably associated with an input device, an output device, and memory storing executable instructions which when executed, causes the digital computer to perform the operations of:
producing self-help user interfaces comprising enough questions, at the output device, so that receiving answers which correspond to the output questions enables the computer to generate a presentation of an innovation characterization configured to avoid disclosure of a trade secret and to avoid a bar to patentability if the presentation were publicly disclosed;
receiving, at the input device, answers to the output questions;
generating, by the computer from the received answers, the presentation; and
outputting the presentation at the output device so as to allow communication of the presentation to a recipient without a confidentiality agreement or license, and without an intermediary deciding whether the presentation can be disclosed to the recipient, and wherein the apparatus is devoid of a central controller between the digital computer system and a recipient, and a central controller does not convey the presentation to the recipient.

2. A self-help apparatus to develop a presentation of an invention characterization without a central controller, the apparatus including:
a digital computer system comprising a computer operably associated with an input device, an output device, and memory storing executable instructions which when executed, causes the digital computer to perform the operations of:
producing self-help user interfaces comprising enough questions, at the output device, so that receiving answers which correspond to the output questions enables the computer to generate a presentation of an innovation characterization configured to avoid disclosure of a trade secret and to avoid a bar to patentability if the presentation were publicly disclosed;
receiving, at the input device, answers to the output questions;
generating, by the computer from the received answers, the presentation; and
outputting the presentation at the output device to convey to a recipient, wherein the apparatus is devoid of a central controller between the digital computer system and a recipient to convey the presentation to the recipient.

3. The apparatus of claim 2, further including the operation of:
producing, from at least some of the received answers, an other presentation that is not configured to avoid disclosure of a trade secret and to avoid a bar to patentability if the presentation were publicly disclosed.

4. The apparatus of claim 2, wherein the operation of generating includes generating the presentation of the innovation characterization configured to avoid disclosure of patentable subject matter.

5. The apparatus of claim 2, wherein the operation of generating includes generating the presentation of the innovation characterization configured to avoid making an offer to sell.

6. The apparatus of claim 2, wherein the operation of generating includes generating the presentation of the innovation characterization configured so as not to contain sufficient detail to be patentable.

7. The apparatus of claim 2, wherein the operation of generating includes generating the presentation of the innovation characterization configured to consist of commonly known or pubic information.

8. The apparatus of claim 2, wherein the operation of outputting enough questions includes producing interactive screens at the output device.

9. The apparatus of claim 2, wherein the operation of outputting enough questions includes producing screens at the output device, whereby at least some of the received answers govern which of the questions is subsequently presented.

10. The apparatus of claim 2, wherein the operation of outputting enough questions includes producing screens at the output device, whereby at least some of the received answers govern which of the presentations is first output.

11. The apparatus of claim 2, wherein the operations further include generating, by the computer from the received answers, advice on how to develop the innovation characterization; and
outputting the advice at the output device.

12. The apparatus of claim 2, wherein the operations further include:
generating, by the computer from the received answers, advice on how to commercialize the innovation characterization; and
outputting the advice at the output device.

13. The apparatus of claim 2, wherein the operations further include:
generating, by the computer from the received answers, instructions corresponding to at least one criterion from an other, the instructions corresponding to receiving the innovation characterization; and
outputting the instructions at the output device.

14. The apparatus of claim 2, wherein some of the answers include at least one criterion of a category, function, benefit, advantage, feature, objective, characteristic, application, uses, users, market, sales outlet, distribution, consumer demographic, and consumer psychographic, corresponding to the innovation characterization.

15. The apparatus of claim 2, wherein the operations further include receiving at least one criterion from an other specifying a desired presentation.

16. The apparatus of claim 15, wherein the operations further include matching said at least one criterion with at least one criterion from an other with respect to the innovation characterization.

17. The apparatus of claim 15, wherein the operations further include matching said at least one criterion with at least one criterion from an other with respect to the innovation characterization in determining a statistical significance of the matching.

18. The apparatus of claim 15, wherein the operations further include producing a relevance matching of said at least one criterion with at least one criterion from an other with respect to the innovation characterization.

19. The apparatus of claim 15, wherein the operations further include presenting screens which solicit said at least one criterion from an other so as to correspond to some of the answers.

20. The apparatus of claim 2, wherein the outputting and receiving operations are carried out at a web site.

21. The apparatus of claim 3, wherein the memory comprises one memory media for both presentations.

22. The apparatus of claim 3, wherein the memory comprises one memory media for the presentation and a second memory media for the other presentation.

23. The apparatus of any one of claims 15, further including a second computer system communicating with the computer system in providing said at least one criterion of the other.

24. The apparatus of claim 16, further including a second computer system communicating with the computer system in providing said at least one criterion of the other.

25. The apparatus of claim 17, further including a second computer system communicating with the computer system in providing said at least one criterion of the other.

26. The apparatus of claim 18, further including a second computer system communicating with the computer system in providing said at least one criterion of the other.

27. The apparatus of claim 19, further including a second computer system communicating with the computer system in providing said at least one criterion of the other.

28. The apparatus of claim 2, further including a recipient computer system receiving said presentation.

29. The apparatus of claim 2, wherein the presentation is configured to avoid disclosure of a trade secret by filtering the received answers.

30. The apparatus of claim 2, wherein the presentation is configured to avoid a bar to patentability if the presentation were publicly disclosed by filtering the received answers.

31. The apparatus of claim 2, wherein the presentation is configured to avoid disclosure of a trade secret by carrying out the outputting with a set of the questions that do not have trade secret answers.

32. The apparatus of claim 2, wherein the presentation is configured to avoid a bar to patentability if the presentation were publicly disclosed by carrying out the outputting with a set of questions that do not have answers which would bar patentability.

33. A computer-readable media tangibly embodying a program of instructions executable by a computer to control performance of a computer system carrying out the self-help steps of:
outputting enough questions so that receiving answers which correspond to the output questions enables the computer to generate a presentation of an innovation characterization configured to avoid disclosure of a trade secret and to avoid a bar to patentability if the presentation were publicly disclosed;
receiving answers to the output questions;
generating, from the received answers, the presentation; and
outputting the presentation, wherein the instructions are not adapted to communicate with a central controller intermediate digital computer system and the recipient.

34. The media of claim 29, wherein the media is a member of a group including at least one of a RAM, a ROM, a disk, an ASIC, and a PROM.

35. A method of making an apparatus including:
providing a digital computer system comprising a computer operably associated with an input device, an output device, and memory storing executable instructions which when executed, causes the digital computer to perform the self-help operations of:
outputting enough questions, at the output device, so that receiving answers which correspond to the output questions enables the computer to generate a presentation of an innovation characterization configured to avoid disclosure of a trade secret and to avoid a bar to patentability if the presentation were publicly disclosed;
receiving, at the input device, answers to the output questions;
generating, by the computer from the received answers, the presentation; and
outputting the presentation at the output device, wherein the apparatus is not adapted to convey the presentation to the recipient via a central controller.

36. A method of using an apparatus including:
engaging a digital computer system comprising a computer operably associated with an input device, an output device, and memory storing executable instructions which when executed, to cause the digital computer to perform the self-help operations of:
outputting enough questions, at the output device, so that receiving answers which correspond to the output questions enables the computer to generate a presentation of an innovation characterization configured to avoid disclosure of a trade secret and to avoid a bar to patentability if the presentation were publicly disclosed;
receiving, at the input device, answers to the output questions;
generating, by the computer from the received answers, the presentation; and
outputting the presentation at the output device so as to allow communication of the presentation to a recipient without an intermediary deciding whether the presentation can be disclosed to the recipient.

37. The method of claim 36, wherein the operations further include:
calculating, by the computer from data input at the input device, a market value corresponding to the presentation; and
outputting the market value at said output device.

38. The method of claim 36, wherein the operations further include:
identifying, by the computer from data input at the input device, potential recipient choices corresponding to the presentation; and
outputting the choices at said output device.
